(19) United States
(12) Patent Application Publication
(10) Pub. No.: US 2024/0400780 A1
(43) Pub. Date: Dec. 5, 2024

(54) FOAMABLE THERMOPLASTIC COMPOSITIONS, THERMOPLASTIC FOAMS AND METHODS OF MAKING SAME

(71) Applicant: HONEYWELL INTERNATIONAL INC., Charlotte, NC (US)

(72) Inventors: Hayim Abrevaya, Charlotte, NC (US); Erin Broderick, Charlotte, NC (US); Alexey Kruglov, Charlotte, NC (US); Keith Lehuta, Charlotte, NC (US); Tianyu Liu, Charlotte, NC (US); Rodrigo Lobo, Charlotte, NC (US); David Mackowiak, Charlotte, NC (US); Susie Martins, Charlotte, NC (US); Peter Nickl, Charlotte, NC (US); Mark Triezenberg, Charlotte, NC (US); Syed Hassan Mahmood, Charlotte, NC (US); Mary Bogdan, Charlotte, NC (US)

(73) Assignee: HONEYWELL INTERNATIONAL INC., Charlotte, NC (US)

(21) Appl. No.: 18/731,413

(22) Filed: Jun. 3, 2024

Related U.S. Application Data
(60) Provisional application No. 63/470,904, filed on Jun. 4, 2023.

(51) Int. Cl. C08J 9/14; F03D 1/00; F03D 1/06

(52) U.S. Cl. CPC C08J 9/146; F03D 1/0675; F03D 1/101; C08J 2203/142; C08J 2205/052; C08J 2367/02; F05B 2280/4007

(57) ABSTRACT

Disclosed are foam articles comprising a thermoplastic, closed-cell foam having at least a first surface and comprising: (i) thermoplastic polymer cell walls comprising at least about 0.5% by weight of ethylene furanoate moieties and optionally one or more co-monomer moieties; and (ii) blowing agent comprising HPC-152a contained in at least a portion of said closed cells.

### CROSS REFERENCE TO RELATED APPLICATION

This application is related to and claims the priority benefit of U.S. Provisional Application No. 63/470,904, filed Jun. 4, 2023, which is incorporated by reference herein in its entirety.

### FIELD OF THE INVENTION

This invention relates to foamable thermoplastic compositions, thermoplastic foams, foaming methods, and systems and articles made from same.

### BACKGROUND

While foams are used in a wide variety of applications, it is a desirable but difficult-to-achieve goal in many applications for the foam material to be environmentally friendly while at the same time possessing excellent performance properties and being cost effective to produce. Environmental considerations include not only of the recyclability and sustainability of the polymeric resin that forms the structure of the foam but also the low environmental impact of blowing agents used to form the foam, such as the Global Warming Potential (GWP) and Ozone Depletion Potential (ODP) of the blowing agent.

Foams based on certain thermoplastic resins, including polyester resins, have been investigated for potential advantage from the perspective of being recyclable and/or sustainably sourced. However, difficulties have been encountered in connection with the development of such materials. For example, it has been a challenge to develop polyester resins that are truly recyclable, can be produced from sustainable sources, and which are compatible with blowing agents that are able, in combination with the thermoplastic, to produce foams with good performance properties. In many applications the performance properties that are considered highly desirable include the production of high-quality closed cell foam that are low density (and therefore have a low weight in use) and at the same time having relatively high mechanical integrity and strength.

With respect to the selection of thermoplastic resin, EP 3,231,836 acknowledges that while there has been interest in thermoplastic resins, in particularly polyester-based resins, this interest has encountered difficulty in development, including difficulty in identifying suitable foaming grades of such resins. Moreover, while EP 3,231,836 notes that certain polyethylene terephthalate (PET) resins, including recycled versions of PET, can be melt-extruded with a suitable physical and/or chemical blowing agent to yield closed-cell foams with the potential for low density and good mechanical properties, it is not disclosed that any such resins are at once are able to produce foams with good environmental properties and good performance properties, and are also able to be formed from sustainable sources. The '836 application identifies several possible polyester resins to be used in the formation of open-celled foams, including polyethylene terephthalate, poly butylene terephthalate, poly cyclohexane terephthalate, polyethylene naphthalate, polyethylene furanoate or a mixture of two or more of these. While the use of polyester materials to make foams that have essentially no closed cells, as required by EP '836, may be beneficial for some applications, a disadvantage of such structures is that in general open cell foams will exhibit relatively poor mechanical strength properties.

CN 108484959 discloses that making foam products based on 2,5-furan dimethyl copolyester is problematic because of an asserted problem of dissolution of foaming agent into the polyester and proposes the use of a combination of a liquid blowing agent and a gaseous blowing agent and a particular process involving sequential use of these different classes of blowing agent.

US 2020/0308363 and US 2020/0308396 each disclose the production of amorphous polyester copolymers that comprise starting with a recycled polyester, of which only PET is exemplified, as the main component and then proceeding through a series of processing steps to achieve an amorphous co-polymer, that is, as copolymer having no crystallinity. A wide variety of different classes of blowing agent are mentioned for use with such amorphous polymers.

US 2020/0308363 and US 2020/0308396 each disclose the production of amorphous polyester copolymers that comprise starting with a recycled polyester, of which only PET is exemplified, as the main component and then proceeding through a series of processing steps to achieve an amorphous co-polymer, that is, as copolymer having no crystallinity. A wide variety of different classes of blowing agent are mentioned for use with such amorphous polymers.

Applicants have come to appreciate that one or more unexpected advantages can be achieved in connection with the formation of thermoplastic foams, and in particular extruded thermoplastic foams, by using a polyester resin as disclosed herein in combination with a blowing agent comprising one of more hydrohaloolefin as disclosed herein.

### SUMMARY

The present invention includes low-density, thermoplastic foam comprising:
(a) thermoplastic polymer cells comprising cell walls forming closed cells, wherein ethylene furanoate moieties are at least 1% by mole of the thermoplastic polymer; and
(b) 1,1-difluoroethane (HFC-152a) contained in the closed cells.

For the purposes of convenience, foams in accordance with this paragraph are referred to herein as Foam 1A.

The present invention also includes low-density, thermoplastic foam comprising:
(a) closed thermoplastic cells comprising cell walls forming closed cells, said cell walls consisting essentially of polyethylene furanoate that has been treated with a chain extender and that has a molecular weight of greater than 25,000; and
(b) 1,1-difluoroethane (HFC-152a) contained in the closed cells.

For the purposes of convenience, foams in accordance with this paragraph are referred to herein as Foam 1B.

The present invention includes low-density, thermoplastic foam comprising:
(a) closed thermoplastic cells comprising cell walls comprising polyethylene furanoate that has been treated with a chain extender and that has a molecular weight of greater than 25,000, wherein ethylene furanoate moieties are at least 70% by weight of the thermoplastic polymer; and
(b) 1,1-difluoroethane (HFC-152a) contained in the closed cells.

For the purposes of convenience, foams in accordance with this paragraph are referred to herein as Foam 1C.

The present invention includes low-density, closed-cell thermoplastic foam comprising:
(a) closed thermoplastic cells comprising cell walls comprising polyethylene furanoate that has been treated with a chain extender and that has a molecular weight of greater than 25,000, wherein ethylene furanoate moieties are at least 90% of the thermoplastic contains ethylene furanoate moieties; and
(b) 1,1-difluoroethane (HFC-152a) contained in the closed cells.

For the purposes of convenience, foams in accordance with this paragraph are referred to herein as Foam 1D.

The present invention includes low-density, thermoplastic foam comprising:
(a) thermoplastic polymer cells comprising cell walls wherein at least about 50% by volume of the cells are closed cells and wherein ethylene furanoate moieties are at least 50% by weight of the thermoplastic polymer; and
(b) 1,1-difluoroethane (HFC-152a) contained in the closed cells.

For the purposes of convenience, foams in accordance with this paragraph are referred to herein as Foam 1E.

The present invention includes low-density, thermoplastic foam comprising:
(a) thermoplastic polymer cells comprising cell walls comprising polyethylene furanoate that has been treated with a chain extender and that has a molecular weight of greater than 25,000, wherein ethylene furanoate moieties are at least 50% of the thermoplastic and wherein at least about 50% by volume of the cells are closed cells; and
(b) 1,1-difluoroethane (HFC-152a) contained in the closed cells.

For the purposes of convenience, foams in accordance with this paragraph are referred to herein as Foam 1F.

The present invention includes low-density, thermoplastic foam comprising:
(a) thermoplastic polymer cells comprising cell walls comprising polyethylene furanoate that has been treated with a chain extender and that has a molecular weight of greater than 25,000, wherein ethylene furanoate moieties are at least 50% of the thermoplastic and wherein at least about 75% by volume of the cells are closed cells; and
(b) 1,1-difluoroethane (HFC-152a) contained in the closed cells.

For the purposes of convenience, foams in accordance with this paragraph are referred to herein as Foam 1G.

The present invention includes low-density, thermoplastic foam comprising:
(a) thermoplastic polymer cells comprising cell walls comprising polyethylene furanoate that has been treated with a chain extender and that has a molecular weight of greater than 25,000, wherein ethylene furanoate moieties are at least 50% of the thermoplastic and wherein at least about 90% by volume of the cells are closed cells; and
(b) 1,1-difluoroethane (HFC-152a) contained in the closed cells.

For the purposes of convenience, foams in accordance with this paragraph are referred to herein as Foam 1H.

The present invention includes low-density, thermoplastic foam comprising:
(a) thermoplastic polymer cells comprising cell walls comprising polyethylene furanoate that has been treated with a chain extender and that has a molecular weight of greater than 50,000, wherein ethylene furanoate moieties are at least 50% of the thermoplastic and wherein at least about 50% by volume of the cells are closed cells; and
(b) 1,1-difluoroethane (HFC-152a) contained in the closed cells.

For the purposes of convenience, foams in accordance with this paragraph are referred to herein as Foam 1I.

The present invention includes low-density, thermoplastic foam comprising:
(a) thermoplastic polymer cells comprising cell walls comprising polyethylene furanoate that has been treated with a chain extender and that has a molecular weight of greater than 50,000, wherein ethylene furanoate moieties are at least 50% of the thermoplastic and wherein at least about 75% by volume of the cells are closed cells; and
(b) 1,1-difluoroethane (HFC-152a) contained in the closed cells.

For the purposes of convenience, foams in accordance with this paragraph are referred to herein as Foam 1J.

The present invention includes low-density, thermoplastic foam comprising:
(a) thermoplastic polymer cells comprising cell walls comprising polyethylene furanoate that has been treated with a chain extender and that has a molecular weight of greater than 50,000, wherein ethylene furanoate moieties are at least 50% of the thermoplastic and wherein at least about 90% by volume of the cells are closed cells; and
(b) 1,1-difluoroethane (HFC-152a) contained in the closed cells.

For the purposes of convenience, foams in accordance with this paragraph are referred to herein as Foam 1K.

The present invention includes low-density, thermoplastic foam comprising:
(a) thermoplastic polymer cells comprising cell walls comprising polyethylene furanoate that has been treated with a chain extender and that has a molecular weight of at least about 90,000, wherein ethylene furanoate moieties are at least 50% of the thermoplastic and wherein at least about 50% by volume of the cells are closed cells; and
(b) 1,1-difluorocthane (HFC-152a) contained in the closed cells.

For the purposes of convenience, foams in accordance with this paragraph are referred to herein as Foam 1L.

The present invention includes low-density, thermoplastic foam comprising:
(a) thermoplastic polymer cells comprising cell walls comprising polyethylene furanoate that has been treated with a chain extender and that has a molecular weight of at least about 90,000, wherein ethylene furanoate moieties are at least 50% of the thermoplastic and wherein at least about 75% by volume of the cells are closed cells; and
(b) 1,1-difluoroethane (HFC-152a) contained in the closed cells.

For the purposes of convenience, foams in accordance with this paragraph are referred to herein as Foam 1M.

The present invention includes low-density, thermoplastic foam comprising:
(a) thermoplastic polymer cells comprising cell walls comprising polyethylene furanoate that has been treated with a chain extender and that has a molecular weight of at least about 90,000, wherein ethylene furanoate moieties are at least 50% of the thermoplastic and wherein at least about 90% by volume of the cells are closed cells; and
(b) 1,1-difluoroethane (HFC-152a) contained in the closed cells.

For the purposes of convenience, foams in accordance with this paragraph are referred to herein as Foam IN.

The present invention includes low-density, closed-cell thermoplastic foam comprising:
(a) closed thermoplastic cells comprising cell walls consisting essentially of polyethylene furanoate; and
(b) 1,1-difluoroethane (HFC-152a) blowing agent contained in said closed cells, wherein said foam has a density of less than 0.3 g/cc. For the purposes of convenience, foams in accordance with this paragraph are referred to herein as Foam 2A.

The present invention includes low-density, closed-cell thermoplastic foam comprising:
(a) closed thermoplastic cells comprising cell walls consisting essentially of polyethylene furanoate; and
(b) 1,1-difluoroethane (HFC-152a) blowing agent contained said closed cells, wherein said foam has a density of less than 0.25 g/cc. For the purposes of convenience, foams in accordance with this paragraph are referred to herein as Foam 2B.

The present invention includes low-density, closed-cell thermoplastic foam comprising:
(a) thermoplastic cells comprising cell walls comprising polyethylene furanoate, wherein at least about 50% by volume of the cells are closed cells; and
(b) 1,1-difluoroethane (HFC-152a) blowing agent contained in said closed cells, wherein said foam has a relative foam density (RFD) of about 0.2 or less. For the purposes of convenience, foams in accordance with this paragraph are referred to herein as Foam 2C.

The present invention includes low-density, closed-cell thermoplastic foam comprising:
(a) thermoplastic cells comprising cell walls wherein: (1) ethylene furanoate moieties are at least 50% by weight of the thermoplastic polymer forming said sell walls; (ii) said thermoplastic polymer has been treated with a chain extender; and (iii) at least about 50% by volume of the cells are closed cells; and
(b) 1,1-difluoroethane (HFC-152a) blowing agent contained in said closed cells, wherein said foam has a relative foam density (RFD) of about 0.2 or less. For the purposes of convenience, foams in accordance with this paragraph are referred to herein as Foam 2D.

The present invention includes low-density, closed-cell thermoplastic foam comprising:
(a) thermoplastic cells comprising cell walls wherein: (1) ethylene furanoate moieties are at least 50% by weight of the thermoplastic polymer forming said sell walls; (ii) said thermoplastic polymer has been treated with a chain extender and has a molecular weight of greater than 25,000; and (iii) at least about 50% by volume of the cells are closed cells; and
(b) 1,1-difluorocthane (HFC-152a) blowing agent contained in said closed cells, wherein said foam has a relative foam density (RFD) of about 0.2. For the purposes of convenience, foams in accordance with this paragraph are referred to herein as Foam 2E.

The present invention includes low-density, closed-cell thermoplastic foam comprising:
(a) thermoplastic cells comprising cell walls wherein: (1) ethylene furanoate moieties are at least 50% by weight of the thermoplastic polymer forming said sell walls; (ii) said thermoplastic polymer has been treated with a chain extender and has a molecular weight of greater than 50,000; and (iii) at least about 50% by volume of the cells are closed cells; and
(b) 1,1-difluoroethane (HFC-152a) blowing agent contained in said closed cells, wherein said foam has a relative foam density (RFD) of about 0.2. For the purposes of convenience, foams in accordance with this paragraph are referred to herein as Foam 2F.

The present invention includes low-density, closed-cell thermoplastic foam comprising:
(a) thermoplastic cells comprising cell walls wherein: (1) ethylene furanoate moieties are at least 50% by weight of the thermoplastic polymer forming said sell walls; (ii) said thermoplastic polymer has been treated with a chain extender and has a molecular weight of at least about 90,000; and (iii) at least about 50% by volume of the cells are closed cells; and
(b) 1,1-difluoroethane (HFC-152a) blowing agent contained in said closed cells, wherein said foam has a relative foam density (RFD) of about 0.2. For the purposes of convenience, foams in accordance with this paragraph are referred to herein as Foam 2G.

The present invention includes low-density, closed-cell thermoplastic foam comprising:
(a) thermoplastic cells comprising cell walls wherein: (1) ethylene furanoate moieties are at least 50% by weight of the thermoplastic polymer forming said sell walls; (ii) said thermoplastic polymer has been treated with a chain extender and has a molecular weight of greater than 25,000; and (iii) at least about 75% by volume of the cells are closed cells; and
(b) 1,1-difluoroethane (HFC-152a) blowing agent contained in said closed cells, wherein said foam has a relative foam density (RFD) of about 0.2. For the purposes of convenience, foams in accordance with this paragraph are referred to herein as Foam 2H.

The present invention includes low-density, closed-cell thermoplastic foam comprising:
(a) thermoplastic cells comprising cell walls wherein: (1) ethylene furanoate moieties are at least 50% by weight of the thermoplastic polymer forming said sell walls; (ii) said thermoplastic polymer has been treated with a chain extender and has a molecular weight of greater than 50,000; and (iii) at least about 75% by volume of the cells are closed cells; and
(b) 1,1-difluorocthane (HFC-152a) blowing agent contained in said closed cells, wherein said foam has a relative foam density (RFD) of about 0.2. For the purposes of convenience, foams in accordance with this paragraph are referred to herein as Foam 2I.

The present invention includes low-density, closed-cell thermoplastic foam comprising:
(a) thermoplastic cells comprising cell walls wherein: (1) ethylene furanoate moieties are at least 50% by weight of the thermoplastic polymer forming said sell walls; (ii) said thermoplastic polymer has been treated with a chain extender and has a molecular weight of at least about 90,000; and (iii) at least about 75% by volume of the cells are closed cells; and
(b) 1,1-difluoroethane (HFC-152a) blowing agent contained in said closed cells, wherein said foam has a relative foam density (RFD) of about 0.2. For the purposes of convenience, foams in accordance with this paragraph are referred to herein as Foam 2J.

The present invention includes low-density, closed-cell thermoplastic foam comprising:
(a) thermoplastic cells comprising cell walls wherein: (1) ethylene furanoate moieties are at least 50% by weight of the thermoplastic polymer forming said sell walls; (ii) said thermoplastic polymer has been treated with a chain extender and has a molecular weight of greater than 25,000; and (iii) at least about 90% by volume of the cells are closed cells; and
(b) 1,1-difluoroethane (HFC-152a) blowing agent contained in said closed cells, wherein said foam has a relative foam density (RFD) of about 0.2. For the purposes of convenience, foams in accordance with this paragraph are referred to herein as Foam 2K.

The present invention includes low-density, closed-cell thermoplastic foam comprising:
(a) thermoplastic cells comprising cell walls wherein: (1) ethylene furanoate moieties are at least 50% by weight of the thermoplastic polymer forming said sell walls; (ii) said thermoplastic polymer has been treated with a chain extender and has a molecular weight of greater than 50,000; and (iii) at least about 90% by volume of the cells are closed cells; and
(b) 1,1-difluoroethane (HFC-152a) blowing agent contained in said closed cells, wherein said foam has a relative foam density (RFD) of about 0.2. For the purposes of convenience, foams in accordance with this paragraph are referred to herein as Foam 2L.

The present invention includes low-density, closed-cell thermoplastic foam comprising:
(a) thermoplastic cells comprising cell walls wherein: (1) ethylene furanoate moieties are at least 50% by weight of the thermoplastic polymer forming said sell walls; (ii) said thermoplastic polymer has been treated with a chain extender and has a molecular weight of at least about 90,000; and (iii) at least about 90% by volume of the cells are closed cells; and
(b) 1,1-difluoroethane (HFC-152a) blowing agent contained in said closed cells, wherein said foam has a relative foam density (RFD) of about 0.2. For the purposes of convenience, foams in accordance with this paragraph are referred to herein as Foam 2M.

The present invention includes low-density, thermoplastic foam comprising:
(a) thermoplastic polymer cells comprising cell walls forming closed cells, wherein said thermoplastic polymer has a crystallinity of at least about 5% and consists essentially of ethylene furanoate moieties and optionally ethylene terephthalate moieties, wherein said polymer comprises from about 1 mole % to about 100 mole % of ethylene furanoate moieties and optionally at least about 1 mole % ethylene terephthalate moieties; and
(b) 1,1-difluoroethane (HFC-152a) contained in the closed cells.

For the purposes of convenience, foams in accordance with this paragraph are referred to herein as Foam 3A.

The present invention includes low-density, thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises from about 1 mole % to about 20 mole % of ethylene furanoate moieties and at least about 1 mole % ethylene terephthalate moieties; and
(b) 1,1-difluoroethane (HFC-152a) contained in the closed cells.

For the purposes of convenience, foams in accordance with this paragraph are referred to herein as Foam 3B.

The present invention includes low-density, thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises from about 1 mole % to about 20 mole % of ethylene furanoate moieties and from about 80 mole % to about 99 mole % ethylene terephthalate moieties; and
(b) 1,1-difluoroethane (HFC-152a) contained in the closed cells.

For the purposes of convenience, foams in accordance with this paragraph are referred to herein as Foam 3C.

The present invention includes low-density, thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises from about 1 mole % to about 10 mole % of ethylene furanoate moieties and from about 90 mole % to about 99 mole % ethylene terephthalate moieties; and
(b) 1,1-difluoroethane (HFC-152a) contained in the closed cells.

For the purposes of convenience, foams in accordance with this paragraph are referred to herein as Foam 3D.

The present invention includes low-density, thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises from about 1 mole % to about 5 mole % of ethylene furanoate moieties and from about 95 mole % to about 99 mole % ethylene terephthalate moieties; and
(b) 1,1-difluoroethane (HFC-152a) contained in the closed cells.

For the purposes of convenience, foams in accordance with this paragraph are referred to herein as Foam 3E.

The present invention includes low-density, thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises from about 0.5 mole % to about 2 mole % of ethylene furanoate moieties and from about 98 mole % to about 99.5 mole % ethylene terephthalate moieties; and
(b) 1,1-difluorocthanc (HFC-152a) contained in the closed cells.

For the purposes of convenience, foams in accordance with this paragraph are referred to herein as Foam 3F.

The present invention includes low-density, thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises about 1 mole % of ethylene furanoate moieties and about 99 mole % ethylene terephthalate moieties; and
(b) 1,1-difluoroethane (HFC-152a) contained in the closed cells.

For the purposes of convenience, foams in accordance with this paragraph are referred to herein as Foam 3G.

The present invention includes low-density, thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises about 0.5 mole % of ethylene furanoate moieties and about 99.5 mole % ethylene terephthalate moieties; and
(b) 1,1-difluoroethane (HFC-152a) contained in the closed cells.

For the purposes of convenience, foams in accordance with this paragraph are referred to herein as Foam 3H.

The present invention includes low-density, thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises about 5 mole % of ethylene furanoate moieties and about 95 mole % ethylene terephthalate moieties; and
(b) 1,1-difluoroethane (HFC-152a) contained in the closed cells.

For the purposes of convenience, foams in accordance with this paragraph are referred to herein as Foam 3I.

The present invention includes low-density, thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises about 10 mole % of ethylene furanoate moieties and about 90 mole % ethylene terephthalate moieties; and
(b) 1,1-difluoroethane (HFC-152a) contained in the closed cells.

For the purposes of convenience, foams in accordance with this paragraph are referred to herein as Foam 3J.

The present invention includes low-density, thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises about 20 mole % of ethylene furanoate moieties and about 80 mole % ethylene terephthalate moieties; and
(b) 1,1-difluoroethane (HFC-152a) contained in the closed cells.

For the purposes of convenience, foams in accordance with this paragraph are referred to herein as Foam 3K.

The present invention includes low-density, thermoplastic foam comprising:
(a) thermoplastic polymer cells comprising cell walls comprising polyethylene furanoate wherein at least 25% of said cells are closed cells; and
(b) 1,1-difluoroethane (HFC-152a) contained in the closed cells.

For the purposes of convenience, foams in accordance with this paragraph are referred to herein as Foam 3L.

The present invention includes low-density, closed-cell thermoplastic foam comprising:
(a) closed thermoplastic cells comprising cell walls consisting essentially of polyethylene furanoate; and
(b) 1,1-difluoroethane (HFC-152a) contained in said closed cells, wherein said foam has a density of less than 0.3 g/cc. For the purposes of convenience, foams in accordance with this paragraph are referred to herein as Foam 4A.

The present invention includes low-density, closed-cell thermoplastic foam comprising:
(a) closed thermoplastic cells comprising cell walls consisting essentially of polyethylene furanoate; and
(b) 1,1-difluoroethane (HFC-152a) contained in said closed cells, wherein said foam has a density of less than 0.2 g/cc. For the purposes of convenience, foams in accordance with this paragraph are referred to herein as Foam 4B.

The present invention includes low-density, closed-cell thermoplastic foam comprising:
(a) closed thermoplastic cells comprising cells walls consisting essentially of polyethylene furanoate; and
(b) 1,1-difluoroethane (HFC-152a) contained in said closed cells, wherein said foam has a density of 0.1 g/cc or less. For the purposes of convenience, foams in accordance with this paragraph are referred to herein as Foam 4C.

The present invention includes closed-cell thermoplastic foam comprising:
(a) closed thermoplastic cells comprising cells walls consisting essentially of polyethylene furanoate wherein at least about 50% by volume of the cells are closed cells; and
(b) 1,1-difluoroethane (HFC-152a) contained in said closed cells. For the purposes of convenience, foams in accordance with this paragraph are referred to herein as Foam 4D.

The present invention includes closed-cell thermoplastic foam comprising:
(a) closed thermoplastic cells comprising cells walls consisting essentially of polyethylene furanoate wherein at least about 75% by volume of the cells are closed cells; and
(b) 1,1-difluoroethane (HFC-152a) contained in said closed cells. For the purposes of convenience, foams in accordance with this paragraph are referred to herein as Foam 4E.

The present invention includes closed-cell thermoplastic foam comprising:
(a) closed thermoplastic cells comprising cells walls consisting essentially of polyethylene furanoate wherein at least about 90% by volume of the cells are closed cells; and
(b) 1,1-difluoroethane (HFC-152a) contained in said closed cells. For the purposes of convenience, foams in accordance with this paragraph are referred to herein as Foam 4F.

The present invention includes foamable thermoplastic compositions comprising:
(a) thermoplastic material consisting essentially of polyethylene furanoate that has been treated with a chain extender and that has a molecular weight of greater than 25,000, wherein at least 50% of the thermoplastic contains ethylene furanoate moieties; and
(b) 1,1-difluoroethane (HFC-152a). For the purposes of convenience, foamable compositions in accordance with this paragraph are referred to herein as Foamable Composition 1A.

The present invention includes foamable thermoplastic compositions comprising:
(a) thermoplastic material consisting essentially of polyethylene furanoate having a molecular weight of greater than 100,000, wherein at least 50% of the thermoplastic contains ethylene furanoate moieties.
(b) 1,1-difluoroethane (HFC-152a). For the purposes of convenience, foamable compositions in accordance with this paragraph are referred to herein as Foamable Composition 1B.

The present invention includes foamable thermoplastic compositions comprising:
(a) thermoplastic material consisting essentially of chain-extended polyethylene furanoate having a molecular weight of greater than 100,000, wherein at least 90% of the thermoplastic contains ethylene furanoate moieties; and
(b) 1,1-difluoroethane (HFC-152a). For the purposes of convenience, foamable compositions in accordance with this paragraph are referred to herein as Foamable Composition 1C.

The present invention also provides methods for forming thermoplastic foam comprising foaming a foamable composition of the present invention, including each of the Foamable Compositions 1A-1C. For the purposes of convenience, methods in accordance with this paragraph are referred to herein as Foaming Method 1.

The present invention also provides methods for forming extruded thermoplastic foam comprising extruding a foamable composition of the present invention, including each of the Foamable Compositions 1A-1C. For the purposes of convenience, methods in accordance with this paragraph are referred to herein as Foaming Method 2.

### BRIEF DESCRIPTION OF THE DRAWING

FIG. 1 is a schematic representation of an extrusion system and process according to one embodiment of the invention and according to the examples herein.

FIG. 2 is a cross-section of an exemplary covered foam of the present invention in the particular form of a sandwich structure.

FIG. 3 is a schematic representation of an exemplary wind turbine.

FIG. 4 is a semi-schematic representation of an exemplary wind turbine.

FIG. 5A is cross-section of an exemplary wind turbine blade.

FIG. 5B is cross-section of an exemplary wind turbine blade.

FIG. 5C is cross-section of an exemplary wind turbine blade.

### DEFINITIONS

HFC-152a means 1,1-difluoroethane.

1234ze means 1,1,1,3-tetrafluoropropene, without limitation as to isomeric form.

Trans1234ze and 1234ze (E) each means trans1,3,3,3-tetrafluoropropene.

Cis1234ze and 1234ze (Z) each means cis1,3,3,3-tetrafluoropropene.

1234yf means 2,3,3,3-tetrafluoropropene.

1233zd means 1-chloro-3,3,3-trifluoropropene, without limitation as to isomeric form.

Trans1233zd and 1233zd (E) each means trans 1-chloro-3,3,3-trifluoropropene.

1224 yd means cis1-chloro-2,3,3,3-tetrafluoropropane, without limitation as to isomeric form.

1336mzz means 1,1,1,4,4,4-hexafluorobutene, without limitation as to isomeric form.

Trans1336mzz and 1336mzz (E) each means trans1,1,1,4,4,4-hexafluorobutene.

Cis1336mzz and 1336mzz (Z) each means cis1,1,1,4,4,4-hexafluorobutene.

Closed cell foam means that a substantial volume percentage of the cells in the foam are closed, for example, about 20% by volume or more.

Ethylene furanoate moiety means the following structure:

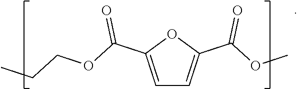

FDCA means 2,5-furandicarboxylic acid and has the following structure:

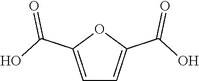 [SMILES: O=C(O)c1ccc(C(=O)O)o1]

MEG means monoethylene glycol and has the following structure:

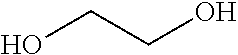

FDME means dimethyl 2,5-furandicarboxylate and has the following structure:

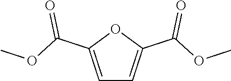

PEF homopolymer means a polymer having at least 99 mole % of ethylene furanoate moieties.

PEF copolymer means a polymer having at least about 1 mole % ethylene furanoate moieties and more than 1% of polymer moieties other than ethylene furanoate moieties.

PEF: PET copolymer means a polymer having at least about 1 mole % ethylene furanoate moieties and at least 1% of ethylene terephthalate moieties.

PEF means poly (ethylene furanoate) and encompasses and is intended to reflect a description of PEF homopolymer and PEF coploymer.

Ethylene terephthalate moiety means the following structure:

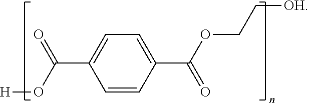

SSP means solid-state polymerization.

PMDA means pyromellitic dianhydride having the following structure:

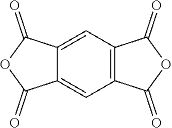 [SMILES: O=c1oc(=O)c2cc3c(=O)oc(=O)c3cc12]

PMDA means pyromellitic dianhydride having the following structure:

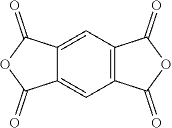 [SMILES: O=c1oc(=O)c2cc3c(=O)oc(=O)c3cc12]

### DETAILED DESCRIPTION

### Poly (Ethylene Furanoate)

The present invention relates to foams and foam article that comprise cell walls formed of PEF.

The PEF which forms the cells walls of the foams and foam articles of the present invention can be PEF homopolymer or PEF copolymer and particularly PEF: PET copolymer.

PEF homopolymer is a known material that is known to be formed by either: (a) esterification and polycondensation of FDCA with MEG; or (b) transesterification and polycondensation of FDME with MEG as illustrated below for example:

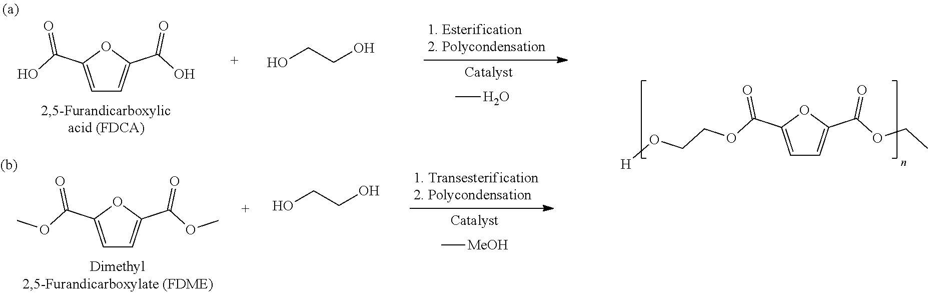

A detailed description of such know esterification and polycondensation synthesis methods is provided in GB Patent 621971 (Drewitt, J. G. N., and Lincocoln, J., entitled “Improvements in Polymers”), which is incorporated herein by reference. A detailed description of such know transesterification and polycondensation synthesis methods is provided in Gandini, A., Silvestre, A. J. D., Neto, C. P., Sousa, A. F., and Gomes, M. (2009), “The furan counterpart of poly (ethylene terephthalate): an alternative material based on renewable resources.”, J. Polym. Sci. Polym. Chem. 47, 295-298. doi: 10.1002/pola.23130, which is incorporated herein by reference.

### Foams

The foams of the present invention are formed from either PEF homopolymers, PEF copolymers, or a combination/mixture of these.

The foams of the present invention, including each of Foams 1-4, are formed from either PEF homopolymers, PEF copolymers, or a combination/mixture of these.

The foams of the present invention, including each of Foams 1-4, may be formed in preferred embodiments from PEF homopolymer in which the polymer has at least 99.5% by weight, or at least 99.9% of by weight, of ethylene furanoate moieties.

It is contemplated that the foams of the present invention, including each of Foams 1-4, may be formed in preferred embodiments from PEF copolymer in which the polymer, including PEF copolymer, has from about 60% to about 99% by weight of ethylene furanoate moieties, or from about 70% to about 99% by weight of ethylene furanoate moieties, or from about 80% to about 99% by weight of ethylene furanoate moieties, or from about 90% to about 99% by weight of ethylene furanoate moieties or from about 95% to about 99.5% by weight of ethylene furanoate moieties.

It is contemplated that the foams of the present invention, including each of Foams 1-4, may be formed in preferred embodiments from PEF copolymer in which the polymer, including PEF copolymer, has from about 40% to about 1% by weight of ethylene furanoate moieties, or from about 30% to about 1% by weight of ethylene furanoate moieties, or from about 20% to about 1% by weight of ethylene furanoate moieties, or from about 10% to about 1% by weight of ethylene furanoate moieties, or from about 5% to about 1% by weight of ethylene furanoate moieties, or from about 5% to about 0.5% by weight of ethylene furanoate moieties.

It is contemplated that the foams of the present invention, including each of Foams 1-4, may be formed in preferred embodiments from PEF copolymer in which the polymer, including PEF copolymer, has from about 40% to about 1% by mole of ethylene furanoate moieties, or from about 30% to about 1% by mole of ethylene furanoate moieties, or from about 20% to about 1% by mole of ethylene furanoate moieties, or from about 10% to about 1% by mole of ethylene furanoate moieties, or from about 5% to about 1% by mole of ethylene furanoate moieties, or from about 5% to about 0.5% by mole of ethylene furanoate moieties.

It is contemplated that the foams of the present invention, including each of Foams 1-4, may be formed in preferred embodiments from PEF copolymer in which the polymer, including PEF copolymer, has from about 40% to about 1% by mole of ethylene furanoate moieties and from about 60% to about 99% by mole of ethylene terephthalate moieties, or from about 30% to about 1% by mole of ethylene furanoate moieties and from about 70% to about 99% by mole of ethylene terephthalate moieties, or from about 20% to about 1% by mole of ethylene furanoate moieties and from about 80% to about 99% by mole of ethylene terephthalate moieties, or from about 10% to about 1% by mole of ethylene furanoate moieties and from about 90% to about 99% by mole of ethylene terephthalate moieties, or from about 5% to about 1% by mole of ethylene furanoate moieties and from about 95% to about 99% by mole of ethylene terephthalate moieties, or from about 5% to about 0.5% by mole of ethylene furanoate moieties and from about 95% to about 99.5% by mole of ethylene terephthalate moieties.

For those embodiments of the present invention involving PEF copolymers, it is contemplated that those skilled in the art will be able, in view of the teachings contained herein, to select the type and amount of co-polymeric materials to be used within each of the ranges described herein to achieve the desired enhancement/modification of the polymer without undue experimentation.

For those embodiments of the present invention involving the use of PEF homopolymer or PEF copolymer, it is contemplated that such material may be formed with a wide variety of molecular weights and physical properties within the scope of the present invention. In preferred embodiments, the foams, including each of Foams 1-4, are formed from PEF having the ranges of characteristics identified in Table 1 below, which are measured as described in the Examples hereof:

TABLE 1

| | | First | Second | |
|---|---|---|---|---|
| | Broad | Intermediate | Intermediate | Narrow |
| Polymer property | Range | Range | Range | Range |
| Molecular weight | 25,000- | 45,000- | 45,000- | 55,000- |
| | 150,000 | 130,000 | 130,000 | 120,000 |
| Glass Transition | 75- | 75- | 75- | 75- |
| Temperature, T_{g}, ° C. | 100 | 95 | 95 | 95 |
| Melting Temperature, | 180- | 190- | 190- | 200- |
| Tₘ, ° C. | 250 | 240 | 240 | 230 |
| Decomposition | 300- | 320- | 320- | 330- |
| Temperature, T_{d}, ° C. | 420 | 400 | 400 | 380 |
| Crystallinity, % | 5- | 25- | 30- | 40- |
| | 75 | 75 | 60 | 50 |

In general, it is contemplated that those skilled in the art will be able to formulate PEF polymers within the range of properties described above without undue experimentation in view of the teachings contained herein. In preferred embodiments, however, PEF (including PEF homopolymer and PEF copolymer) having these properties is achieved using one or more of the synthesis methods described above, in combination with a variety of known supplemental processing techniques, including by treatment with chain extenders, such as PMDA (and alternatives and supplements to PMDA, such as ADR, PENTA and talc as described in the present examples, and others) and/or SSP processing. It is believed that, in view of the disclosures contained herein, including the polymer synthesis described in the Examples below, a person skilled in the art will be able to produce PEF polymers within the range of characteristics described in the table above and elsewhere herein, including the use of methods to enhance crystallization of polymers, including. Such processing conditions include methods of increasing crystallization as described herein, including Thermoplastic Forming Method 1 of the present invention and such methods as are disclosed in the Examples hereof.

An example of the process for chain extension treatment of polyesters is provided in the article “Recycled poly (ethylene terephthalate) chain extension by a reactive extrusion process,” Firas Awaja, Fugen Daver, Edward Kosior, 16 Aug. 2004, available at https://doi.org/10.1002/pen.20155, which is incorporated herein by reference. As explained in US 1009/0264545, which is incorporated herein by reference, chain extenders generally are typically compounds that are at least di-functional with respect to reactive groups which can react with end groups or functional groups in the polyester to extend the length of the polymer chains. In certain cases, as disclosed herein, such a treatment can advantageously increase the average molecular weight of the polyester to improve its melt strength and/or other important properties. The degree of chain extension achieved is related, at least in part, to the structure and functionalities of the compounds used. Various compounds are useful as chain extenders. Non-limiting examples of chain extenders include trimellitic anhydride, pyromellitic dianhydride (PMDA), trimellitic acid, haloformyl derivatives thereof, or compounds containing multi-functional epoxy (e.g., glycidyl), or oxazoline functional groups. Nanocomposite material such as finely dispersed nanoclay may optionally be used for controlling viscosity. Commercial chain extenders include CESA-Extend from Clariant, Joncryl from BASF, or Lotader from Arkema. The amount of chain extender can vary depending on the type and molecular weight of the polyester components. The amount of chain extender used to treat the polymer can vary widely, and in preferred embodiments ranges from about 0.1 to about 5 wt. %, or preferably from about 0.1 to about 1.5 wt. %. Examples of chain extenders are also described in U.S. Pat. No. 4,219,527, which is incorporated herein by reference.

An example of the process for SSP processing of poly (ethylene furanoate) is provided in the article “Solid-State Polymerization of Poly (ethylene furanoate) Biobased Polyester, I: Effect of Catalyst Type on Molecular Weight Increase,”

Nejib Kasmi, Mustapha Majdoub, George Z. Papageorgiou, Dimitris S. Achilias, and Dimitrios N. Bikiaris, which is incorporated herein by reference.

The PEF thermoplastic polymers which are especially advantageous for making foamable compositions and foams of the present invention are identified in the following Thermoplastic Polymer Table (Table 2A), wherein all numerical values in the table are understood to be preceded by the word “about.”

TABLE 2A
THERMOPLASTIC POLYMER TABLE

| | Ethylene | | | | |
|---|---|---|---|---|---|
| Thermoplastic | furanoate | Tannin | Other | | Crystal- |
| Polymer (TPP) | moieties, | moieties, | moieties, | MW, | linity, |
| Number | wt % | wt % | wt % | Kg/mol | % |
| TPP1A | 100 | 0 | 0 | 25-180 | 25-100 |
| TPP1B | 100 | 0 | 0 | 25-75 | 30-60 |
| TPP1C | 100 | 0 | 0 | 80-130 | 30-60 |
| TPP1D | 100 | 0 | 0 | 90-120 | 35-50 |
| TPP1E | 100 | 0 | 0 | 90-110 | 35-45 |
| TPP2A | 85 to <100 | >0 to <15 | 0 | 25-180 | 25-100 |
| TPP2B | 85 to <100 | >0 to <15 | 0 | 25-75 | 30-60 |
| TPP2C | 85 to <100 | >0 to <15 | 0 | 80-130 | 30-60 |
| TPP2D | 85 to <100 | >0 to <15 | 0 | 90-120 | 35-50 |
| TPP2E | 85 to <100 | >0 to <15 | 0 | 90-110 | 35-45 |
| TPP3A | 5 to 95 | 0 | 5 to 95 | 25-180 | 25-100 |
| TPP3B | 5 to 95 | 0 | 5 to 95 | 25-75 | 30-60 |
| TPP3C | 5 to 95 | 0 | 5 to 95 | 80-130 | 30-60 |
| TPP3D | 5 to 95 | 0 | 5 to 95 | 90-120 | 35-50 |
| TPP3E | 5 to 95 | 0 | 5 to 95 | 90-110 | 35-45 |
| TPP4A | 5 to 95 | >0-<15 | 5 to 95 | 25-180 | 25-100 |
| TPP4B | 5 to 95 | >0-<15 | 5 to 95 | 25-75 | 30-60 |
| TPP4C | 5 to 95 | >0-<15 | 5 to 95 | 80-130 | 30-60 |
| TPP4D | 5 to 95 | >0-<15 | 5 to 95 | 90-120 | 35-50 |
| TPP4E | 5 to 95 | >0-<15 | 5 to 95 | 90-110 | 35-45 |
| TPP5A | 10 | 0 | 90 | 25-180 | 25-100 |
| TPP5B | 10 | 0 | 90 | 25-75 | 30-60 |
| TPP5C | 10 | 0 | 90 | 80-130 | 30-60 |
| TPP5D | 10 | 0 | 90 | 90-120 | 35-50 |
| TPP5E | 10 | 0 | 90 | 90-110 | 35-45 |
| TPP6A | 90 | 0 | 10 | 25-180 | 25-100 |
| TPP6B | 90 | 0 | 10 | 25-75 | 30-60 |
| TPP6C | 90 | 0 | 10 | 80-130 | 30-60 |
| TPP6D | 90 | 0 | 10 | 90-120 | 35-50 |
| TPP6E | 90 | 0 | 10 | 90-110 | 35-45 |

The PEF thermoplastic polymers which are especially advantageous for making foamable compositions and foams of the present invention also include those materials identified in the following Thermoplastic Polymer Table (Table 2B), wherein all numerical values in the table are understood to be preceded by the word “about.”

TABLE 2B
THERMOPLASTIC POLYMER TABLE

| Thermo- | | | | | |
|---|---|---|---|---|---|
| plastic | Ethylene | | Ethylene | | |
| Polymer | furanoate | Tannin | Terephalate | MW, | Crystal- |
| (TPP) | moieties, | moieties, | moieties, | Kg/ | linity, |
| Number | wt % | wt % | wt % | mol | % |
| TPP7A | 100 | 0 | 0 | 25-180 | 25-100 |
| TPP7B | 100 | 0 | 0 | 25-75 | 30-60 |
| TPP7C | 100 | 0 | 0 | 80-130 | 30-60 |
| TPP7D | 100 | 0 | 0 | 90-120 | 35-50 |
| TPP7E | 100 | 0 | 0 | 90-110 | 35-45 |
| TPP8A | 85 to <100 | >0 to <15 | 0 | 25-180 | 25-100 |
| TPP8B | 85 to <100 | >0 to <15 | 0 | 25-75 | 30-60 |
| TPP8C | 85 to <100 | >0 to <15 | 0 | 80-130 | 30-60 |
| TPP8D | 85 to <100 | >0 to <15 | 0 | 90-120 | 35-50 |
| TPP8E | 85 to <100 | >0 to <15 | 0 | 90-110 | 35-45 |
| TPP8A | 5 to 95 | 0 | 5 to 95 | 25-180 | 25-100 |
| TPP8B | 5 to 95 | 0 | 5 to 95 | 25-75 | 30-60 |
| TPP8C | 5 to 95 | 0 | 5 to 95 | 80-130 | 30-60 |
| TPP8D | 5 to 95 | 0 | 5 to 95 | 90-120 | 35-50 |
| TPP8E | 5 to 95 | 0 | 5 to 95 | 90-110 | 35-45 |
| TPP9A | 5 to 95 | >0-<15 | 5 to 95 | 25-180 | 25-100 |
| TPP9B | 5 to 95 | >0-<15 | 5 to 95 | 25-75 | 30-60 |
| TPP9C | 5 to 95 | >0-<15 | 5 to 95 | 80-130 | 30-60 |
| TPP9D | 5 to 95 | >0-<15 | 5 to 95 | 90-120 | 35-50 |
| TPP9E | 5 to 95 | >0-<15 | 5 to 95 | 90-110 | 35-45 |
| TPP10A | 10 | 0 | 90 | 25-180 | 25-100 |
| TPP10B | 10 | 0 | 90 | 25-75 | 30-60 |
| TPP10C | 10 | 0 | 90 | 80-130 | 30-60 |
| TPP10D | 10 | 0 | 90 | 90-120 | 35-50 |
| TPP10E | 10 | 0 | 90 | 90-110 | 35-45 |
| TPP11A | 90 | 0 | 10 | 25-180 | 25-100 |
| TPP11B | 90 | 0 | 10 | 25-75 | 30-60 |
| TPP11C | 90 | 0 | 10 | 80-130 | 30-60 |
| TPP11D | 90 | 0 | 10 | 90-120 | 35-50 |
| TPP11E | 90 | 0 | 10 | 90-110 | 35-45 |

The PEF thermoplastic polymers which are especially advantageous for making foamable compositions and foams of the present invention also include those materials identified in the following Thermoplastic Polymer Table (Table 2C), wherein all numerical values in the table are understood to be preceded by the word “about.”

TABLE 2C
THERMOPLASTIC POLYMER TABLE

| Thermo- | | | | | |
|---|---|---|---|---|---|
| plastic | Ethylene | | Ethylene | | |
| Polymer | furanoate | Tannin | Terephalate | MW, | Crystal- |
| (TPP) | moieties, | moieties, | moieties, | Kg/ | linity, |
| Number | mole % | mole % | mole % | mol | % |
| TPP12A | 100 | 0 | 0 | 25-180 | 25-100 |
| TPP12B | 100 | 0 | 0 | 25-75 | 30-60 |
| TPP12C | 100 | 0 | 0 | 80-130 | 30-60 |
| TPP12D | 100 | 0 | 0 | 90-120 | 35-50 |
| TPP12E | 100 | 0 | 0 | 90-110 | 35-45 |
| TPP13A | 85 to <100 | >0 to <15 | 0 | 25-180 | 25-100 |
| TPP13B | 85 to <100 | >0 to <15 | 0 | 25-75 | 30-60 |
| TPP13C | 85 to <100 | >0 to <15 | 0 | 80-130 | 30-60 |
| TPP13D | 85 to <100 | >0 to <15 | 0 | 90-120 | 35-50 |
| TPP13E | 85 to <100 | >0 to <15 | 0 | 90-110 | 35-45 |
| TPP14A | 5 to 95 | 0 | 5 to 95 | 25-180 | 25-100 |
| TPP14B | 5 to 95 | 0 | 5 to 95 | 25-75 | 30-60 |
| TPP14C | 5 to 95 | 0 | 5 to 95 | 80-130 | 30-60 |
| TPP14D | 5 to 95 | 0 | 5 to 95 | 90-120 | 35-50 |
| TPP14E | 5 to 95 | 0 | 5 to 95 | 90-110 | 35-45 |
| TPP15A | 5 to 95 | >0-<15 | 5 to 95 | 25-180 | 25-100 |
| TPP15B | 5 to 95 | >0-<15 | 5 to 95 | 25-75 | 30-60 |
| TPP15C | 5 to 95 | >0-<15 | 5 to 95 | 80-130 | 30-60 |
| TPP16D | 5 to 95 | >0-<15 | 5 to 95 | 90-120 | 35-50 |
| TPP16E | 5 to 95 | >0-<15 | 5 to 95 | 90-110 | 35-45 |
| TPP17A | 10 | 0 | 90 | 25-180 | 25-100 |
| TPP17B | 10 | 0 | 90 | 25-75 | 30-60 |
| TPP17C | 10 | 0 | 90 | 80-130 | 30-60 |
| TPP17D | 10 | 0 | 90 | 90-120 | 35-50 |
| TPP17E | 10 | 0 | 90 | 90-110 | 35-45 |
| TPP18A | 90 | 0 | 10 | 25-180 | 25-100 |
| TPP18B | 90 | 0 | 10 | 25-75 | 30-60 |
| TPP18C | 90 | 0 | 10 | 80-130 | 30-60 |
| TPP18D | 90 | 0 | 10 | 90-120 | 35-50 |
| TPP18E | 90 | 0 | 10 | 90-110 | 35-45 |
| TPP19A | 5 | 0 | 95 | 25-180 | 25-100 |
| TPP19B | 5 | 0 | 95 | 25-75 | 30-60 |
| TPP19C | 5 | 0 | 95 | 80-130 | 30-60 |
| TPP19D | 5 | 0 | 95 | 90-120 | 35-50 |
| TPP19E | 5 | 0 | 95 | 90-110 | 35-45 |
| TPP20A | 1 | 0 | 99 | 25-180 | 25-100 |
| TPP20B | 1 | 0 | 99 | 25-75 | 30-60 |
| TPP20C | 1 | 0 | 99 | 80-130 | 30-60 |
| TPP20D | 1 | 0 | 99 | 90-120 | 35-50 |
| TPP20E | 1 | 0 | 99 | 90-110 | 35-45 |
| TPP21A | 1-20 | 0 | 80-99 | 25-180 | 25-100 |
| TPP21B | 1-20 | 0 | 80-99 | 25-75 | 30-60 |
| TPP21C | 1-20 | 0 | 80-99 | 80-130 | 30-60 |
| TPP21D | 1-20 | 0 | 80-99 | 90-120 | 35-50 |
| TPP21E | 1-20 | 0 | 80-99 | 90-110 | 35-45 |
| TPP22A | 1-10 | 0 | 80-99 | 25-180 | 25-100 |
| TPP22B | 1-10 | 0 | 90-99 | 25-75 | 30-60 |
| TPP22C | 1-10 | 0 | 90-99 | 80-130 | 30-60 |
| TPP22D | 1-10 | 0 | 90-99 | 90-120 | 35-50 |
| TPP22E | 1-10 | 0 | 90-99 | 90-110 | 35-45 |

For the purposes of definition of terms used herein, it is to be noted that reference will be made at various locations herein to the thermoplastic polymers identified in the first column in each of rows in the TPP table above, and reference to each of these numbers is a reference to a thermoplastic polymer as defined in the corresponding columns of that row. Reference to a group of TPPs that have been defined in the table above by reference to a TPP number means separately and individually each such numbered TPP, including each TPP having the indicated number, including any such number that has a suffix. For example, reference to TPP1 is a separate and independent reference to TPP1A, TPP1B, TPP1C, TPP1D and TPP1E. Reference to TPP1-TPP2 is a separate and independent reference to TPP1A, TPP1B, TPP1C, TPP1D, TTP1E, TPP2A, TPP2B, TPP2C, TPP2D and TPP1E. This use convention is used for the Foamable Composition Table and the Foam Table below as well.

### Blowing Agent

As explained in detail herein, the present invention involves applicant's discovery that HFC-152a as a blowing agent in the foamable compositions, the foams and the methods of the present invention is capable of providing foamable PEF compositions and PEF foams having a difficult to achieve a surprising combination of physical properties, including low density as well as good mechanical strengths properties.

The blowing agent used in accordance with the present invention thus preferably comprises HFC-152a. For the purposes of convenience, a blowing agent in accordance with this paragraph is sometimes referred to herein as Blowing Agent 1A.

The blowing agent used in accordance with the present invention thus preferably comprises at least about 50% by weight of HFC-152a. For the purposes of convenience, a blowing agent in accordance with this paragraph is sometimes referred to herein as Blowing Agent 1B.

The blowing agent used in accordance with the present invention thus preferably comprises at least about 60% by weight of HFC-152a. For the purposes of convenience, a blowing agent in accordance with this paragraph is sometimes referred to herein as Blowing Agent 1C.

The blowing agent used in accordance with the present invention thus preferably comprises at least about 70% by weight of HFC-152a. For the purposes of convenience, a blowing agent in accordance with this paragraph is sometimes referred to herein as Blowing Agent 1D.

The blowing agent used in accordance with the present invention thus preferably comprises at least about 80% by weight of HFC-152a. For the purposes of convenience, a blowing agent in accordance with this paragraph is sometimes referred to herein as Blowing Agent 1E.

The blowing agent used in accordance with the present invention thus preferably comprises at least about 90% by weight of HFC-152a. For the purposes of convenience, a blowing agent in accordance with this paragraph is sometimes referred to herein as Blowing Agent 1F.

The blowing agent used in accordance with the present invention thus preferably comprises at least about 95% by weight of HFC-152a. For the purposes of convenience, a blowing agent in accordance with this paragraph is sometimes referred to herein as Blowing Agent 1G.

The blowing agent used in accordance with the present invention thus preferably consisting essentially of HFC-152a. For the purposes of convenience, a blowing agent in accordance with this paragraph is sometimes referred to herein as Blowing Agent 1H.

The blowing agent used in accordance with the present invention preferably consists of HFC-152a. For the purposes of convenience, a blowing agent in accordance with this paragraph is sometimes referred to herein as Blowing Agent 1I.

A preferred blowing agent of the present invention preferably comprises HFC-152a and one or more of 1234ze, 1234yf, 1336mzz, 1233zd and 1224ydf (referred to hereinafter for convenience as Blowing Agent 2); or comprises HFC-152a and one or more of trans 1234ze, 1336mzz, trans 1233zd and cis 1224 yd (referred to hereinafter for convenience as Blowing Agent 3); or comprises HFC-152a and one or more of trans 1234ze, trans 1336mzz, trans 1233zd and cis 1224 yd (referred to hereinafter for convenience as Blowing Agent 4); or comprises HFC-152a and one or more of trans 1234ze and trans 1336mzz (referred to hereinafter for convenience as Blowing Agent 5); or comprises HFC-152a and trans 1234ze (referred to hereinafter for convenience as Blowing Agent 6); or comprises HFC-152a and trans 1336mzz (referred to hereinafter for convenience as Blowing Agent 7); or comprises HFC-152a and cis 1336mzz (referred to hereinafter for convenience as Blowing Agent 8); or comprises HFC-152a and 1234yf (referred to hereinafter for convenience as Blowing Agent 9); or comprises HFC-152a and 1224 yd (referred to hereinafter for convenience as Blowing Agent 10); or comprises HFC-152a and trans 1233zd (referred to hereinafter for convenience as Blowing Agent 11). It is thus contemplated that the blowing agent of the present invention, including each of Blowing Agents 1-11, can include, in addition to each of the above-identified blowing agent(s), additional co-blowing agents including in one or more of the optional potential co-blowing agents as described below. In preferred embodiments, the present foamable compositions, foams, and foaming methods include a blowing agent as described according to the selection in the paragraphs, wherein the indicated blowing agent (including the compound or group of compound(s) specifically identified in each of Blowing Agent 1-11) is present in an amount, based upon the total weight of all blowing agent present, of at least about 50% by weight, or preferably at least about 60% by weight, preferably at least about 70% by weight, or preferably at least about 80% by weight, or preferably at least about 90% by weight, or preferably at least about 95% by weight, or preferably at least about 99% by weight.

The blowing agent used in accordance with of the present invention also preferably consists essentially of HFC-152a and one or more of 1234zc, 1234yf, 1336mzz, 1233zd and 1224ydf (referred to hereinafter for convenience as Blowing Agent 12); or consists essentially of HFC-152a and one or more of trans 1234ze, 1336mzz, trans 1233zd and cis 1224 yd (referred to hereinafter for convenience as Blowing Agent 13); or consists essentially of HFC-152a and one or more of trans 1234ze, trans 1336mzz, trans 1233zd and cis 1224 yd (referred to hereinafter for convenience as Blowing Agent 14); or consists essentially of HFC-152a and one or more of trans 1234ze and trans 1336mzz (referred to hereinafter for convenience as Blowing Agent 15); or consists essentially of HFC-152a and trans 1234ze (referred to hereinafter for convenience as Blowing Agent 16); or consists essentially of HFC-152a and trans 1336mzz (referred to hereinafter for convenience as Blowing Agent 17); or consists essentially of HFC-152a and cis 1336mzz (referred to hereinafter for convenience as Blowing Agent 18); or consists essentially of HFC-152a and 1234yf (referred to hereinafter for convenience as Blowing Agent 19); or consists essentially of HFC-152a and 1224 yd (referred to hereinafter for convenience as Blowing Agent 20); or consists essentially of HFC-152a and trans 1233zd (referred to hereinafter for convenience as Blowing Agent 21). It is contemplated and understood that blowing agent of the present paragraph can include one or more co-blowing agents which are not included in the indicated selection, provided that such co-blowing agent in the amount used does not interfere with or negate the ability to achieve relatively low-density foams as described herein, and preferably further does not interfere with or negate the ability to achieve mechanical strengths properties as described herein. It is contemplated, therefore, that given the teachings contained herein a person of skill in the art will be able to select, by way of example, one or more of the following potential co-blowing agents for use with a particular application without unduc experimentation: one or more saturated hydrocarbons or hydrofluorocarbons (HFCs), particularly C4-C6 hydrocarbons or C1-C4 HFCs, that are known in the art. Examples of such HFC co-blowing agents include, but are not limited to, one or a combination of difluoromethanc (HFC-32), fluorocthanc (HFC-161), difluorocthane (HFC-152), trifluorocthanc (HFC-143), tetrafluoroethane (HFC-134), pentafluorocthanc (HFC-125), pentafluoropropanc (HFC-245), hexafluoropropane (HFC-236), heptafluoropropane (HFC-227ca), pentafluorobutane (HFC-365), hexafluorobutane (HFC-356) and all isomers of all such HFC's. With respect to hydrocarbons, the present blowing agent compositions also may include in certain preferred embodiments, for example, iso, normal and/or cyclopentane for thermoset foams and butane or isobutane for thermoplastic foams. Other materials, such as water, CO2, CFCs (such as trichlorofluoromethane (CFC-11) and dichlorodifluoromethane (CFC-12)), hydrochlorocarbons (HCCs such as dichloroethylene (preferably trans-dichloroethylene), ethyl chloride and chloropropane), HCFCs, C1-C5 alcohols (such as, for example, ethanol and/or propanol and/or butanol), C1-C4 aldehydes, C1-C4 ketones, C1-C4 ethers (including ethers (such as dimethyl ether and diethyl ether), diethers (such as dimethoxy methane and dicthoxy methanc)), and methyl formate, organic acids (such as but not limited to formic acid), including combinations of any of these may be included, although such components are not necessarily preferred in many embodiments due to negative environmental impact.

The blowing agent used in accordance with of the present invention also preferably consists of HFC-152a and one or more of 1234ze, 1234yf, 1336mzz, 1233zd and 1224ydf (referred to hereinafter for convenience as Blowing Agent 22); or consists of HFC-152a and one or more of trans 1234ze, 1336mzz, trans 1233zd and cis 1224 yd (referred to hereinafter for convenience as Blowing Agent 23); or consists of HFC-152a and one or more of trans 1234ze, trans 1336mzz, trans 1233zd and cis 1224 yd (referred to hereinafter for convenience as Blowing Agent 24); or consists of HFC-152a and one or more of trans 1234ze and trans 1336mzz (referred to hereinafter for convenience as Blowing Agent 25); or consists of HFC-152a and trans 1234ze (referred to hereinafter for convenience as Blowing Agent 26); or consists of HFC-152a and trans 1336mzz (referred to hereinafter for convenience as Blowing Agent 27); or consists of HFC-152a and cis 1336mzz (referred to hereinafter for convenience as Blowing Agent 28); or consists of HFC-152a and 1234yf (referred to hereinafter for convenience as Blowing Agent 29); or consists of 1224 yd (referred to hereinafter for convenience as Blowing Agent 30); or consists of HFC-152a and trans 1233zd (referred to hereinafter for convenience as Blowing Agent 31).

### Foams and Foaming Process

The foams of the present invention, including each of Foams 1-4, or foam made from PEF polymer of the present invention, including Thermoplastic Polymer TPPIA-TPP22E, or any of the foams described in Examples 1-22, may generally be formed from a foamable composition of the present invention. In general, the foamable compositions of the present invention may be formed by combining a PEF polymer of the present invention, including each of Thermoplastic Polymer TPPIA-TPP22E, with a blowing agent of the present invention, including each of Blowing Agents 1-31.

Foamable compositions that are included within the present invention, and which provide particular advantage in connection with forming the foams of the present invention, are described in the following Foamable Composition Table (Table 3A and Table 3B), in which all numerical values in the table are understood to be preceded by the word “about” and in which the following terms used in the table have the following meanings:
CBAG1 means co-blowing agent selected from the group consisting of 1234ze (E), 1336mzz (Z), 1336mzzm (E), 1224 yd (Z), 1233zd (E), 1234yf and combinations of two or more of these.
CBAG2 means co-blowing agent selected from the group consisting of water, CO2, C1-C6 hydrocarbons (HCs) HCFCs, C1-C5 HFCs, C2-C4 hydrohaloolefins, C1-C5 alcohols, C1-C4 aldehydes, C1-C4 ketones, C1-C4 ethers, C1-C4 esters, organic acids and combinations of two or more of these.
CCBAG3 means co-blowing agent selected from the group consisting of water, CO2, isobutane, n-butane, isopentane, cyclopentane, cyclohexane, trans-dichloroethylene, ethanol, propanol, butanol, acetone, dimethyl ether, diethyl ether, dimethoxy methane, diethoxy methane, methyl formate, difluoromethane (HFC-32), fluoroethane (HFC-161), difluoroethane (HFC-152), trifluoroethane (HFC-143), 1,1,1,2-tetrafluoroethane (HFC-134a), pentafluoroethane (HFC-125), pentafluoropropane (HFC-245), hexafluoropropane (HFC-236), heptafluoropropane (HFC-227ea), pentafluorobutane (HFC-365), hexafluorobutane (HFC-356), and combinations of any two or more of these.

NR means not required.

TABLE 3A
FOAMABLE COMPOSITION TABLE

| | Foamable Composition Components | | | | |
|---|---|---|---|---|---|
| | | Blowing Agent(s) and Amounts, | | | |
| | | wt % of All Blowing Agents | | | |
| Foamable | | Blowing | | Co Blowing | |
| Composition | Polymer, | Agent 1 | Wt % | Agent(s) | Wt % |
| Number | TPP No. | (BA1) | BA1 | (CB) | CB |
| FC1A1 | TPP1A | HFC-152a | 100 | NR | 0 |
| FC1B1 | TPP1B | HFC-152a | 100 | NR | 0 |
| FC1C1 | TPP1C | HFC-152a | 100 | NR | 0 |
| FC1D1 | TPP1D | HFC-152a | 100 | NR | 0 |
| FC1E1 | TPP1E | HFC-152a | 100 | NR | 0 |
| FC1A2 | TPP2A | HFC-152a | 100 | NR | 0 |
| FC1B2 | TPP2B | HFC-152a | 100 | NR | 0 |
| FC1C2 | TPP2C | HFC-152a | 100 | NR | 0 |
| FC1D2 | TPP2D | HFC-152a | 100 | NR | 0 |
| FC1E2 | TPP2E | HFC-152a | 100 | NR | 0 |
| FC1A3 | TPP3A | HFC-152a | 100 | NR | 0 |
| FC1B3 | TPP3B | HFC-152a | 100 | NR | 0 |
| FC1C3 | TPP3C | HFC-152a | 100 | NR | 0 |
| FC1D3 | TPP3D | HFC-152a | 100 | NR | 0 |
| FC1E3 | TPP3E | HFC-152a | 100 | NR | 0 |
| FC1A4 | TPP4A | HFC-152a | 100 | NR | 0 |
| FC1B4 | TPP4B | HFC-152a | 100 | NR | 0 |
| FC1C4 | TPP4C | HFC-152a | 100 | NR | 0 |
| FC1D4 | TPP4D | HFC-152a | 100 | NR | 0 |
| FC1E4 | TPP4E | HFC-152a | 100 | NR | 0 |
| FC1A5 | TPP5A | HFC-152a | 100 | NR | 0 |
| FC1B5 | TPP5B | HFC-152a | 100 | NR | 0 |
| FC1C5 | TPP5C | HFC-152a | 100 | NR | 0 |
| FC1D5 | TPP5D | HFC-152a | 100 | NR | 0 |
| FC1E5 | TPP5E | HFC-152a | 100 | NR | 0 |
| FC1A6 | TPP6A | HFC-152a | 100 | NR | 0 |
| FC1B6 | TPP6B | HFC-152a | 100 | NR | 0 |
| FC1C6 | TPP6C | HFC-152a | 100 | NR | 0 |
| FC1D6 | TPP6D | HFC-152a | 100 | NR | 0 |
| FC1E6 | TPP6E | HFC-152a | 100 | NR | 0 |
| FC2A1 | TPP1A | HFC-152a | 5-95 | CBAG1 | 5-95 |
| FC2B1 | TPP1B | HFC-152a | 5-95 | CBAG1 | 5-95 |
| FC2C1 | TPP1C | HFC-152a | 5-95 | CBAG1 | 5-95 |
| FC2D1 | TPP1D | HFC-152a | 5-95 | CBAG1 | 5-95 |
| FC2E1 | TPP1E | HFC-152a | 5-95 | CBAG1 | 5-95 |
| FC2A2 | TPP2A | HFC-152a | 5-95 | CBAG1 | 5-95 |
| FC2B2 | TPP2B | HFC-152a | 5-95 | CBAG1 | 5-95 |
| FC2C2 | TPP2C | HFC-152a | 5-95 | CBAG1 | 5-95 |
| FC2D2 | TPP2D | HFC-152a | 5-95 | CBAG1 | 5-95 |
| FC2E2 | TPP2E | HFC-152a | 5-95 | CBAG1 | 5-95 |
| FC2A3 | TPP3A | HFC-152a | 5-95 | CBAG1 | 5-95 |
| FC2B3 | TPP3B | HFC-152a | 5-95 | CBAG1 | 5-95 |
| FC2C3 | TPP3C | HFC-152a | 5-95 | CBAG1 | 5-95 |
| FC2D3 | TPP3D | HFC-152a | 5-95 | CBAG1 | 5-95 |
| FC2E3 | TPP3E | HFC-152a | 5-95 | CBAG1 | 5-95 |
| FC2A4 | TPP4A | HFC-152a | 5-95 | CBAG1 | 5-95 |
| FC2B4 | TPP4B | HFC-152a | 5-95 | CBAG1 | 5-95 |
| FC2C4 | TPP4C | HFC-152a | 5-95 | CBAG1 | 5-95 |
| FC2D4 | TPP4D | HFC-152a | 5-95 | CBAG1 | 5-95 |
| FC2E4 | TPP4E | HFC-152a | 5-95 | CBAG1 | 5-95 |
| FC2A5 | TPP5A | HFC-152a | 5-95 | CBAG1 | 5-95 |
| FC2B5 | TPP5B | HFC-152a | 5-95 | CBAG1 | 5-95 |
| FC2C5 | TPP5C | HFC-152a | 5-95 | CBAG1 | 5-95 |
| FC2D5 | TPP5D | HFC-152a | 5-95 | CBAG1 | 5-95 |
| FC2E5 | TPP5E | HFC-152a | 5-95 | CBAG1 | 5-95 |
| FC2A6 | TPP6A | HFC-152a | 5-95 | CBAG1 | 5-95 |
| FC2B6 | TPP6B | HFC-152a | 5-95 | CBAG1 | 5-95 |
| FC2C6 | TPP6C | HFC-152a | 5-95 | CBAG1 | 5-95 |
| FC2D6 | TPP6D | HFC-152a | 5-95 | CBAG1 | 5-95 |
| FC2E6 | TPP6E | HFC-152a | 5-95 | CBAG1 | 5-95 |
| FC3A1 | TPP1A | HFC-152a | 5-95 | CBAG2 | 5-95 |
| FC3B1 | TPP1B | HFC-152a | 5-95 | CBAG2 | 5-95 |
| FC3C1 | TPP1C | HFC-152a | 5-95 | CBAG2 | 5-95 |
| FC3D1 | TPP1D | HFC-152a | 5-95 | CBAG2 | 5-95 |
| FC3E1 | TPP1E | HFC-152a | 5-95 | CBAG2 | 5-95 |
| FC3A2 | TPP2A | HFC-152a | 5-95 | CBAG2 | 5-95 |
| FC3B2 | TPP2B | HFC-152a | 5-95 | CBAG2 | 5-95 |
| FC3C2 | TPP2C | HFC-152a | 5-95 | CBAG2 | 5-95 |
| FC3D2 | TPP2D | HFC-152a | 5-95 | CBAG2 | 5-95 |
| FC3E2 | TPP2E | HFC-152a | 5-95 | CBAG2 | 5-95 |
| FC3A3 | TPP3A | HFC-152a | 5-95 | CBAG2 | 5-95 |
| FC3B3 | TPP3B | HFC-152a | 5-95 | CBAG2 | 5-95 |
| FC3C3 | TPP3C | HFC-152a | 5-95 | CBAG2 | 5-95 |
| FC3D3 | TPP3D | HFC-152a | 5-95 | CBAG2 | 5-95 |
| FC3E3 | TPP3E | HFC-152a | 5-95 | CBAG2 | 5-95 |
| FC3A4 | TPP4A | HFC-152a | 5-95 | CBAG2 | 5-95 |
| FC3B4 | TPP4B | HFC-152a | 5-95 | CBAG2 | 5-95 |
| FC3C4 | TPP4C | HFC-152a | 5-95 | CBAG2 | 5-95 |
| FC3D4 | TPP4D | HFC-152a | 5-95 | CBAG2 | 5-95 |
| FC3E4 | TPP4E | HFC-152a | 5-95 | CBAG2 | 5-95 |
| FC3A5 | TPP5A | HFC-152a | 5-95 | CBAG2 | 5-95 |
| FC3B5 | TPP5B | HFC-152a | 5-95 | CBAG2 | 5-95 |
| FC3C5 | TPP5C | HFC-152a | 5-95 | CBAG2 | 5-95 |
| FC3D5 | TPP5D | HFC-152a | 5-95 | CBAG2 | 5-95 |
| FC3E5 | TPP5E | HFC-152a | 5-95 | CBAG2 | 5-95 |
| FC3A6 | TPP6A | HFC-152a | 5-95 | CBAG2 | 5-95 |
| FC3B6 | TPP6B | HFC-152a | 5-95 | CBAG2 | 5-95 |
| FC3C6 | TPP6C | HFC-152a | 5-95 | CBAG2 | 5-95 |
| FC3D6 | TPP6D | HFC-152a | 5-95 | CBAG2 | 5-95 |
| FC3E6 | TPP6E | HFC-152a | 5-95 | CBAG2 | 5-95 |
| FC4A1 | TPP1A | HFC-152a | 5-95 | CBAG3 | 5-95 |
| FC4B1 | TPP1B | HFC-152a | 5-95 | CBAG3 | 5-95 |
| FC4C1 | TPP1C | HFC-152a | 5-95 | CBAG3 | 5-95 |
| FC4D1 | TPP1D | HFC-152a | 5-95 | CBAG3 | 5-95 |
| FC4E1 | TPP1E | HFC-152a | 5-95 | CBAG3 | 5-95 |
| FC4A2 | TPP2A | HFC-152a | 5-95 | CBAG3 | 5-95 |
| FC4B2 | TPP2B | HFC-152a | 5-95 | CBAG3 | 5-95 |
| FC4C2 | TPP2C | HFC-152a | 5-95 | CBAG3 | 5-95 |
| FC4D2 | TPP2D | HFC-152a | 5-95 | CBAG3 | 5-95 |
| FC4E2 | TPP2E | HFC-152a | 5-95 | CBAG3 | 5-95 |
| FC4A3 | TPP3A | HFC-152a | 5-95 | CBAG3 | 5-95 |
| FC4B3 | TPP3B | HFC-152a | 5-95 | CBAG3 | 5-95 |
| FC4C3 | TPP3C | HFC-152a | 5-95 | CBAG3 | 5-95 |
| FC4D3 | TPP3D | HFC-152a | 5-95 | CBAG3 | 5-95 |
| FC4E3 | TPP3E | HFC-152a | 5-95 | CBAG3 | 5-95 |
| FC4A4 | TPP4A | HFC-152a | 5-95 | CBAG3 | 5-95 |
| FC4B4 | TPP4B | HFC-152a | 5-95 | CBAG3 | 5-95 |
| FC4C4 | TPP4C | HFC-152a | 5-95 | CBAG3 | 5-95 |
| FC4D4 | TPP4D | HFC-152a | 5-95 | CBAG3 | 5-95 |
| FC4E4 | TPP4E | HFC-152a | 5-95 | CBAG3 | 5-95 |
| FC4A5 | TPP5A | HFC-152a | 5-95 | CBAG3 | 5-95 |
| FC4B5 | TPP5B | HFC-152a | 5-95 | CBAG3 | 5-95 |
| FC4C5 | TPP5C | HFC-152a | 5-95 | CBAG3 | 5-95 |
| FC4D5 | TPP5D | HFC-152a | 5-95 | CBAG3 | 5-95 |
| FC4E5 | TPP5E | HFC-152a | 5-95 | CBAG3 | 5-95 |
| FC4A6 | TPP6A | HFC-152a | 5-95 | CBAG3 | 5-95 |
| FC4B6 | TPP6B | HFC-152a | 5-95 | CBAG3 | 5-95 |
| FC4C6 | TPP6C | HFC-152a | 5-95 | CBAG3 | 5-95 |
| FC4D6 | TPP6D | HFC-152a | 5-95 | CBAG3 | 5-95 |
| FC4E6 | TPP6E | HFC-152a | 5-95 | CBAG3 | 5-95 |
| FC5A1 | TPP1A | HFC-152a | 5-95 | cyclopentane | 5-95 |
| FC5B1 | TPP1B | HFC-152a | 5-95 | cyclopentane | 5-95 |
| FC5C1 | TPP1C | HFC-152a | 5-95 | cyclopentane | 5-95 |
| FC5D1 | TPP1D | HFC-152a | 5-95 | cyclopentane | 5-95 |
| FC5E1 | TPP1E | HFC-152a | 5-95 | cyclopentane | 5-95 |
| FC5A2 | TPP2A | HFC-152a | 5-95 | cyclopentane | 5-95 |
| FC5B2 | TPP2B | HFC-152a | 5-95 | cyclopentane | 5-95 |
| FC5C2 | TPP2C | HFC-152a | 5-95 | cyclopentane | 5-95 |
| FC5D2 | TPP2D | HFC-152a | 5-95 | cyclopentane | 5-95 |
| FC5E2 | TPP2E | HFC-152a | 5-95 | cyclopentane | 5-95 |
| FC5A3 | TPP3A | HFC-152a | 5-95 | cyclopentane | 5-95 |
| FC5B3 | TPP3B | HFC-152a | 5-95 | cyclopentane | 5-95 |
| FC5C3 | TPP3C | HFC-152a | 5-95 | cyclopentane | 5-95 |
| FC5D3 | TPP3D | HFC-152a | 5-95 | cyclopentane | 5-95 |
| FC5E3 | TPP3E | HFC-152a | 5-95 | cyclopentane | 5-95 |
| FC5A4 | TPP4A | HFC-152a | 5-95 | cyclopentane | 5-95 |
| FC5B4 | TPP4B | HFC-152a | 5-95 | cyclopentane | 5-95 |
| FC5C4 | TPP4C | HFC-152a | 5-95 | cyclopentane | 5-95 |
| FC5D4 | TPP4D | HFC-152a | 5-95 | cyclopentane | 5-95 |
| FC5E4 | TPP4E | HFC-152a | 5-95 | cyclopentane | 5-95 |
| FC5A5 | TPP5A | HFC-152a | 5-95 | cyclopentane | 5-95 |
| FC5B5 | TPP5B | HFC-152a | 5-95 | cyclopentane | 5-95 |
| FC5C5 | TPP5C | HFC-152a | 5-95 | cyclopentane | 5-95 |
| FC5D5 | TPP5D | HFC-152a | 5-95 | cyclopentane | 5-95 |
| FC5E5 | TPP5E | HFC-152a | 5-95 | cyclopentane | 5-95 |
| FC5A6 | TPP6A | HFC-152a | 5-95 | cyclopentane | 5-95 |
| FC5B6 | TPP6B | HFC-152a | 5-95 | cyclopentane | 5-95 |
| FC5C6 | TPP6C | HFC-152a | 5-95 | cyclopentane | 5-95 |
| FC5D6 | TPP6D | HFC-152a | 5-95 | cyclopentane | 5-95 |
| FC5E6 | TPP6E | HFC-152a | 5-95 | cyclopentane | 5-95 |
| FC6A1 | TPP1A | HFC-152a | 5-95 | HFC-134a | 5-95 |
| FC6B1 | TPP1B | HFC-152a | 5-95 | HFC-134a | 5-95 |
| FC6C1 | TPP1C | HFC-152a | 5-95 | HFC-134a | 5-95 |
| FC6D1 | TPP1D | HFC-152a | 5-95 | HFC-134a | 5-95 |
| FC6E1 | TPP1E | HFC-152a | 5-95 | HFC-134a | 5-95 |
| FC6A2 | TPP2A | HFC-152a | 5-95 | HFC-134a | 5-95 |
| FC6B2 | TPP2B | HFC-152a | 5-95 | HFC-134a | 5-95 |
| FC6C2 | TPP2C | HFC-152a | 5-95 | HFC-134a | 5-95 |
| FC6D2 | TPP2D | HFC-152a | 5-95 | HFC-134a | 5-95 |
| FC6E2 | TPP2E | HFC-152a | 5-95 | HFC-134a | 5-95 |
| FC6A3 | TPP3A | HFC-152a | 5-95 | HFC-134a | 5-95 |
| FC6B3 | TPP3B | HFC-152a | 5-95 | HFC-134a | 5-95 |
| FC6C3 | TPP3C | HFC-152a | 5-95 | HFC-134a | 5-95 |
| FC6D3 | TPP3D | HFC-152a | 5-95 | HFC-134a | 5-95 |
| FC6E3 | TPP3E | HFC-152a | 5-95 | HFC-134a | 5-95 |
| FC6A4 | TPP4A | HFC-152a | 5-95 | HFC-134a | 5-95 |
| FC6B4 | TPP4B | HFC-152a | 5-95 | HFC-134a | 5-95 |
| FC6C4 | TPP4C | HFC-152a | 5-95 | HFC-134a | 5-95 |
| FC6D4 | TPP4D | HFC-152a | 5-95 | HFC-134a | 5-95 |
| FC6E4 | TPP4E | HFC-152a | 5-95 | HFC-134a | 5-95 |
| FC6A5 | TPP5A | HFC-152a | 5-95 | HFC-134a | 5-95 |
| FC6B5 | TPP5B | HFC-152a | 5-95 | HFC-134a | 5-95 |
| FC6C5 | TPP5C | HFC-152a | 5-95 | HFC-134a | 5-95 |
| FC6D5 | TPP5D | HFC-152a | 5-95 | HFC-134a | 5-95 |
| FC6E5 | TPP5E | HFC-152a | 5-95 | HFC-134a | 5-95 |
| FC6A6 | TPP6A | HFC-152a | 5-95 | HFC-134a | 5-95 |
| FC6B6 | TPP6B | HFC-152a | 5-95 | HFC-134a | 5-95 |
| FC6C6 | TPP6C | HFC-152a | 5-95 | HFC-134a | 5-95 |
| FC6D6 | TPP6D | HFC-152a | 5-95 | HFC-134a | 5-95 |
| FC6E6 | TPP6E | HFC-152a | 5-95 | HFC-134a | 5-95 |
| FC7A1 | TPP1A | HFC-152a | 5-95 | CO₂ | 5-95 |
| FC7B1 | TPP1B | HFC-152a | 5-95 | CO₂ | 5-95 |
| FC7C1 | TPP1C | HFC-152a | 5-95 | CO₂ | 5-95 |
| FC7D1 | TPP1D | HFC-152a | 5-95 | CO₂ | 5-95 |
| FC7E1 | TPP1E | HFC-152a | 5-95 | CO₂ | 5-95 |
| FC7A2 | TPP2A | HFC-152a | 5-95 | CO₂ | 5-95 |
| FC7B2 | TPP2B | HFC-152a | 5-95 | CO₂ | 5-95 |
| FC7C2 | TPP2C | HFC-152a | 5-95 | CO₂ | 5-95 |
| FC7D2 | TPP2D | HFC-152a | 5-95 | CO₂ | 5-95 |
| FC7E2 | TPP2E | HFC-152a | 5-95 | CO₂ | 5-95 |
| FC7A3 | TPP3A | HFC-152a | 5-95 | CO₂ | 5-95 |
| FC7B3 | TPP3B | HFC-152a | 5-95 | CO₂ | 5-95 |
| FC7C3 | TPP3C | HFC-152a | 5-95 | CO₂ | 5-95 |
| FC7D3 | TPP3D | HFC-152a | 5-95 | CO₂ | 5-95 |
| FC7E3 | TPP3E | HFC-152a | 5-95 | CO₂ | 5-95 |
| FC7A4 | TPP4A | HFC-152a | 5-95 | CO₂ | 5-95 |
| FC7B4 | TPP4B | HFC-152a | 5-95 | CO₂ | 5-95 |
| FC7C4 | TPP4C | HFC-152a | 5-95 | CO₂ | 5-95 |
| FC7D4 | TPP4D | HFC-152a | 5-95 | CO₂ | 5-95 |
| FC7E4 | TPP4E | HFC-152a | 5-95 | CO₂ | 5-95 |
| FC7A5 | TPP5A | HFC-152a | 5-95 | CO₂ | 5-95 |
| FC7B5 | TPP5B | HFC-152a | 5-95 | CO₂ | 5-95 |
| FC7C5 | TPP5C | HFC-152a | 5-95 | CO₂ | 5-95 |
| FC7D5 | TPP5D | HFC-152a | 5-95 | CO₂ | 5-95 |
| FC7E5 | TPP5E | HFC-152a | 5-95 | CO₂ | 5-95 |
| FC7A6 | TPP6A | HFC-152a | 5-95 | CO₂ | 5-95 |
| FC7B6 | TPP6B | HFC-152a | 5-95 | CO₂ | 5-95 |
| FC7C6 | TPP6C | HFC-152a | 5-95 | CO₂ | 5-95 |
| FC7D6 | TPP6D | HFC-152a | 5-95 | CO₂ | 5-95 |
| FC7E6 | TPP6E | HFC-152a | 5-95 | CO₂ | 5-95 |
| FC8A1 | TPP1A | HFC-152a | 5-95 | 1234ze(e) | 5-95 |
| FC8B1 | TPP1B | HFC-152a | 5-95 | 1234ze(e) | 5-95 |
| FC8C1 | TPP1C | HFC-152a | 5-95 | 1234ze(e) | 5-95 |
| FC8D1 | TPP1D | HFC-152a | 5-95 | 1234ze(e) | 5-95 |
| FC8E1 | TPP1E | HFC-152a | 5-95 | 1234ze(e) | 5-95 |
| FC8A2 | TPP2A | HFC-152a | 5-95 | 1234ze(e) | 5-95 |
| FC8B2 | TPP2B | HFC-152a | 5-95 | 1234ze(e) | 5-95 |
| FC8C2 | TPP2C | HFC-152a | 5-95 | 1234ze(e) | 5-95 |
| FC8D2 | TPP2D | HFC-152a | 5-95 | 1234ze(e) | 5-95 |
| FC8E2 | TPP2E | HFC-152a | 5-95 | 1234ze(e) | 5-95 |
| FC8A3 | TPP3A | HFC-152a | 5-95 | 1234ze(e) | 5-95 |
| FC8B3 | TPP3B | HFC-152a | 5-95 | 1234ze(e) | 5-95 |
| FC8C3 | TPP3C | HFC-152a | 5-95 | 1234ze(e) | 5-95 |
| FC8D3 | TPP3D | HFC-152a | 5-95 | 1234ze(e) | 5-95 |
| FC8E3 | TPP3E | HFC-152a | 5-95 | 1234ze(e) | 5-95 |
| FC8A4 | TPP4A | HFC-152a | 5-95 | 1234ze(e) | 5-95 |
| FC8B4 | TPP4B | HFC-152a | 5-95 | 1234ze(e) | 5-95 |
| FC8C4 | TPP4C | HFC-152a | 5-95 | 1234ze(e) | 5-95 |
| FC8D4 | TPP4D | HFC-152a | 5-95 | 1234ze(e) | 5-95 |
| FC8E4 | TPP4E | HFC-152a | 5-95 | 1234ze(e) | 5-95 |
| FC8A5 | TPP5A | HFC-152a | 5-95 | 1234ze(e) | 5-95 |
| FC8B5 | TPP5B | HFC-152a | 5-95 | 1234ze(e) | 5-95 |
| FC8C5 | TPP5C | HFC-152a | 5-95 | 1234ze(e) | 5-95 |
| FC8D5 | TPP5D | HFC-152a | 5-95 | 1234ze(e) | 5-95 |
| FC8E5 | TPP5E | HFC-152a | 5-95 | 1234ze(e) | 5-95 |
| FC8A6 | TPP6A | HFC-152a | 5-95 | 1234ze(e) | 5-95 |
| FC8B6 | TPP6B | HFC-152a | 5-95 | 1234ze(e) | 5-95 |
| FC8C6 | TPP6C | HFC-152a | 5-95 | 1234ze(e) | 5-95 |
| FC8D6 | TPP6D | HFC-152a | 5-95 | 1234ze(e) | 5-95 |
| FC8E6 | TPP6E | HFC-152a | 5-95 | 1234ze(e) | 5-95 |

TABLE 3BA
FOAMABLE COMPOSITION TABLE

| | Foamable Composition Components | | | | |
|---|---|---|---|---|---|
| | | Blowing Agent(s) and Amounts, | | | |
| | | wt % of All Blowing Agents | | | |
| Foamable | | Blowing | | Co Blowing | |
| Composition | Polymer, | Agent 1 | Wt % | Agent(s) | Wt % |
| Number | TPP No. | (BA1) | BA1 | (CB) | CB |
| FC9A1 | TPP17A | HFC-152a | 100 | NR | 0 |
| FC9B1 | TPP17B | HFC-152a | 100 | NR | 0 |
| FC9C1 | TPP17C | HFC-152a | 100 | NR | 0 |
| FC9D1 | TPP17D | HFC-152a | 100 | NR | 0 |
| FC9E1 | TPP17E | HFC-152a | 100 | NR | 0 |
| FC9A2 | TPP18A | HFC-152a | 100 | NR | 0 |
| FC9B2 | TPP18B | HFC-152a | 100 | NR | 0 |
| FC9C2 | TPP18C | HFC-152a | 100 | NR | 0 |
| FC9D2 | TPP18D | HFC-152a | 100 | NR | 0 |
| FC9E2 | TPP18E | HFC-152a | 100 | NR | 0 |
| FC9A3 | TPP18A | HFC-152a | 100 | NR | 0 |
| FC9B3 | TPP18B | HFC-152a | 100 | NR | 0 |
| FC9C3 | TPP18C | HFC-152a | 100 | NR | 0 |
| FC9D3 | TPP18 | HFC-152a | 100 | NR | 0 |
| FC9E3 | TPP18 | HFC-152a | 100 | NR | 0 |
| FC9A4 | TPP19A | HFC-152a | 100 | NR | 0 |
| FC9B4 | TPP19B | HFC-152a | 100 | NR | 0 |
| FC9C4 | TPP19C | HFC-152a | 100 | NR | 0 |
| FC9D4 | TPP19D | HFC-152a | 100 | NR | 0 |
| FC9E4 | TPP19E | HFC-152a | 100 | NR | 0 |
| FC9A5 | TPP20A | HFC-152a | 100 | NR | 0 |
| FC9B5 | TPP20B | HFC-152a | 100 | NR | 0 |
| FC9C5 | TPP20C | HFC-152a | 100 | NR | 0 |
| FC9D5 | TPP20D | HFC-152a | 100 | NR | 0 |
| FC9E5 | TPP20E | HFC-152a | 100 | NR | 0 |
| FC9A6 | TPP17A | HFC-152a | 100 | NR | 0 |
| FC9B6 | TPP17B | HFC-152a | 100 | NR | 0 |
| FC9C6 | TPP17C | HFC-152a | 100 | NR | 0 |
| FC9D6 | TPP17D | HFC-152a | 100 | NR | 0 |
| FC9E6 | TPP17E | HFC-152a | 100 | NR | 0 |
| FC10A1 | TPP17A | HFC-152a | 5-95 | CBAG1 | 5-95 |
| FC10B1 | TPP17B | HFC-152a | 5-95 | CBAG1 | 5-95 |
| FC10C1 | TPP17C | HFC-152a | 5-95 | CBAG1 | 5-95 |
| FC10D1 | TPP17D | HFC-152a | 5-95 | CBAG1 | 5-95 |
| FC10E1 | TPP17E | HFC-152a | 5-95 | CBAG1 | 5-95 |
| FC10A2 | TPP18A | HFC-152a | 5-95 | CBAG1 | 5-95 |
| FC10B2 | TPP18B | HFC-152a | 5-95 | CBAG1 | 5-95 |
| FC10C2 | TPP18C | HFC-152a | 5-95 | CBAG1 | 5-95 |
| FC10D2 | TPP18D | HFC-152a | 5-95 | CBAG1 | 5-95 |
| FC10E2 | TPP18E | HFC-152a | 5-95 | CBAG1 | 5-95 |
| FC10A3 | TPP18A | HFC-152a | 5-95 | CBAG1 | 5-95 |
| FC10B3 | TPP18B | HFC-152a | 5-95 | CBAG1 | 5-95 |
| FC10C3 | TPP18C | HFC-152a | 5-95 | CBAG1 | 5-95 |
| FC10D3 | TPP19D | HFC-152a | 5-95 | CBAG1 | 5-95 |
| FC10E3 | TPP19E | HFC-152a | 5-95 | CBAG1 | 5-95 |
| FC10A4 | TPP20A | HFC-152a | 5-95 | CBAG1 | 5-95 |
| FC10B4 | TPP20B | HFC-152a | 5-95 | CBAG1 | 5-95 |
| FC10C4 | TPP20C | HFC-152a | 5-95 | CBAG1 | 5-95 |
| FC10D4 | TPP20D | HFC-152a | 5-95 | CBAG1 | 5-95 |
| FC10E4 | TPP20E | HFC-152a | 5-95 | CBAG1 | 5-95 |
| FC10A5 | TPP20A | HFC-152a | 5-95 | CBAG1 | 5-95 |
| FC10B5 | TPP20B | HFC-152a | 5-95 | CBAG1 | 5-95 |
| FC10C5 | TPP20C | HFC-152a | 5-95 | CBAG1 | 5-95 |
| FC10D5 | TPP20D | HFC-152a | 5-95 | CBAG1 | 5-95 |
| FC10E5 | TPP20E | HFC-152a | 5-95 | CBAG1 | 5-95 |
| FC10A6 | TPP21A | HFC-152a | 5-95 | CBAG1 | 5-95 |
| FC10B6 | TPP21B | HFC-152a | 5-95 | CBAG1 | 5-95 |
| FC10C6 | TPP21C | HFC-152a | 5-95 | CBAG1 | 5-95 |
| FC10D6 | TPP21D | HFC-152a | 5-95 | CBAG1 | 5-95 |
| FC10E6 | TPP21E | HFC-152a | 5-95 | CBAG1 | 5-95 |
| FC11A1 | TPP17A | HFC-152a | 5-95 | CBAG2 | 5-95 |
| FC11B1 | TPP17B | HFC-152a | 5-95 | CBAG2 | 5-95 |
| FC11C1 | TPP17C | HFC-152a | 5-95 | CBAG2 | 5-95 |
| FC11D1 | TPP17D | HFC-152a | 5-95 | CBAG2 | 5-95 |
| FC11E1 | TPP17E | HFC-152a | 5-95 | CBAG2 | 5-95 |
| FC11A2 | TPP18A | HFC-152a | 5-95 | CBAG2 | 5-95 |
| FC11B2 | TPP18B | HFC-152a | 5-95 | CBAG2 | 5-95 |
| FC11C2 | TPP18C | HFC-152a | 5-95 | CBAG2 | 5-95 |
| FC11D2 | TPP18D | HFC-152a | 5-95 | CBAG2 | 5-95 |
| FC11E2 | TPP18E | HFC-152a | 5-95 | CBAG2 | 5-95 |
| FC11A3 | TPP19A | HFC-152a | 5-95 | CBAG2 | 5-95 |
| FC11B3 | TPP19B | HFC-152a | 5-95 | CBAG2 | 5-95 |
| FC11C3 | TPP19C | HFC-152a | 5-95 | CBAG2 | 5-95 |
| FC11D3 | TPP19D | HFC-152a | 5-95 | CBAG2 | 5-95 |
| FC11E3 | TPP19E | HFC-152a | 5-95 | CBAG2 | 5-95 |
| FC11A4 | TPP20A | HFC-152a | 5-95 | CBAG2 | 5-95 |
| FC11B4 | TPP20B | HFC-152a | 5-95 | CBAG2 | 5-95 |
| FC11C4 | TPP20C | HFC-152a | 5-95 | CBAG2 | 5-95 |
| FC11D4 | TPP20D | HFC-152a | 5-95 | CBAG2 | 5-95 |
| FC11E4 | TPP20E | HFC-152a | 5-95 | CBAG2 | 5-95 |
| FC11A5 | TPP21A | HFC-152a | 5-95 | CBAG2 | 5-95 |
| FC11B5 | TPP21B | HFC-152a | 5-95 | CBAG2 | 5-95 |
| FC11C5 | TPP21C | HFC-152a | 5-95 | CBAG2 | 5-95 |
| FC11D5 | TPP21D | HFC-152a | 5-95 | CBAG2 | 5-95 |
| FC11E5 | TPP21E | HFC-152a | 5-95 | CBAG2 | 5-95 |
| FC11A6 | TPP22A | HFC-152a | 5-95 | CBAG2 | 5-95 |
| FC11B6 | TPP22B | HFC-152a | 5-95 | CBAG2 | 5-95 |
| FC11C6 | TPP22C | HFC-152a | 5-95 | CBAG2 | 5-95 |
| FC11D6 | TPP22D | HFC-152a | 5-95 | CBAG2 | 5-95 |
| FC11E6 | TPP22E | HFC-152a | 5-95 | CBAG2 | 5-95 |

### Foam Forming Methods

It is contemplated that any one or more of a variety of known techniques for forming a thermoplastic foam can be used in view of the disclosures contained herein to form a foam of the present invention, including each of Foams 1-4, and Fomable Compositions 1-11, all such techniques and all foams formed thereby or within the broad scope of the present invention. For clarity, it will be noted that definition of the foams in the Table below all begin with only the letter F, in contrast to the foams defined by the paragraphs in the summary above, which begin with the capitalized phrase Foamable Composition.

In general, the forming step involves first introducing into a PEF polymer of the present invention, including each of TPP1-TPP22, a blowing agent of the present invention, including each of Blowing Agents 1-31, to form a foamable PEF composition comprising PEF and blowing agent. One example of a preferred method for forming a foamable PEF composition of the present invention is to plasticize the PEF, preferably comprising heating the PEF to its melt temperature, preferably above its melt temperature, and thereafter exposing the PEF melt to the blowing agent under conditions effective to incorporate (preferably by solubilizing) the desired amount of blowing agent into the polymer melt.

In preferred embodiments, the foaming methods of the present invention comprise providing a foamable composition of the present invention, including each of FC1-FC11 and foaming the provided foamable composition. In preferred embodiments, the foaming methods of the present invention comprising providing a foamable composition of the present invention, including each of FC1-FC11, and extruding the provided foamable composition to form a foam of the present invention, including each of Foams 1-4 and each of foams F1-F8.

Foaming processes of the present invention can include batch, semi-batch, continuous processes, and combinations of two or more of these. Batch processes generally involve preparation of at least one portion of the foamable polymer composition, including each of FC1-FC11, in a storable state and then using that portion of foamable polymer composition at some future point in time to prepare a foam. Semi-batch process involves preparing at least a portion of a foamable polymer composition, including each of FC1-FC11, and intermittently expanding that foamable polymer composition into a foam including each of Foams 1-4 and each of foams F1-F11, all in a single process. For example, U.S. Pat. No. 4,323,528, herein incorporated by reference, discloses a process for making thermoplastic foams via an accumulating extrusion process. The present invention thus includes processes that comprises: 1) mixing PEF thermoplastic polymer, including each of TPP1-TPP22, and a blowing agent of the present invention, including each of Blowing Agents 1-31, under conditions to form a foamable PEF composition; 2) extruding the foamable PEF composition, including each of FC1-FC11, into a holding zone maintained at a temperature and pressure which does not allow the foamable composition to foam, where the holding zone preferably comprises a die defining an orifice opening into a zone of lower pressure at which the foamable polymer composition, including each of FC1-FC11, foams and an openable gate closing the die orifice; 3) periodically opening the gate while substantially concurrently applying mechanical pressure by means of a movable ram on the foamable polymer composition, including each of FC1-FC11, to eject it from the holding zone through the dic orifice into the zone of lower pressure, and 4) allowing the ejected foamable polymer composition to expand, under the influence of the blowing agent, to form the foam, including each of Foams 1-4 and each of foams F1-F8.

The present invention also can use continuous processes for forming the foam. By way of example such a continuous process involves forming a foamable PEF composition, including each of FC1-FC11, and then expanding that foamable PEF composition without substantial interruption. For example, a foamable PEF composition, including each of FC1-FC11, may be prepared in an extruder by heating the selected PEF polymer resin, including each of TPP1-TPP22, to form a PEF melt, incorporating into the PEF melt a blowing agent of the present invention, including each of Blowing Agents 1-31, preferably by solubilizing the blowing agent into the PEF melt, at an initial pressure to form a foamable PEF composition comprising a substantially homogeneous combination of PEF and blowing agent, including each of FC1-FC11, and then extruding that foamable PEF composition through a die into a zone at a selected foaming pressure and allowing the foamable PEF composition to expand into a foam, including each of Foams 1-4 and each of foams F1-F8 described below, under the influence of the blowing agent. Optionally, the foamable PEF composition which comprises the PEF polymer, including each of FC1-FC11, and the incorporated blowing agent, including each of Blowing Agents 1-31, may be cooled prior to extruding the composition through the die to enhance certain desired properties of the resulting foam, including each of Foams 1-6 and each of foams F1-F8.

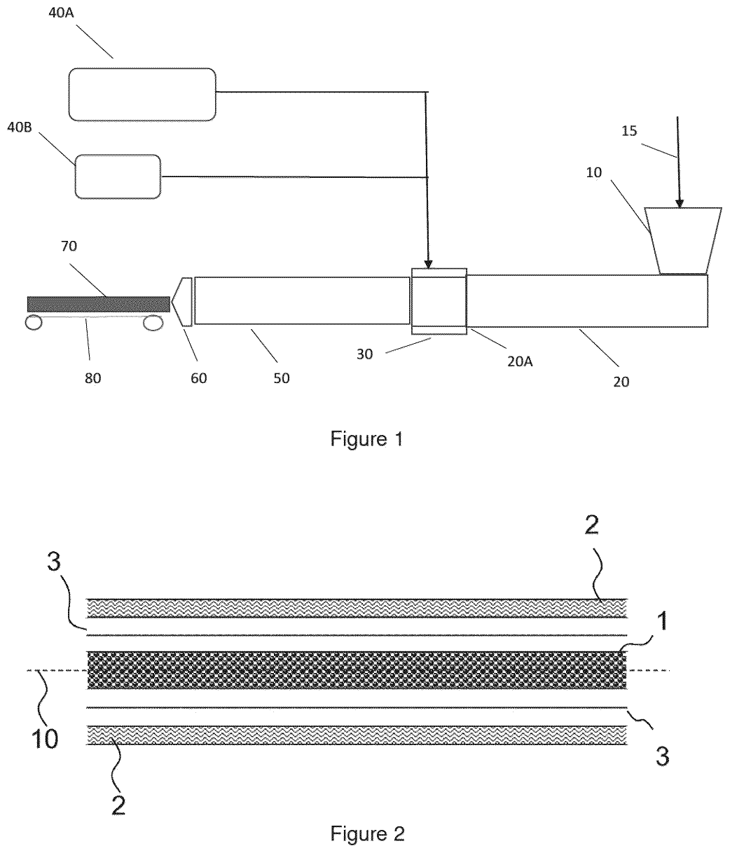

The methods can be carried out, by way of example, using extrusion equipment of the general type disclosed in FIG. 1. In particular, the extrusion apparatus can include a raw material feed hopper 10 for holding the PEF polymer 15 of the present invention, including each of TPP1-TPP22, and one or more optional components (which may be added with the PEF in the hopper or optionally elsewhere in the process depending on the particular needs of the user). The feed materials 15, excluding the blowing agent, can be charged to the hopper and delivered to the screw extruder 10. The extruder 20 can include thermocouples (not shown) located at three points along the length thereof and a pressure sensor (not shown) at the discharge end 20A of the extruder. A mixer section 30 can be located at the discharge end 20A of the extruder for receiving blowing agent components of the present invention, including each of Blowing Agents 1-31, via one or more metering pumps 40A and 40B and mixing those blowing agents into the PEF melt in the mixer section. Sensors (not shown) can be included for monitoring the temperature and pressure of the mixer section 30. The mixer section 30 can then discharge the foamable composition melt of the present invention, including each of FC1-FC11, into a pair of melt coolers 50 oriented in series, with temperature sensors (not shown) located in each cooler to monitor the melt temperature. The melt is then extruded through a die 60, which also had temperature and pressure sensors (not shown) for monitoring the pressure and temperature at the die. The die pressure and temperature can be varied, according to the needs of each particular extrusion application to produce a foam 70 of the present invention, including each of including each of Foams 1-4 and each of foams F1-F8 described below. The foam can then be carried away from the extrusion equipment by a conveyor belt 80.

The foamable polymer compositions of the present invention, including each of FC1-FC11, may optionally contain additional additives such as nucleating agents, cell-controlling agents, glass and carbon fibers, dyes, pigments, fillers, antioxidants, extrusion aids, stabilizing agents, antistatic agents, fire retardants, IR attenuating agents and thermally insulating additives. Nucleating agents include, among others, materials such as talc, calcium carbonate, sodium benzoate, and chemical blowing agents such azodicarbonamide or sodium bicarbonate and citric acid. IR attenuating agents and thermally insulating additives can include carbon black, graphite, silicon dioxide, metal flake or powder, among others. Flame retardants can include, among others, brominated materials such as hexabromocyclodecane and polybrominated biphenyl ether. Each of the above-noted additional optional additives can be introduced into the foam at various times and that various locations in the process according to known techniques, and all such additives and methods of addition or within the broad scope of the present invention.

### Foams

In preferred embodiments, the foams of the present invention are formed in a commercial extrusion apparatus and have the properties as indicated in the following Table 4, with the values being measured as described in the Examples hereof:

TABLE 4

| | | Low | High |
|---|---|---|---|
| | Broad | Density | Density |
| Foam property | Range | Range | Range |
| Foam density, | 0.04-.25 | .06-0.115 | 0.115-0.25 |
| g/cc (ISO 845) | | | |
| Compressive | 0.5-15 | 0.5-5 | 1-14 |
| Strength | | | |
| (perpendicular | | | |
| to the plane) | | | |
| (ISO 844), Mpa | | | |
| Tensile strength | 1.0-6 | 1 .-3 | 2-6 |
| perpendicular to | | | |
| the plane (ASTM | | | |
| C297), Mpa | | | |
| Tensile Strength + | 1.5-21 | 1.5-8 | 3-20 |
| Compressive | | | |
| Strength, Mpa | | | |
| Average Cell | 20-300 | 20-100 | 30-300 |
| Size, (SEM) | | | |

Foams that are included within the present invention and which provide particular advantage are described in the following Table 5, and in which all numerical values in the table are understood to be preceded by the word “about” and in which the designation NR means “not required.”

TABLE 5
FOAM TABLE

| | | Foam Properties | | | |
|---|---|---|---|---|---|
| | | | | Com- | Tensile |
| | Foam- | | | pressive | Strength, |
| | able | | | Strength, | ((ASTM |
| | Compo- | % | | (ISO 844), | C297), |
| Foam | sition, | Closed | Density, | megapascal | megapascal |
| Number | No. | Cell | g/cc | (MPa) | (MPa) |
| F1A1A | FC1A1 | >25 | NR | NR | NR |
| F1B1A | FC1B1 | >25 | NR | NR | NR |
| F1C1A | FC1C1 | >25 | NR | NR | NR |
| F1D1A | FC1D1 | >25 | NR | NR | NR |
| F1E1A | FC1E1 | >25 | NR | NR | NR |
| F1A2A | FC1A2 | >25 | NR | NR | NR |
| F1B2A | FC1B2 | >25 | NR | NR | NR |
| F1C2A | FC1C2 | >25 | NR | NR | NR |
| F1D2A | FC1D2 | >25 | NR | NR | NR |
| F1E2A | FC1E2 | >25 | NR | NR | NR |
| F1A3A | FC1A3 | >25 | NR | NR | NR |
| F1B3A | FC1B3 | >25 | NR | NR | NR |
| F1C3A | FC1C3 | >25 | NR | NR | NR |
| F1D3A | FC1D3 | >25 | NR | NR | NR |
| F1E3A | FC1E3 | >25 | NR | NR | NR |
| F1A4A | FC1A4 | >25 | NR | NR | NR |
| F1B4A | FC1B4 | >25 | NR | NR | NR |
| F1C4A | FC1C4 | >25 | NR | NR | NR |
| F1D4A | FC1D4 | >25 | NR | NR | NR |
| F1E4A | FC1E4 | >25 | NR | NR | NR |
| F1A5A | FC1A5 | >25 | NR | NR | NR |
| F1B5A | FC1B5 | >25 | NR | NR | NR |
| F1C5A | FC1C5 | >25 | NR | NR | NR |
| F1D5A | FC1D5 | >25 | NR | NR | NR |
| F1E5A | FC1E5 | >25 | NR | NR | NR |
| F1A6A | FC1A6 | >25 | NR | NR | NR |
| F1B6A | FC1B6 | >25 | NR | NR | NR |
| F1C6A | FC1C6 | >25 | NR | NR | NR |
| F1D6A | FC1D6 | >25 | NR | NR | NR |
| F1E6A | FC1E6 | >25 | NR | NR | NR |
| F2A1A | FC2A1 | >25 | NR | NR | NR |
| F2B1A | FC2B1 | >25 | NR | NR | NR |
| F2C1A | FC2C1 | >25 | NR | NR | NR |
| F2D1A | FC2D1 | >25 | NR | NR | NR |
| F2E1A | FC2E1 | >25 | NR | NR | NR |
| F2A2A | FC2A2 | >25 | NR | NR | NR |
| F2B2A | FC2B2 | >25 | NR | NR | NR |
| F2C2A | FC2C2 | >25 | NR | NR | NR |
| F2D2A | FC2D2 | >25 | NR | NR | NR |
| F2E2A | FC2E2 | >25 | NR | NR | NR |
| F2A3A | FC2A3 | >25 | NR | NR | NR |
| F2B3A | FC2B3 | >25 | NR | NR | NR |
| F2C3A | FC2C3 | >25 | NR | NR | NR |
| F2D3A | FC2D3 | >25 | NR | NR | NR |
| F2E3A | FC2E3 | >25 | NR | NR | NR |
| F2A4A | FC2A4 | >25 | NR | NR | NR |
| F2B4A | FC2B4 | >25 | NR | NR | NR |
| F2C4A | FC2C4 | >25 | NR | NR | NR |
| F2D4A | FC2D4 | >25 | NR | NR | NR |
| F2E4A | FC2E4 | >25 | NR | NR | NR |
| F2A5A | FC2A5 | >25 | NR | NR | NR |
| F2B5A | FC2B5 | >25 | NR | NR | NR |
| F2C5A | FC2C5 | >25 | NR | NR | NR |
| F2D5A | FC2D5 | >25 | NR | NR | NR |
| F2E5A | FC2E5 | >25 | NR | NR | NR |
| F2A6A | FC2A6 | >25 | NR | NR | NR |
| F2B6A | FC2B6 | >25 | NR | NR | NR |
| F2C6A | FC2C6 | >25 | NR | NR | NR |
| F2D6A | FC2D6 | >25 | NR | NR | NR |
| F2E6A | FC2E6 | >25 | NR | NR | NR |
| F3A1A | FC3A1 | >25 | NR | NR | NR |
| F3B1A | FC3B1 | >25 | NR | NR | NR |
| F3C1A | FC3C1 | >25 | NR | NR | NR |
| F3D1A | FC3D1 | >25 | NR | NR | NR |
| F3E1A | FC3E1 | >25 | NR | NR | NR |
| F3A2A | FC3A2 | >25 | NR | NR | NR |
| F3B2A | FC3B2 | >25 | NR | NR | NR |
| F3C2A | FC3C2 | >25 | NR | NR | NR |
| F3D2A | FC3D2 | >25 | NR | NR | NR |
| F3E2A | FC3E2 | >25 | NR | NR | NR |
| F3A3A | FC3A3 | >25 | NR | NR | NR |
| F3B3A | FC3B3 | >25 | NR | NR | NR |
| F3C3A | FC3C3 | >25 | NR | NR | NR |
| F3D3A | FC3D3 | >25 | NR | NR | NR |
| F3E3A | FC3E3 | >25 | NR | NR | NR |
| F3A4A | FC3A4 | >25 | NR | NR | NR |
| F3B4A | FC3B4 | >25 | NR | NR | NR |
| F3C4A | FC3C4 | >25 | NR | NR | NR |
| F3D4A | FC3D4 | >25 | NR | NR | NR |
| F3E4A | FC3E4 | >25 | NR | NR | NR |
| F3A5A | FC3A5 | >25 | NR | NR | NR |
| F3B5A | FC3B5 | >25 | NR | NR | NR |
| F3C5A | FC3C5 | >25 | NR | NR | NR |
| F3D5A | FC3D5 | >25 | NR | NR | NR |
| F3E5A | FC3E5 | >25 | NR | NR | NR |
| F3A6A | FC3A6 | >25 | NR | NR | NR |
| F3B6A | FC3B6 | >25 | NR | NR | NR |
| F3C6A | FC3C6 | >25 | NR | NR | NR |
| F3D6A | FC3D6 | >25 | NR | NR | NR |
| F3E6A | FC3E6 | >25 | NR | NR | NR |
| F4A1A | FC4A1 | >25 | R | NR | NR |
| F4B1A | FC4B1 | >25 | NR | NR | NR |
| F4C1A | FC4C1 | >25 | NR | NR | NR |
| F4D1A | FC4D1 | >25 | NR | NR | NR |
| F4E1A | FC4E1 | >25 | NR | NR | NR |
| F4A2A | FC4A2 | >25 | NR | NR | NR |
| F4B2A | FC4B2 | >25 | NR | NR | NR |
| F4C2A | FC4C2 | >25 | NR | NR | NR |
| F4D2A | FC4D2 | >25 | NR | NR | NR |
| F4E2A | FC4E2 | >25 | NR | NR | NR |
| F4A3A | FC4A3 | >25 | NR | NR | NR |
| F4B3A | FC4B3 | >25 | NR | NR | NR |
| FC4C3A | FC4C3 | >25 | NR | NR | NR |
| F4D3A | FC4D3 | >25 | NR | NR | NR |
| F4E3A | FC4E3 | >25 | NR | NR | NR |
| F4A4A | FC4A4 | >25 | NR | NR | NR |
| F4B4A | FC4B4 | >25 | NR | NR | NR |
| F4C4A | FC4C4 | >25 | NR | NR | NR |
| F4D4A | FC4D4 | >25 | NR | NR | NR |
| F4E4A | FC4E4 | >25 | NR | NR | NR |
| F4A5A | FC4A5 | >25 | NR | NR | NR |
| F4B5A | FC4B5 | >25 | NR | NR | NR |
| F4C5A | FC4C5 | >25 | NR | NR | NR |
| F4D5A | FC4D5 | >25 | NR | NR | NR |
| F4E5A | FC4E5 | >25 | NR | NR | NR |
| F4A6A | FC4A6 | >25 | NR | NR | NR |
| F4B6A | FC4B6 | >25 | NR | NR | NR |
| F4C6A | FC4C6 | >25 | NR | NR | NR |
| F4D6A | FC4D6 | >25 | NR | NR | NR |
| F4E6A | FC4E6 | >25 | NR | NR | NR |
| F5A1A | FC5A1 | >25 | NR | NR | NR |
| F5B1A | FC5B1 | >25 | NR | NR | NR |
| F5C1A | FC5C1 | >25 | NR | NR | NR |
| F5D1A | FC5D1 | >25 | NR | NR | NR |
| F5E1A | FC5E1 | >25 | NR | NR | NR |
| F5A2A | FC5A2 | >25 | NR | NR | NR |
| F5B2A | FC5B2 | >25 | NR | NR | NR |
| F5C2A | FC5C2 | >25 | NR | NR | NR |
| F5D2A | FC5D2 | >25 | NR | NR | NR |
| F5E2A | FC5E2 | >25 | NR | NR | NR |
| F5A3A | FC5A3 | >25 | NR | NR | NR |
| F5B3A | FC5B3 | >25 | NR | NR | NR |
| F5C3A | FC5C3 | >25 | NR | NR | NR |
| F5D3A | FC5D3 | >25 | NR | NR | NR |
| F5E3A | FC5E3 | >25 | NR | NR | NR |
| F5A4A | FC5A4 | >25 | NR | NR | NR |
| F5B4A | FC5B4 | >25 | NR | NR | NR |
| F5C4A | FC5C4 | >25 | NR | NR | NR |
| F5D4A | FC5D4 | >25 | NR | NR | NR |
| F5E4A | FC5E4 | >25 | NR | NR | NR |
| F5A5A | FC5A5 | >25 | NR | NR | NR |
| F5B5A | FC5B5 | >25 | NR | NR | NR |
| F5C5A | FC5C5 | >25 | NR | NR | NR |
| F5D5A | FC5D5 | >25 | NR | NR | NR |
| F5E5A | FC5E5 | >25 | NR | NR | NR |
| F5A6A | FC5A6 | >25 | NR | NR | NR |
| F5B6A | FC5B6 | >25 | NR | NR | NR |
| F5C6A | FC5C6 | >25 | NR | NR | NR |
| F5D6A | FC5D6 | >25 | NR | NR | NR |
| F5E6A | FC5E6 | >25 | NR | NR | NR |
| F6A1A | FC6A1 | >25 | NR | NR | NR |
| F6B1A | FC6B1 | >25 | NR | NR | NR |
| F6C1A | FC6C1 | >25 | NR | NR | NR |
| F6D1A | FC6D1 | >25 | NR | NR | NR |
| F6E1A | FC6E1 | >25 | NR | NR | NR |
| F6A2A | FC6A2 | >25 | NR | NR | NR |
| F6B2A | FC6B2 | >25 | NR | NR | NR |
| F6C2A | FC6C2 | >25 | NR | NR | NR |
| F6D2A | FC6D2 | >25 | NR | NR | NR |
| F6E2A | FC6E2 | >25 | NR | NR | NR |
| F6A3A | FC6A3 | >25 | NR | NR | NR |
| F6B3A | FC6B3 | >25 | NR | NR | NR |
| F6C3A | FC6C3 | >25 | NR | NR | NR |
| F6D3A | FC6D3 | >25 | NR | NR | NR |
| F6E3A | FC6E3 | >25 | NR | NR | NR |
| F6B4A | FC6B4 | >25 | NR | NR | NR |
| F6C4A | FC6C4 | >25 | NR | NR | NR |
| F6D4A | FC6D4 | >25 | NR | NR | NR |
| F6E4A | FC6E4 | >25 | NR | NR | NR |
| F6A5A | FC6A5 | >25 | NR | NR | NR |
| F6B5A | FC6B5 | >25 | NR | NR | NR |
| F6C5A | FC6C5 | >25 | NR | NR | NR |
| F6D5A | FC6D5 | >25 | NR | NR | NR |
| F6E5A | FC6E5 | >25 | NR | NR | NR |
| F6A6A | FC6A6 | >25 | NR | NR | NR |
| F6B6A | FC6B6 | >25 | NR | NR | NR |
| F6C6A | FC6C6 | >25 | NR | NR | NR |
| F6D6A | FC6D6 | >25 | NR | NR | NR |
| F6E6A | FC6E6 | >25 | NR | NR | NR |
| F7A1A | FC7A1 | >25 | NR | NR | NR |
| F7B1A | FC7B1 | >25 | NR | NR | NR |
| F7C1A | FC7C1 | >25 | NR | NR | NR |
| F7D1A | FC7D1 | >25 | NR | NR | NR |
| F7E1A | FC7E1 | >25 | NR | NR | NR |
| F7A2A | FC7A2 | >25 | NR | NR | NR |
| F7B2 | FC7B2 | >25 | NR | NR | NR |
| F7C2A | FC7C2 | >25 | NR | NR | NR |
| F7D2A | FC7D2 | >25 | NR | NR | NR |
| F7E2A | FC7E2 | >25 | NR | NR | NR |
| F7A3A | FC7A3 | >25 | NR | NR | NR |
| F7B3A | FC7B3 | >25 | NR | NR | NR |
| F7C3A | FC7C3 | >25 | NR | NR | NR |
| F7D3A | FC7D3 | >25 | NR | NR | NR |
| F7E3A | FC7E3 | >25 | NR | NR | NR |
| F7A4A | FC7A4 | >25 | NR | NR | NR |
| F7B4A | FC7B4 | >25 | NR | NR | NR |
| F7C4A | FC7C4 | >25 | NR | NR | NR |
| F7D4A | FC7D4 | >25 | NR | NR | NR |
| F7E4A | FC7E4 | >25 | NR | NR | NR |
| F7A5A | FC7A5 | >25 | NR | NR | NR |
| F7B5A | FC7B5 | >25 | NR | NR | NR |
| F7C5A | FC7C5 | >25 | NR | NR | NR |
| F7D5A | FC7D5 | >25 | NR | NR | NR |
| F7E5A | FC7E5 | >25 | NR | NR | NR |
| F7A6A | FC7A6 | >25 | NR | NR | NR |
| F7B6A | FC7B6 | >25 | NR | NR | NR |
| F7C6A | FC7C6 | >25 | NR | NR | NR |
| F7D6A | FC7D6 | >25 | NR | NR | NR |
| F7E6A | FC7E6 | >25 | NR | NR | NR |
| F8A1A | FC8A1 | >25 | NR | NR | NR |
| F8B1A | FC8B1 | >25 | NR | NR | NR |
| F8C1A | FC8C1 | >25 | NR | NR | NR |
| F8D1A | FC8D1 | >25 | NR | NR | NR |
| F8E1A | FC8E1 | >25 | NR | NR | NR |
| F8A2A | FC8A2 | >25 | NR | NR | NR |
| F8B2A | FC8B2 | >25 | NR | NR | NR |
| F8C2A | FC8C2 | >25 | NR | NR | NR |
| F8D2A | FC8D2 | >25 | NR | NR | NR |
| F8E2A | FC8E2 | >25 | NR | NR | NR |
| F8A3A | FC8A3 | >25 | NR | NR | NR |
| F8B3A | FC8B3 | >25 | NR | NR | NR |
| F8C3A | FC8C3 | >25 | NR | NR | NR |
| F8D3A | FC8D3 | >25 | NR | NR | NR |
| F8E3A | FC8E3 | >25 | NR | NR | NR |
| F8A4A | FC8A4 | >25 | NR | NR | NR |
| F8B4A | FC8B4 | >25 | NR | NR | NR |
| F8C4A | FC8C4 | >25 | NR | NR | NR |
| F8D4A | FC8D4 | >25 | NR | NR | NR |
| F8E4A | FC8E4 | >25 | NR | NR | NR |
| F8A5A | FC8A5 | >25 | NR | NR | NR |
| F8B5A | FC8B5 | >25 | NR | NR | NR |
| F8C5A | FC8C5 | >25 | NR | NR | NR |
| F8D5A | FC8D5 | >25 | NR | NR | NR |
| F8E5A | FC8E5 | >25 | NR | NR | NR |
| F8A6A | FC8A6 | >25 | NR | NR | NR |
| F8B6A | FC8B6 | >25 | NR | NR | NR |
| F8C6A | FC8C6 | >25 | NR | NR | NR |
| F8D6A | FC8D6 | >25 | NR | NR | NR |
| F8E6A | FC8E6 | >25 | NR | NR | NR |
| F1A1B | FC1A1 | NR | <0.3 | NR | NR |
| F1B1B | FC1B1 | NR | <0.3 | NR | NR |
| F1C1B | FC1C1 | NR | <0.3 | NR | NR |
| F1D1B | FC1D1 | NR | <0.3 | NR | NR |
| F1E1B | FC1E1 | NR | <0.3 | NR | NR |
| F1A2B | FC1A2 | NR | <0.3 | NR | NR |
| F1B2B | FC1B2 | NR | <0.3 | NR | NR |
| F1C2B | FC1C2 | NR | <0.3 | NR | NR |
| F1D2B | FC1D2 | NR | <0.3 | NR | NR |
| F1E2B | FC1E2 | NR | <0.3 | NR | NR |
| F1A3B | FC1A3 | NR | <0.3 | NR | NR |
| F1B3B | FC1B3 | NR | <0.3 | NR | NR |
| F1C3B | FC1C3 | NR | <0.3 | NR | NR |
| F1D3B | FC1D3 | NR | <0.3 | NR | NR |
| F1E3B | FC1E3 | NR | <0.3 | NR | NR |
| F1A4B | FC1A4 | NR | <0.3 | NR | NR |
| F1B4B | FC1B4 | NR | <0.3 | NR | NR |
| F1C4B | FC1C4 | NR | <0.3 | NR | NR |
| F1D4B | FC1D4 | NR | <0.3 | NR | NR |
| F1E4B | FC1E4 | NR | <0.3 | NR | NR |
| F1A5B | FC1A5 | NR | <0.3 | NR | NR |
| F1B5B | FC1B5 | NR | <0.3 | NR | NR |
| F1C5B | FC1C5 | NR | <0.3 | NR | NR |
| F1D5B | FC1D5 | NR | <0.3 | NR | NR |
| F1E5B | FC1E5 | NR | <0.3 | NR | NR |
| F1A6B | FC1A6 | NR | <0.3 | NR | NR |
| F1B6B | FC1B6 | NR | <0.3 | NR | NR |
| F1C6B | FC1C6 | NR | <0.3 | NR | NR |
| F1D6B | FC1D6 | NR | <0.3 | NR | NR |
| F1E6B | FC1E6 | NR | <0.3 | NR | NR |
| F2A1B | FC2A1 | NR | <0.3 | NR | NR |
| F2B1B | FC2B1 | NR | <0.3 | NR | NR |
| F2C1B | FC2C1 | NR | <0.3 | NR | NR |
| F2D1B | FC2D1 | NR | <0.3 | NR | NR |
| F2E1B | FC2E1 | NR | <0.3 | NR | NR |
| F2A2B | FC2A2 | NR | <0.3 | NR | NR |
| F2B2B | FC2B2 | NR | <0.3 | NR | NR |
| F2C2B | FC2C2 | NR | <0.3 | NR | NR |
| F2D2B | FC2D2 | NR | <0.3 | NR | NR |
| F2E2B | FC2E2 | NR | <0.3 | NR | NR |
| F2A3B | FC2A3 | NR | <0.3 | NR | NR |
| F2B3B | FC2B3 | NR | <0.3 | NR | NR |
| F2C3B | FC2C3 | NR | <0.3 | NR | NR |
| F2D3B | FC2D3 | NR | <0.3 | NR | NR |
| F2E3B | FC2E3 | NR | <0.3 | NR | NR |
| F2A4B | FC2A4 | NR | <0.3 | NR | NR |
| F2B4B | FC2B4 | NR | <0.3 | NR | NR |
| F2C4B | FC2C4 | NR | <0.3 | NR | NR |
| F2D4B | FC2D4 | NR | <0.3 | NR | NR |
| F2E4B | FC2E4 | NR | <0.3 | NR | NR |
| F2A5B | FC2A5 | NR | <0.3 | NR | NR |
| F2B5B | FC2B5 | NR | <0.3 | NR | NR |
| F2C5B | FC2C5 | NR | <0.3 | NR | NR |
| F2D5B | FC2D5 | NR | <0.3 | NR | NR |
| F2E5B | FC2E5 | NR | <0.3 | NR | NR |
| F2A6B | FC2A6 | NR | <0.3 | NR | NR |
| F2B6B | FC2B6 | NR | <0.3 | NR | NR |
| F2C6B | FC2C6 | NR | <0.3 | NR | NR |
| F2D6B | FC2D6 | NR | <0.3 | NR | NR |
| F2E6B | FC2E6 | NR | <0.3 | NR | NR |
| F3A1B | FC3A1 | NR | <0.3 | NR | NR |
| F3B1B | FC3B1 | NR | <0.3 | NR | NR |
| F3C1B | FC3C1 | NR | <0.3 | NR | NR |
| F3D1B | FC3D1 | NR | <0.3 | NR | NR |
| F3E1B | FC3E1 | NR | <0.3 | NR | NR |
| F3A2B | FC3A2 | NR | <0.3 | NR | NR |
| F3B2B | FC3B2 | NR | <0.3 | NR | NR |
| F3C2B | FC3C2 | NR | <0.3 | NR | NR |
| F3D2B | FC3D2 | NR | <0.3 | NR | NR |
| F3E2B | FC3E2 | NR | <0.3 | NR | NR |
| F3A3B | FC3A3 | NR | <0.3 | NR | NR |
| F3B3B | FC3B3 | NR | <0.3 | NR | NR |
| F3C3B | FC3C3 | NR | <0.3 | NR | NR |
| F3D3B | FC3D3 | NR | <0.3 | NR | NR |
| F3E3B | FC3E3 | NR | <0.3 | NR | NR |
| F3A4B | FC3A4 | NR | <0.3 | NR | NR |
| F3B4B | FC3B4 | NR | <0.3 | NR | NR |
| F3C4B | FC3C4 | NR | <0.3 | NR | NR |
| F3D4B | FC3D4 | NR | <0.3 | NR | NR |
| F3E4B | FC3E4 | NR | <0.3 | NR | NR |
| F3A5B | FC3A5 | NR | <0.3 | NR | NR |
| F3B5B | FC3B5 | NR | <0.3 | NR | NR |
| F3C5B | FC3C5 | NR | <0.3 | NR | NR |
| F3D5B | FC3D5 | NR | <0.3 | NR | NR |
| F3E5B | FC3E5 | NR | <0.3 | NR | NR |
| F3A6B | FC3A6 | NR | <0.3 | NR | NR |
| F3B6B | FC3B6 | NR | <0.3 | NR | NR |
| F3C6B | FC3C6 | NR | <0.3 | NR | NR |
| F3D6B | FC3D6 | NR | <0.3 | NR | NR |
| F3E6B | FC3E6 | NR | <0.3 | NR | NR |
| F4A1B | FC4A1 | NR | <0.3 | NR | NR |
| F4B1B | FC4B1 | NR | <0.3 | NR | NR |
| F4C1B | FC4C1 | NR | <0.3 | NR | NR |
| F4D1B | FC4D1 | NR | <0.3 | NR | NR |
| F4E1B | FC4E1 | NR | <0.3 | NR | NR |
| F4A2B | FC4A2 | NR | <0.3 | NR | NR |
| F4B2B | FC4B2 | NR | <0.3 | NR | NR |
| F4C2B | FC4C2 | NR | <0.3 | NR | NR |
| F4D2B | FC4D2 | NR | <0.3 | NR | NR |
| F4E2B | FC4E2 | NR | <0.3 | NR | NR |
| F4A3B | FC4A3 | NR | <0.3 | NR | NR |
| F4B3B | FC4B3 | NR | <0.3 | NR | NR |
| F4C3B | FC4C3 | NR | <0.3 | NR | NR |
| F4D3B | FC4D3 | NR | <0.3 | NR | NR |
| F4E3B | FC4E3 | NR | <0.3 | NR | NR |
| F4A4B | FC4A4 | NR | <0.3 | NR | NR |
| F4B4B | FC4B4 | NR | <0.3 | NR | NR |
| F4C4B | FC4C4 | NR | <0.3 | NR | NR |
| F4D4B | FC4D4 | NR | <0.3 | NR | NR |
| F4E4B | FC4E4 | NR | <0.3 | NR | NR |
| F4A5B | FC4A5 | NR | <0.3 | NR | NR |
| F4B5B | FC4B5 | NR | <0.3 | NR | NR |
| F4C5B | FC4C5 | NR | <0.3 | NR | NR |
| F4D5B | FC4D5 | NR | <0.3 | NR | NR |
| F4E5B | FC4E5 | NR | <0.3 | NR | NR |
| F4A6B | FC4A6 | NR | <0.3 | NR | NR |
| F4B6B | FC4B6 | NR | <0.3 | NR | NR |
| F4C6B | FC4C6 | NR | <0.3 | NR | NR |
| F4D6B | FC4D6 | NR | <0.3 | NR | NR |
| F4E6B | FC4E6 | NR | <0.3 | NR | NR |
| F5A1B | FC5A1 | NR | <0.3 | NR | NR |
| F5B1B | FC5B1 | NR | <0.3 | NR | NR |
| F5C1B | FC5C1 | NR | <0.3 | NR | NR |
| F5D1B | FC5D1 | NR | <0.3 | NR | NR |
| F5E1B | FC5E1 | NR | <0.3 | NR | NR |
| F5A2B | FC5A2 | NR | <0.3 | NR | NR |
| F5B2B | FC5B2 | NR | <0.3 | NR | NR |
| F5C2B | FC5C2 | NR | <0.3 | NR | NR |
| F5D2B | FC5D2 | NR | <0.3 | NR | NR |
| F5E2B | FC5E2 | NR | <0.3 | NR | NR |
| F5A3B | FC5A3 | NR | <0.3 | NR | NR |
| F5B3B | FC5B3 | NR | <0.3 | NR | NR |
| F5C3B | FC5C3 | NR | <0.3 | NR | NR |
| F5D3B | FC5D3 | NR | <0.3 | NR | NR |
| F5E3B | FC5E3 | NR | <0.3 | NR | NR |
| F5A4B | FC5A4 | NR | <0.3 | NR | NR |
| F5B4B | FC5B4 | NR | <0.3 | NR | NR |
| F5C4B | FC5C4 | NR | <0.3 | NR | NR |
| F5D4B | FC5D4 | NR | <0.3 | NR | NR |
| F5E4B | FC5E4 | NR | <0.3 | NR | NR |
| F5A5B | FC5A5 | NR | <0.3 | NR | NR |
| F5B5B | FC5B5 | NR | <0.3 | NR | NR |
| F5C5B | FC5C5 | NR | <0.3 | NR | NR |
| F5D5B | FC5D5 | NR | <0.3 | NR | NR |
| F5E5B | FC5E5 | NR | <0.3 | NR | NR |
| F5A6B | FC5A6 | NR | <0.3 | NR | NR |
| F5B6B | FC5B6 | NR | <0.3 | NR | NR |
| F5C6B | FC5C6 | NR | <0.3 | NR | NR |
| F5D6B | FC5D6 | NR | <0.3 | NR | NR |
| F5E6B | FC5E6 | NR | <0.3 | NR | NR |
| F6A1B | FC6A1 | NR | <0.3 | NR | NR |
| F6B1B | FC6B1 | NR | <0.3 | NR | NR |
| F6C1B | FC6C1 | NR | <0.3 | NR | NR |
| F6D1B | FC6D1 | NR | <0.3 | NR | NR |
| F6E1B | FC6E1 | NR | <0.3 | NR | NR |
| F6A2B | FC6A2 | NR | <0.3 | NR | NR |
| F6B2B | FC6B2 | NR | <0.3 | NR | NR |
| F6C2B | FC6C2 | NR | <0.3 | NR | NR |
| F6D2B | FC6D2 | NR | <0.3 | NR | NR |
| F6E2B | FC6E2 | NR | <0.3 | NR | NR |
| F6A3B | FC6A3 | NR | <0.3 | NR | NR |
| F6B3B | FC6B3 | NR | <0.3 | NR | NR |
| F6C3B | FC6C3 | NR | <0.3 | NR | NR |
| F6D3B | FC6D3 | NR | <0.3 | NR | NR |
| F6E3B | FC6E3 | NR | <0.3 | NR | NR |
| F6B4B | FC6B4 | NR | <0.3 | NR | NR |
| F6C4B | FC6C4 | NR | <0.3 | NR | NR |
| F6D4B | FC6D4 | NR | <0.3 | NR | NR |
| F6E4B | FC6E4 | NR | <0.3 | NR | NR |
| F6A5B | FC6A5 | NR | <0.3 | NR | NR |
| F6B5B | FC6B5 | NR | <0.3 | NR | NR |
| F6C5B | FC6C5 | NR | <0.3 | NR | NR |
| F6D5B | FC6D5 | NR | <0.3 | NR | NR |
| F6E5B | FC6E5 | NR | <0.3 | NR | NR |
| F6A6B | FC6A6 | NR | <0.3 | NR | NR |
| F6B6B | FC6B6 | NR | <0.3 | NR | NR |
| F6C6B | FC6C6 | NR | <0.3 | NR | NR |
| F6D6B | FC6D6 | NR | <0.3 | NR | NR |
| F6E6B | FC6E6 | NR | <0.3 | NR | NR |
| F7A1B | FC7A1 | NR | <0.3 | NR | NR |
| F7B1B | FC7B1 | NR | <0.3 | NR | NR |
| F7C1B | FC7C1 | NR | <0.3 | NR | NR |
| F7D1B | FC7D1 | NR | <0.3 | NR | NR |
| F7E1B | FC7E1 | NR | <0.3 | NR | NR |
| F7A2B | FC7A2 | NR | <0.3 | NR | NR |
| F7B2B | FC7B2 | NR | <0.3 | NR | NR |
| F7C2B | FC7C2 | NR | <0.3 | NR | NR |
| F7D2B | FC7D2 | NR | <0.3 | NR | NR |
| F7E2B | FC7E2 | NR | <0.3 | NR | NR |
| F7A3B | FC7A3 | NR | <0.3 | NR | NR |
| F7B3B | FC7B3 | NR | <0.3 | NR | NR |
| F7C3B | FC7C3 | NR | <0.3 | NR | NR |
| F7D3B | FC7D3 | NR | <0.3 | NR | NR |
| F7E3B | FC7E3 | NR | <0.3 | NR | NR |
| F7A4B | FC7A4 | NR | <0.3 | NR | NR |
| F7B4B | FC7B4 | NR | <0.3 | NR | NR |
| F7C4B | FC7C4 | NR | <0.3 | NR | NR |
| F7D4B | FC7D4 | NR | <0.3 | NR | NR |
| F7E4B | FC7E4 | NR | <0.3 | NR | NR |
| F7A5B | FC7A5 | NR | <0.3 | NR | NR |
| F7B5B | FC7B5 | NR | <0.3 | NR | NR |
| F7C5B | FC7C5 | NR | <0.3 | NR | NR |
| F7D5B | FC7D5 | NR | <0.3 | NR | NR |
| F7E5B | FC7E5 | NR | <0.3 | NR | NR |
| F7A6B | FC7A6 | NR | <0.3 | NR | NR |
| F7B6B | FC7B6 | NR | <0.3 | NR | NR |
| F7C6B | FC7C6 | NR | <0.3 | NR | NR |
| F7D6B | FC7D6 | NR | <0.3 | NR | NR |
| F7E6B | FC7E6 | NR | <0.3 | NR | NR |
| F8A1B | FC8A1 | NR | <0.3 | NR | NR |
| F8B1B | FC8B1 | NR | <0.3 | NR | NR |
| F8C1B | FC8C1 | NR | <0.3 | NR | NR |
| F8D1B | FC8D1 | NR | <0.3 | NR | NR |
| F8E1B | FC8E1 | NR | <0.3 | NR | NR |
| F8A2B | FC8A2 | NR | <0.3 | NR | NR |
| F8B2B | FC8B2 | NR | <0.3 | NR | NR |
| F8C2B | FC8C2 | NR | <0.3 | NR | NR |
| F8D2B | FC8D2 | NR | <0.3 | NR | NR |
| F8E2B | FC8E2 | NR | <0.3 | NR | NR |
| F8A3B | FC8A3 | NR | <0.3 | NR | NR |
| F8B3B | FC8B3 | NR | <0.3 | NR | NR |
| F8C3B | FC8C3 | NR | <0.3 | NR | NR |
| F8D3B | FC8D3 | NR | <0.3 | NR | NR |
| F8E3B | FC8E3 | NR | <0.3 | NR | NR |
| F8A4B | FC8A4 | NR | <0.3 | NR | NR |
| F8B4B | FC8B4 | NR | <0.3 | NR | NR |
| F8C4B | FC8C4 | NR | <0.3 | NR | NR |
| F8D4B | FC8D4 | NR | <0.3 | NR | NR |
| F8E4B | FC8E4 | NR | <0.3 | NR | NR |
| F8A5B | FC8A5 | NR | <0.3 | NR | NR |
| F8B5B | FC8B5 | NR | <0.3 | NR | NR |
| F8C5B | FC8C5 | NR | <0.3 | NR | NR |
| F8D5B | FC8D5 | NR | <0.3 | NR | NR |
| F8E5B | FC8E5 | NR | <0.3 | NR | NR |
| F8A6B | FC8A6 | NR | <0.3 | NR | NR |
| F8B6B | FC8B6 | NR | <0.3 | NR | NR |
| F8C6B | FC8C6 | NR | <0.3 | NR | NR |
| F8D6B | FC8D6 | NR | <0.3 | NR | NR |
| F8E6B | FC8E6 | NR | <0.3 | NR | NR |
| F1A1C | FC1A1 | NR | 0.04-0.25 | NR | NR |
| F1B1C | FC1B1 | NR | 0.04-0.252 | NR | NR |
| F1C1C | FC1C1 | NR | 0.04-0.252 | NR | NR |
| F1D1C | FC1D1 | NR | 0.04-0.252 | NR | NR |
| F1E1C | FC1E1 | NR | 0.04-0.252 | NR | NR |
| F1A2C | FC1A2 | NR | 0.04-0.252 | NR | NR |
| F1B2C | FC1B2 | NR | 0.04-0.252 | NR | NR |
| F1C2C | FC1C2 | NR | 0.04-0.252 | NR | NR |
| F1D2C | FC1D2 | NR | 0.04-0.252 | NR | NR |
| F1E2C | FC1E2 | NR | 0.04-0.252 | NR | NR |
| F1A3C | FC1A3 | NR | 0.04-0.252 | NR | NR |
| F1B3C | FC1B3 | NR | 0.04-0.252 | NR | NR |
| F1C3C | FC1C3 | NR | 0.04-0.252 | NR | NR |
| F1D3C | FC1D3 | NR | 0.04-0.252 | NR | NR |
| F1E3C | FC1E3 | NR | 0.04-0.252 | NR | NR |
| F1A4C | FC1A4 | NR | 0.04-0.252 | NR | NR |
| F1B4C | FC1B4 | NR | 0.04-0.252 | NR | NR |
| F1C4C | FC1C4 | NR | 0.04-0.252 | NR | NR |
| F1D4C | FC1D4 | NR | 0.04-0.252 | NR | NR |
| F1E4C | FC1E4 | NR | 0.04-0.252 | NR | NR |
| F1A5C | FC1A5 | NR | 0.04-0.252 | NR | NR |
| F1B5C | FC1B5 | NR | 0.04-0.252 | NR | NR |
| F1C5C | FC1C5 | NR | 0.04-0.252 | NR | NR |
| F1D5C | FC1D5 | NR | 0.04-0.252 | NR | NR |
| F1E5C | FC1E5 | NR | 0.04-0.252 | NR | NR |
| F1A6C | FC1A6 | NR | 0.04-0.252 | NR | NR |
| F1B6C | FC1B6 | NR | 0.04-0.252 | NR | NR |
| F1C6C | FC1C6 | NR | 0.04-0.252 | NR | NR |
| F1D6C | FC1D6 | NR | 0.04-0.252 | NR | NR |
| F1E6C | FC1E6 | NR | 0.04-0.252 | NR | NR |
| F2A1C | FC2A1 | NR | 0.04-0.252 | NR | NR |
| F2B1C | FC2B1 | NR | 0.04-0.252 | NR | NR |
| F2C1C | FC2C1 | NR | 0.04-0.252 | NR | NR |
| F2D1C | FC2D1 | NR | 0.04-0.252 | NR | NR |
| F2E1C | FC2E1 | NR | 0.04-0.252 | NR | NR |
| F2A2C | FC2A2 | NR | 0.04-0.252 | NR | NR |
| F2B2C | FC2B2 | NR | 0.04-0.252 | NR | NR |
| F2C2C | FC2C2 | NR | 0.04-0.252 | NR | NR |
| F2D2C | FC2D2 | NR | 0.04-0.252 | NR | NR |
| F2E2C | FC2E2 | VR | 0.04-0.252 | NR | NR |
| F2A3C | FC2A3 | NR | 0.04-0.252 | NR | NR |
| F2B3C | FC2B3 | NR | 0.04-0.252 | NR | NR |
| F2C3C | FC2C3 | NR | 0.04-0.252 | NR | NR |
| F2D3C | FC2D3 | NR | 0.04-0.252 | NR | NR |
| F2E3C | FC2E3 | NR | 0.04-0.252 | NR | NR |
| F2A4C | FC2A4 | NR | 0.04-0.252 | NR | NR |
| F2B4C | FC2B4 | NR | 0.04-0.252 | NR | NR |
| F2C4C | FC2C4 | NR | 0.04-0.252 | NR | NR |
| F2D4C | FC2D4 | NR | 0.04-0.252 | NR | NR |
| F2E4C | FC2E4 | NR | 0.04-0.252 | NR | NR |
| F2A5C | FC2A5 | NR | 0.04-0.252 | NR | NR |
| F2B5C | FC2B5 | NR | 0.04-0.252 | NR | NR |
| F2C5C | FC2C5 | NR | 0.04-0.252 | NR | NR |
| F2D5C | FC2D5 | NR | 0.04-0.252 | NR | NR |
| F2E5C | FC2E5 | VR | 0.04-0.252 | NR | NR |
| F2A6C | FC2A6 | NR | 0.04-0.252 | NR | NR |
| F2B6C | FC2B6 | NR | 0.04-0.252 | NR | NR |
| F2C6C | FC2C6 | NR | 0.04-0.252 | NR | NR |
| F2D6C | FC2D6 | NR | 0.04-0.252 | NR | NR |
| F2E6C | FC2E6 | NR | 0.04-0.252 | NR | NR |
| F3A1C | FC3A1 | NR | 0.04-0.252 | NR | NR |
| F3B1C | FC3B1 | NR | 0.04-0.252 | NR | NR |
| F3C1C | FC3C1 | NR | 0.04-0.252 | NR | NR |
| F3D1C | FC3D1 | NR | 0.04-0.252 | NR | NR |
| F3E1C | FC3E1 | NR | 0.04-0.252 | NR | NR |
| F3A2C | FC3A2 | NR | 0.04-0.252 | NR | NR |
| F3B2C | FC3B2 | NR | 0.04-0.252 | NR | NR |
| F3C2C | FC3C2 | NR | 0.04-0.252 | NR | NR |
| F3D2C | FC3D2 | NR | 0.04-0.252 | NR | NR |
| F3E2C | FC3E2 | NR | 0.04-0.252 | NR | NR |
| F3A3C | FC3A3 | NR | 0.04-0.252 | NR | NR |
| F3B3C | FC3B3 | NR | 0.04-0.252 | NR | NR |
| F3C3C | FC3C3 | NR | 0.04-0.252 | NR | NR |
| F3D3C | FC3D3 | NR | 0.04-0.252 | NR | NR |
| F3E3C | FC3E3 | NR | 0.04-0.252 | NR | NR |
| F3A4C | FC3A4 | NR | 0.04-0.252 | NR | NR |
| F3B4C | FC3B4 | NR | 0.04-0.252 | NR | NR |
| F3C4C | FC3C4 | NR | 0.04-0.252 | NR | NR |
| F3D4C | FC3D4 | NR | 0.04-0.252 | NR | NR |
| F3E4C | FC3E4 | NR | 0.04-0.252 | NR | NR |
| F3A5C | FC3A5 | NR | 0.04-0.252 | NR | NR |
| F3B5C | FC3B5 | NR | 0.04-0.252 | NR | NR |
| F3C5C | FC3C5 | NR | 0.04-0.252 | NR | NR |
| F3D5C | FC3D5 | NR | 0.04-0.252 | NR | NR |
| F3E5C | FC3E5 | NR | 0.04-0.252 | NR | NR |
| F3A6C | FC3A6 | NR | 0.04-0.252 | NR | NR |
| F3B6C | FC3B6 | NR | 0.04-0.252 | NR | NR |
| F3C6C | FC3C6 | NR | 0.04-0.252 | NR | NR |
| F3D6C | FC3D6 | NR | 0.04-0.252 | NR | NR |
| F3E6C | FC3E6 | NR | 0.04-0.252 | NR | NR |
| F4A1C | FC4A1 | NR | 0.04-0.252 | NR | NR |
| F4B1C | FC4B1 | NR | 0.04-0.252 | NR | NR |
| F4C1C | FC4C1 | NR | 0.04-0.252 | NR | NR |
| F4D1C | FC4D1 | NR | 0.04-0.252 | NR | NR |
| F4E1C | FC4E1 | NR | 0.04-0.252 | NR | NR |
| F4A2C | FC4A2 | NR | 0.04-0.252 | NR | NR |
| F4B2C | FC4B2 | NR | 0.04-0.252 | NR | NR |
| F4C2C | FC4C2 | NR | 0.04-0.252 | NR | NR |
| F4D2C | FC4D2 | NR | 0.04-0.252 | NR | NR |
| F4E2C | FC4E2 | NR | 0.04-0.252 | NR | NR |
| F4A3C | FC4A3 | NR | 0.04-0.252 | NR | NR |
| F4B3C | FC4B3 | NR | 0.04-0.252 | NR | NR |
| F4C3C | FC4C3 | NR | 0.04-0.252 | NR | NR |
| F4D3C | FC4D3 | NR | 0.04-0.252 | NR | NR |
| F4E3C | FC4E3 | NR | 0.04-0.252 | NR | NR |
| F4A4C | FC4A4 | NR | 0.04-0.252 | NR | NR |
| F4B4C | FC4B4 | NR | 0.04-0.252 | NR | NR |
| F4C4C | FC4C4 | NR | 0.04-0.252 | NR | NR |
| F4D4C | FC4D4 | NR | 0.04-0.252 | NR | NR |
| F4E4C | FC4E4 | NR | 0.04-0.252 | NR | NR |
| F4A5C | FC4A5 | NR | 0.04-0.252 | NR | NR |
| F4B5C | FC4B5 | NR | 0.04-0.252 | NR | NR |
| F4C5C | FC4C5 | NR | 0.04-0.252 | NR | NR |
| F4D5C | FC4D5 | NR | 0.04-0.252 | NR | NR |
| F4E5C | FC4E5 | NR | 0.04-0.252 | NR | NR |
| F4A6C | FC4A6 | NR | 0.04-0.252 | NR | NR |
| F4B6C | FC4B6 | NR | 0.04-0.252 | NR | NR |
| F4C6C | FC4C6 | NR | 0.04-0.252 | NR | NR |
| F4D6C | FC4D6 | NR | 0.04-0.252 | NR | NR |
| F4E6C | FC4E6 | NR | 0.04-0.252 | NR | NR |
| F5A1C | FC5A1 | NR | 0.04-0.252 | NR | NR |
| F5B1C | FC5B1 | NR | 0.04-0.252 | NR | NR |
| F5C1C | FC5C1 | NR | 0.04-0.252 | NR | NR |
| F5D1C | FC5D1 | NR | 0.04-0.252 | NR | NR |
| F5E1C | FC5E1 | NR | 0.04-0.252 | NR | NR |
| F5A2C | FC5A2 | NR | 0.04-0.252 | NR | NR |
| F5B2C | FC5B2 | NR | 0.04-0.252 | NR | NR |
| F5C2C | FC5C2 | NR | 0.04-0.252 | NR | NR |
| F5D2C | FC5D2 | NR | 0.04-0.252 | NR | NR |
| F5E2C | FC5E2 | NR | 0.04-0.252 | NR | NR |
| F5A3C | FC5A3 | NR | 0.04-0.252 | NR | NR |
| F5B3C | FC5B3 | NR | 0.04-0.252 | NR | NR |
| F5C3C | FC5C3 | NR | 0.04-0.252 | NR | NR |
| F5D3C | FC5D3 | NR | 0.04-0.252 | NR | NR |
| F5E3C | FC5E3 | NR | 0.04-0.252 | NR | NR |
| F5A4C | FC5A4 | NR | 0.04-0.252 | NR | NR |
| F5B4C | FC5B4 | NR | 0.04-0.252 | NR | NR |
| F5C4C | FC5C4 | NR | 0.04-0.252 | NR | NR |
| F5D4C | FC5D4 | NR | 0.04-0.252 | NR | NR |
| F5E4C | FC5E4 | NR | 0.04-0.252 | NR | NR |
| F5A5C | FC5A5 | NR | 0.04-0.252 | NR | NR |
| F5B5C | FC5B5 | NR | 0.04-0.252 | NR | NR |
| F5C5C | FC5C5 | NR | 0.04-0.252 | NR | NR |
| F5D5C | FC5D5 | NR | 0.04-0.252 | NR | NR |
| F5E5C | FC5E5 | NR | 0.04-0.252 | NR | NR |
| F5A6C | FC5A6 | NR | 0.04-0.252 | NR | NR |
| F5B6C | FC5B6 | NR | 0.04-0.252 | NR | NR |
| F5C6C | FC5C6 | NR | 0.04-0.252 | NR | NR |
| F5D6C | FC5D6 | NR | 0.04-0.252 | NR | NR |
| F5E6C | FC5E6 | NR | 0.04-0.252 | NR | NR |
| F6A1C | FC6A1 | NR | 0.04-0.252 | NR | NR |
| F6B1C | FC6B1 | NR | 0.04-0.252 | NR | NR |
| F6C1C | FC6C1 | NR | 0.04-0.252 | NR | NR |
| F6D1C | FC6D1 | NR | 0.04-0.252 | NR | NR |
| F6E1C | FC6E1 | NR | 0.04-0.252 | NR | NR |
| F6A2C | FC6A2 | NR | 0.04-0.252 | NR | NR |
| F6B2C | FC6B2 | NR | 0.04-0.252 | NR | NR |
| F6C2C | FC6C2 | NR | 0.04-0.252 | NR | NR |
| F6D2C | FC6D2 | NR | 0.04-0.252 | NR | NR |
| F6E2C | FC6E2 | NR | 0.04-0.252 | NR | NR |
| F6A3C | FC6A3 | NR | 0.04-0.252 | NR | NR |
| F6B3C | FC6B3 | NR | 0.04-0.252 | NR | NR |
| F6C3C | FC6C3 | NR | 0.04-0.252 | NR | NR |
| F6D3C | FC6D3 | NR | 0.04-0.252 | NR | NR |
| F6E3C | FC6E3 | NR | 0.04-0.252 | NR | NR |
| F6B4C | FC6B4 | NR | 0.04-0.252 | NR | NR |
| F6C4C | FC6C4 | NR | 0.04-0.252 | NR | NR |
| F6D4C | FC6D4 | NR | 0.04-0.252 | NR | NR |
| F6E4C | FC6E4 | NR | 0.04-0.252 | NR | NR |
| F6A5C | FC6A5 | NR | 0.04-0.252 | NR | NR |
| F6B5C | FC6B5 | NR | 0.04-0.252 | NR | NR |
| F6C5C | FC6C5 | NR | 0.04-0.252 | NR | NR |
| F6D5C | FC6D5 | NR | 0.04-0.252 | NR | NR |
| F6E5C | FC6E5 | NR | 0.04-0.252 | NR | NR |
| F6A6C | FC6A6 | NR | 0.04-0.252 | NR | NR |
| F6B6C | FC6B6 | NR | 0.04-0.252 | NR | NR |
| F6C6C | FC6C6 | NR | 0.04-0.252 | NR | NR |
| F6D6C | FC6D6 | NR | 0.04-0.252 | NR | NR |
| F6E6C | FC6E6 | NR | 0.04-0.252 | NR | NR |
| F7A1C | FC7A1 | NR | 0.04-0.252 | NR | NR |
| F7B1C | FC7B1 | NR | 0.04-0.252 | NR | NR |
| F7C1C | FC7C1 | NR | 0.04-0.252 | NR | NR |
| F7D1C | FC7D1 | NR | 0.04-0.252 | NR | NR |
| F7E1C | FC7E1 | NR | 0.04-0.252 | NR | NR |
| F7A2C | FC7A2 | NR | 0.04-0.252 | NR | NR |
| F7B2C | FC7B2 | NR | 0.04-0.252 | NR | NR |
| F7C2C | FC7C2 | NR | 0.04-0.252 | NR | NR |
| F7D2C | FC7D2 | NR | 0.04-0.252 | NR | NR |
| F7E2C | FC7E2 | NR | 0.04-0.252 | NR | NR |
| F7A3C | FC7A3 | NR | 0.04-0.252 | NR | NR |
| F7B3C | FC7B3 | NR | 0.04-0.252 | NR | NR |
| F7C3C | FC7C3 | NR | 0.04-0.252 | NR | NR |
| F7D3C | FC7D3 | NR | 0.04-0.252 | NR | NR |
| F7E3C | FC7E3 | NR | 0.04-0.252 | NR | NR |
| F7A4C | FC7A4 | NR | 0.04-0.252 | NR | NR |
| F7B4C | FC7B4 | NR | 0.04-0.252 | NR | NR |
| F7C4C | FC7C4 | NR | 0.04-0.252 | NR | NR |
| F7D4C | FC7D4 | NR | 0.04-0.252 | NR | NR |
| F7E4C | FC7E4 | NR | 0.04-0.252 | NR | NR |
| F7A5C | FC7A5 | NR | 0.04-0.252 | NR | NR |
| F7B5C | FC7B5 | NR | 0.04-0.252 | NR | NR |
| F7C5C | FC7C5 | NR | 0.04-0.252 | NR | NR |
| F7D5C | FC7D5 | NR | 0.04-0.252 | NR | NR |
| F7E5C | FC7E5 | NR | 0.04-0.252 | NR | NR |
| F7A6C | FC7A6 | NR | 0.04-0.252 | NR | NR |
| F7B6C | FC7B6 | NR | 0.04-0.252 | NR | NR |
| F7C6C | FC7C6 | NR | 0.04-0.252 | NR | NR |
| F7D6C | FC7D6 | NR | 0.04-0.252 | NR | NR |
| F7E6C | FC7E6 | NR | 0.04-0.252 | NR | NR |
| F8A1C | FC8A1 | NR | 0.04-0.252 | NR | NR |
| F8B1C | FC8B1 | NR | 0.04-0.252 | NR | NR |
| F8C1C | FC8C1 | NR | 0.04-0.252 | NR | NR |
| F8D1C | FC8D1 | NR | 0.04-0.252 | NR | NR |
| F8E1C | FC8E1 | NR | 0.04-0.252 | NR | NR |
| F8A2C | FC8A2 | NR | 0.04-0.252 | NR | NR |
| F8B2C | FC8B2 | NR | 0.04-0.252 | NR | NR |
| F8C2C | FC8C2 | NR | 0.04-0.252 | NR | NR |
| F8D2C | FC8D2 | NR | 0.04-0.252 | NR | NR |
| F8E2C | FC8E2 | NR | 0.04-0.252 | NR | NR |
| F8A3C | FC8A3 | NR | 0.04-0.252 | NR | NR |
| F8B3C | FC8B3 | NR | 0.04-0.252 | NR | NR |
| F8C3C | FC8C3 | NR | 0.04-0.252 | NR | NR |
| F8D3C | FC8D3 | NR | 0.04-0.252 | NR | NR |
| F8E3C | FC8E3 | NR | 0.04-0.252 | NR | NR |
| F8A4C | FC8A4 | NR | 0.04-0.252 | NR | NR |
| F8B4C | FC8B4 | NR | 0.04-0.252 | NR | NR |
| F8C4C | FC8C4 | NR | 0.04-0.252 | NR | NR |
| F8D4C | FC8D4 | NR | 0.04-0.252 | NR | NR |
| F8E4C | FC8E4 | NR | 0.04-0.252 | NR | NR |
| F8A5C | FC8A5 | NR | 0.04-0.252 | NR | NR |
| F8B5C | FC8B5 | NR | 0.04-0.252 | NR | NR |
| F8C5C | FC8C5 | NR | 0.04-0.252 | NR | NR |
| F8D5C | FC8D5 | NR | 0.04-0.252 | NR | NR |
| F8E5C | FC8E5 | NR | 0.04-0.252 | NR | NR |
| F8A6C | FC8A6 | NR | 0.04-0.252 | NR | NR |
| F8B6C | FC8B6 | NR | 0.04-0.252 | NR | NR |
| F8C6C | FC8C6 | NR | 0.04-0.252 | NR | NR |
| F8D6C | FC8D6 | NR | 0.04-0.252 | NR | NR |
| F8E6C | FC8E6 | NR | 0.04-0.252 | NR | NR |
| F1A1D | FC1A1 | NR | NR | 0.6-14 | 1.0-6 |
| F1B1D | FC1B1 | NR | NR | 0.6-14 | 1.0-6 |
| F1C1D | FC1C1 | NR | NR | 0.6-14 | 1.0-6 |
| F1D1D | FC1D1 | NR | NR | 0.6-14 | 1.0-6 |
| F1E1D | FC1E1 | NR | NR | 0.6-14 | 1.0-6 |
| F1A2D | FC1A2 | NR | NR | 0.6-14 | 1.0-6 |
| F1B2D | FC1B2 | NR | NR | 0.6-14 | 1.0-6 |
| F1C2D | FC1C2 | NR | NR | 0.6-14 | 1.0-6 |
| F1D2D | FC1D2 | NR | NR | 0.6-14 | 1.0-6 |
| F1E2D | FC1E2 | NR | NR | 0.6-14 | 1.0-6 |
| F1A3D | FC1A3 | NR | NR | 0.6-14 | 1.0-6 |
| F1B3D | FC1B3 | NR | NR | 0.6-14 | 1.0-6 |
| F1C3D | FC1C3 | NR | NR | 0.6-14 | 1.0-6 |
| F1D3D | FC1D3 | NR | NR | 0.6-14 | 1.0-6 |
| F1E3D | FC1E3 | NR | NR | 0.6-14 | 1.0-6 |
| F1A4D | FC1A4 | NR | NR | 0.6-14 | 1.0-6 |
| F1B4D | FC1B4 | NR | NR | 0.6-14 | 1.0-6 |
| F1C4D | FC1C4 | NR | NR | 0.6-14 | 1.0-6 |
| F1D4D | FC1D4 | NR | NR | 0.6-14 | 1.0-6 |
| F1E4D | FC1E4 | NR | NR | 0.6-14 | 1.0-6 |
| F1A5D | FC1A5 | NR | NR | 0.6-14 | 1.0-6 |
| F1B5D | FC1B5 | NR | NR | 0.6-14 | 1.0-6 |
| F1C5D | FC1C5 | NR | NR | 0.6-14 | 1.0-6 |
| F1D5D | FC1D5 | NR | NR | 0.6-14 | 1.0-6 |
| F1E5D | FC1E5 | NR | NR | 0.6-14 | 1.0-6 |
| F1A6D | FC1A6 | NR | NR | 0.6-14 | 1.0-6 |
| F1B6D | FC1B6 | NR | NR | 0.6-14 | 1.0-6 |
| F1C6D | FC1C6 | NR | NR | 0.6-14 | 1.0-6 |
| F1D6D | FC1D6 | NR | NR | 0.6-14 | 1.0-6 |
| F1E6D | FC1E6 | NR | NR | 0.6-14 | 1.0-6 |
| F2A1D | FC2A1 | NR | NR | 0.6-14 | 1.0-6 |
| F2B1D | FC2B1 | NR | NR | 0.6-14 | 1.0-6 |
| F2C1D | FC2C1 | NR | NR | 0.6-14 | 1.0-6 |
| F2D1D | FC2D1 | NR | NR | 0.6-14 | 1.0-6 |
| F2E1D | FC2E1 | NR | NR | 0.6-14 | 1.0-6 |
| F2A2D | FC2A2 | NR | NR | 0.6-14 | 1.0-6 |
| F2B2D | FC2B2 | NR | NR | 0.6-14 | 1.0-6 |
| F2C2D | FC2C2 | NR | NR | 0.6-14 | 1.0-6 |
| F2D2D | FC2D2 | NR | NR | 0.6-14 | 1.0-6 |
| F2E2D | FC2E2 | NR | NR | 0.6-14 | 1.0-6 |
| F2A3D | FC2A3 | NR | NR | 0.6-14 | 1.0-6 |
| F2B3D | FC2B3 | NR | NR | 0.6-14 | 1.0-6 |
| F2C3D | FC2C3 | NR | NR | 0.6-14 | 1.0-6 |
| F2D3D | FC2D3 | NR | NR | 0.6-14 | 1.0-6 |
| F2E3D | FC2E3 | NR | NR | 0.6-14 | 1.0-6 |
| F2A4D | FC2A4 | NR | NR | 0.6-14 | 1.0-6 |
| F2B4D | FC2B4 | NR | NR | 0.6-14 | 1.0-6 |
| F2C4D | FC2C4 | NR | NR | 0.6-14 | 1.0-6 |
| F2D4D | FC2D4 | NR | NR | 0.6-14 | 1.0-6 |
| F2E4D | FC2E4 | NR | NR | 0.6-14 | 1.0-6 |
| F2A5D | FC2A5 | NR | NR | 0.6-14 | 1.0-6 |
| F2B5D | FC2B5 | NR | NR | 0.6-14 | 1.0-6 |
| F2C5D | FC2C5 | NR | NR | 0.6-14 | 1.0-6 |
| F2D5D | FC2D5 | NR | NR | 0.6-14 | 1.0-6 |
| F2E5D | FC2E5 | NR | NR | 0.6-14 | 1.0-6 |
| F2A6D | FC2A6 | NR | NR | 0.6-14 | 1.0-6 |
| F2B6D | FC2B6 | NR | NR | 0.6-14 | 1.0-6 |
| F2C6D | FC2C6 | NR | NR | 0.6-14 | 1.0-6 |
| F2D6D | FC2D6 | NR | NR | 0.6-14 | 1.0-6 |
| F2E6D | FC2E6 | NR | NR | 0.6-14 | 1.0-6 |
| F3A1D | FC3A1 | NR | NR | 0.6-14 | 1.0-6 |
| F3B1D | FC3B1 | NR | NR | 0.6-14 | 1.0-6 |
| F3C1D | FC3C1 | NR | NR | 0.6-14 | 1.0-6 |
| F3D1D | FC3D1 | NR | NR | 0.6-14 | 1.0-6 |
| F3E1D | FC3E1 | NR | NR | 0.6-14 | 1.0-6 |
| F3A2D | FC3A2 | NR | NR | 0.6-14 | 1.0-6 |
| F3B2D | FC3B2 | NR | NR | 0.6-14 | 1.0-6 |
| F3C2D | FC3C2 | NR | NR | 0.6-14 | 1.0-6 |
| F3D2D | FC3D2 | NR | NR | 0.6-14 | 1.0-6 |
| F3E2D | FC3E2 | NR | NR | 0.6-14 | 1.0-6 |
| F3A3D | FC3A3 | NR | NR | 0.6-14 | 1.0-6 |
| F3B3D | FC3B3 | NR | NR | 0.6-14 | 1.0-6 |
| F3C3D | FC3C3 | NR | NR | 0.6-14 | 1.0-6 |
| F3D3D | FC3D3 | NR | NR | 0.6-14 | 1.0-6 |
| F3E3D | FC3E3 | NR | NR | 0.6-14 | 1.0-6 |
| F3A4D | FC3A4 | NR | NR | 0.6-14 | 1.0-6 |
| F3B4D | FC3B4 | NR | NR | 0.6-14 | 1.0-6 |
| F3C4D | FC3C4 | NR | NR | 0.6-14 | 1.0-6 |
| F3D4D | FC3D4 | NR | NR | 0.6-14 | 1.0-6 |
| F3E4D | FC3E4 | NR | NR | 0.6-14 | 1.0-6 |
| F3A5D | FC3A5 | NR | NR | 0.6-14 | 1.0-6 |
| F3B5D | FC3B5 | NR | NR | 0.6-14 | 1.0-6 |
| F3C5D | FC3C5 | NR | NR | 0.6-14 | 1.0-6 |
| F3D5D | FC3D5 | NR | NR | 0.6-14 | 1.0-6 |
| F3E5D | FC3E5 | NR | NR | 0.6-14 | 1.0-6 |
| F3A6D | FC3A6 | NR | NR | 0.6-14 | 1.0-6 |
| F3B6D | FC3B6 | NR | NR | 0.6-14 | 1.0-6 |
| F3C6D | FC3C6 | NR | NR | 0.6-14 | 1.0-6 |
| F3D6D | FC3D6 | NR | NR | 0.6-14 | 1.0-6 |
| F3E6D | FC3E6 | NR | NR | 0.6-14 | 1.0-6 |
| F4A1D | FC4A1 | NR | NR | 0.6-14 | 1.0-6 |
| F4B1D | FC4B1 | NR | NR | 0.6-14 | 1.0-6 |
| F4C1D | FC4C1 | NR | NR | 0.6-14 | 1.0-6 |
| F4D1D | FC4D1 | NR | NR | 0.6-14 | 1.0-6 |
| F4E1D | FC4E1 | NR | NR | 0.6-14 | 1.0-6 |
| F4A2D | FC4A2 | NR | NR | 0.6-14 | 1.0-6 |
| F4B2D | FC4B2 | NR | NR | 0.6-14 | 1.0-6 |
| F4C2D | FC4C2 | NR | NR | 0.6-14 | 1.0-6 |
| F4D2D | FC4D2 | NR | NR | 0.6-14 | 1.0-6 |
| F4E2D | FC4E2 | NR | NR | 0.6-14 | 1.0-6 |
| F4A3D | FC4A3 | NR | NR | 0.6-14 | 1.0-6 |
| F4B3D | FC4B3 | NR | NR | 0.6-14 | 1.0-6 |
| FC4C3D | FC4C3 | NR | NR | 0.6-14 | 1.0-6 |
| F4D3D | FC4D3 | NR | NR | 0.6-14 | 1.0-6 |
| F4E3D | FC4E3 | NR | NR | 0.6-14 | 1.0-6 |
| F4A4D | FC4A4 | NR | NR | 0.6-14 | 1.0-6 |
| F4B4D | FC4B4 | NR | NR | 0.6-14 | 1.0-6 |
| F4C4D | FC4C4 | NR | NR | 0.6-14 | 1.0-6 |
| F4D4D | FC4D4 | NR | NR | 0.6-14 | 1.0-6 |
| F4E4D | FC4E4 | NR | NR | 0.6-14 | 1.0-6 |
| F4A5D | FC4A5 | NR | NR | 0.6-14 | 1.0-6 |
| F4B5D | FC4B5 | NR | NR | 0.6-14 | 1.0-6 |
| F4C5D | FC4C5 | NR | NR | 0.6-14 | 1.0-6 |
| F4D5D | FC4D5 | NR | NR | 0.6-14 | 1.0-6 |
| F4E5D | FC4E5 | NR | NR | 0.6-14 | 1.0-6 |
| F4A6D | FC4A6 | NR | NR | 0.6-14 | 1.0-6 |
| F4B6D | FC4B6 | NR | NR | 0.6-14 | 1.0-6 |
| F4C6D | FC4C6 | NR | NR | 0.6-14 | 1.0-6 |
| F4D6D | FC4D6 | NR | NR | 0.6-14 | 1.0-6 |
| F4E6D | FC4E6 | NR | NR | 0.6-14 | 1.0-6 |
| F5A1D | FC5A1 | NR | NR | 0.6-14 | 1.0-6 |
| F5B1D | FC5B1 | NR | NR | 0.6-14 | 1.0-6 |
| F5C1D | FC5C1 | NR | NR | 0.6-14 | 1.0-6 |
| F5D1D | FC5D1 | NR | NR | 0.6-14 | 1.0-6 |
| F5E1D | FC5E1 | NR | NR | 0.6-14 | 1.0-6 |
| F5A2D | FC5A2 | NR | NR | 0.6-14 | 1.0-6 |
| F5B2D | FC5B2 | NR | NR | 0.6-14 | 1.0-6 |
| F5C2D | FC5C2 | NR | NR | 0.6-14 | 1.0-6 |
| F5D2D | FC5D2 | NR | NR | 0.6-14 | 1.0-6 |
| F5E2D | FC5E2 | NR | NR | 0.6-14 | 1.0-6 |
| F5A3D | FC5A3 | NR | NR | 0.6-14 | 1.0-6 |
| F5B3D | FC5B3 | NR | NR | 0.6-14 | 1.0-6 |
| F5C3D | FC5C3 | NR | NR | 0.6-14 | 1.0-6 |
| F5D3D | FC5D3 | NR | NR | 0.6-14 | 1.0-6 |
| F5E3D | FC5E3 | NR | NR | 0.6-14 | 1.0-6 |
| F5A4D | FC5A4 | NR | NR | 0.6-14 | 1.0-6 |
| F5B4D | FC5B4 | NR | NR | 0.6-14 | 1.0-6 |
| F5C4D | FC5C4 | NR | NR | 0.6-14 | 1.0-6 |
| F5D4D | FC5D4 | NR | NR | 0.6-14 | 1.0-6 |
| F5E4D | FC5E4 | NR | NR | 0.6-14 | 1.0-6 |
| F5A5D | FC5A5 | NR | NR | 0.6-14 | 1.0-6 |
| F5B5D | FC5B5 | NR | NR | 0.6-14 | 1.0-6 |
| F5C5D | FC5C5 | NR | NR | 0.6-14 | 1.0-6 |
| F5D5D | FC5D5 | NR | NR | 0.6-14 | 1.0-6 |
| F5E5D | FC5E5 | NR | NR | 0.6-14 | 1.0-6 |
| F5A6D | FC5A6 | NR | NR | 0.6-14 | 1.0-6 |
| F5B6D | FC5B6 | NR | NR | 0.6-14 | 1.0-6 |
| F5C6D | FC5C6 | NR | NR | 0.6-14 | 1.0-6 |
| F5D6D | FC5D6 | NR | NR | 0.6-14 | 1.0-6 |
| F5E6D | FC5E6 | NR | NR | 0.6-14 | 1.0-6 |
| F6A1D | FC6A1 | NR | NR | 0.6-14 | 1.0-6 |
| F6B1D | FC6B1 | NR | NR | 0.6-14 | 1.0-6 |
| F6C1D | FC6C1 | NR | NR | 0.6-14 | 1.0-6 |
| F6D1D | FC6D1 | NR | NR | 0.6-14 | 1.0-6 |
| F6E1D | FC6E1 | NR | NR | 0.6-14 | 1.0-6 |
| F6A2D | FC6A2 | NR | NR | 0.6-14 | 1.0-6 |
| F6B2D | FC6B2 | NR | NR | 0.6-14 | 1.0-6 |
| F6C2D | FC6C2 | NR | NR | 0.6-14 | 1.0-6 |
| F6D2D | FC6D2 | NR | NR | 0.6-14 | 1.0-6 |
| F6E2D | FC6E2 | NR | NR | 0.6-14 | 1.0-6 |
| F6A3D | FC6A3 | NR | NR | 0.6-14 | 1.0-6 |
| F6B3D | FC6B3 | NR | NR | 0.6-14 | 1.0-6 |
| F6C3D | FC6C3 | NR | NR | 0.6-14 | 1.0-6 |
| F6D3D | FC6D3 | NR | NR | 0.6-14 | 1.0-6 |
| F6E3D | FC6E3 | NR | NR | 0.6-14 | 1.0-6 |
| F6B4D | FC6B4 | NR | NR | 0.6-14 | 1.0-6 |
| F6C4D | FC6C4 | NR | NR | 0.6-14 | 1.0-6 |
| F6D4D | FC6D4 | NR | NR | 0.6-14 | 1.0-6 |
| F6E4D | FC6E4 | NR | NR | 0.6-14 | 1.0-6 |
| F6A5D | FC6A5 | NR | NR | 0.6-14 | 1.0-6 |
| F6B5D | FC6B5 | NR | NR | 0.6-14 | 1.0-6 |
| F6C5D | FC6C5 | NR | NR | 0.6-14 | 1.0-6 |
| F6D5D | FC6D5 | NR | NR | 0.6-14 | 1.0-6 |
| F6E5D | FC6E5 | NR | NR | 0.6-14 | 1.0-6 |
| F6A6D | FC6A6 | NR | NR | 0.6-14 | 1.0-6 |
| F6B6D | FC6B6 | NR | NR | 0.6-14 | 1.0-6 |
| F6C6D | FC6C6 | NR | NR | 0.6-14 | 1.0-6 |
| F6D6D | FC6D6 | NR | NR | 0.6-14 | 1.0-6 |
| F6E6D | FC6E6 | NR | NR | 0.6-14 | 1.0-6 |
| F7A1D | FC7A1 | NR | NR | 0.6-14 | 1.0-6 |
| F7B1D | FC7B1 | NR | NR | 0.6-14 | 1.0-6 |
| F7C1D | FC7C1 | NR | NR | 0.6-14 | 1.0-6 |
| F7D1D | FC7D1 | NR | NR | 0.6-14 | 1.0-6 |
| F7E1D | FC7E1 | NR | NR | 0.6-14 | 1.0-6 |
| F7A2D | FC7A2 | NR | NR | 0.6-14 | 1.0-6 |
| F7B2D | FC7B2 | NR | NR | 0.6-14 | 1.0-6 |
| F7C2D | FC7C2 | NR | NR | 0.6-14 | 1.0-6 |
| F7D2D | FC7D2 | NR | NR | 0.6-14 | 1.0-6 |
| F7E2D | FC7E2 | NR | NR | 0.6-14 | 1.0-6 |
| F7A3D | FC7A3 | NR | NR | 0.6-14 | 1.0-6 |
| F7B3D | FC7B3 | NR | NR | 0.6-14 | 1.0-6 |
| F7C3D | FC7C3 | NR | NR | 0.6-14 | 1.0-6 |
| F7D3D | FC7D3 | NR | NR | 0.6-14 | 1.0-6 |
| F7E3D | FC7E3 | NR | NR | 0.6-14 | 1.0-6 |
| F7A4D | FC7A4 | NR | NR | 0.6-14 | 1.0-6 |
| F7B4D | FC7B4 | NR | NR | 0.6-14 | 1.0-6 |
| F7C4D | FC7C4 | NR | NR | 0.6-14 | 1.0-6 |
| F7D4D | FC7D4 | NR | NR | 0.6-14 | 1.0-6 |
| F7E4D | FC7E4 | NR | NR | 0.6-14 | 1.0-6 |
| F7A5D | FC7A5 | NR | NR | 0.6-14 | 1.0-6 |
| F7B5D | FC7B5 | NR | NR | 0.6-14 | 1.0-6 |
| F7C5D | FC7C5 | NR | NR | 0.6-14 | 1.0-6 |
| F7D5D | FC7D5 | NR | NR | 0.6-14 | 1.0-6 |
| F7E5D | FC7E5 | NR | NR | 0.6-14 | 1.0-6 |
| F7A6D | FC7A6 | NR | NR | 0.6-14 | 1.0-6 |
| F7B6D | FC7B6 | NR | NR | 0.6-14 | 1.0-6 |
| F7C6D | FC7C6 | NR | NR | 0.6-14 | 1.0-6 |
| F7D6D | FC7D6 | NR | NR | 0.6-14 | 1.0-6 |
| F7E6D | FC7E6 | NR | NR | 0.6-14 | 1.0-6 |
| F8A1D | FC8A1 | NR | NR | 0.6-14 | 1.0-6 |
| F8B1D | FC8B1 | NR | NR | 0.6-14 | 1.0-6 |
| F8C1D | FC8C1 | NR | NR | 0.6-14 | 1.0-6 |
| F8D1B | FC8D1 | NR | NR | 0.6-14 | 1.0-6 |
| F8E1D | FC8E1 | NR | NR | 0.6-14 | 1.0-6 |
| F8A2B | FC8A2 | NR | NR | 0.6-14 | 1.0-6 |
| F8B2D | FC8B2 | NR | NR | 0.6-14 | 1.0-6 |
| F8C2D | FC8C2 | NR | NR | 0.6-14 | 1.0-6 |
| F8D2D | FC8D2 | NR | NR | 0.6-14 | 1.0-6 |
| F8E2D | FC8E2 | NR | NR | 0.6-14 | 1.0-6 |
| F8A3D | FC8A3 | NR | NR | 0.6-14 | 1.0-6 |
| F8B3D | FC8B3 | NR | NR | 0.6-14 | 1.0-6 |
| F8C3D | FC8C3 | NR | NR | 0.6-14 | 1.0-6 |
| F8D3D | FC8D3 | NR | NR | 0.6-14 | 1.0-6 |
| F8E3D | FC8E3 | NR | NR | 0.6-14 | 1.0-6 |
| F8A4D | FC8A4 | NR | NR | 0.6-14 | 1.0-6 |
| F8B4D | FC8B4 | NR | NR | 0.6-14 | 1.0-6 |
| F8C4D | FC8C4 | NR | NR | 0.6-14 | 1.0-6 |
| F8D4D | FC8D4 | NR | NR | 0.6-14 | 1.0-6 |
| F8E4D | FC8E4 | NR | NR | 0.6-14 | 1.0-6 |
| F8A5D | FC8A5 | NR | NR | 0.6-14 | 1.0-6 |
| F8B5D | FC8B5 | NR | NR | 0.6-14 | 1.0-6 |
| F8C5D | FC8C5 | NR | NR | 0.6-14 | 1.0-6 |
| F8D5D | FC8D5 | NR | NR | 0.6-14 | 1.0-6 |
| F8E5D | FC8E5 | NR | NR | 0.6-14 | 1.0-6 |
| F8A6D | FC8A6 | NR | NR | 0.6-14 | 1.0-6 |
| F8B6D | FC8B6 | NR | NR | 0.6-14 | 1.0-6 |
| F8C6D | FC8C6 | NR | NR | 0.6-14 | 1.0-6 |
| F8D6D | FC8D6 | NR | NR | 0.6-14 | 1.0-6 |
| F8E6D | FC8E6 | NR | NR | 0.6-14 | 1.0-6 |
| F1A1E | FC1A1 | >25% | 0.05-0.1 | 0.6-14 | 1.0-6 |
| F1B1E | FC1B1 | NR | NR | 0.6-14 | 1.0-6 |
| F1C1E | FC1C1 | NR | NR | 0.6-14 | 1.0-6 |
| F1D1E | FC1D1 | NR | NR | 0.6-14 | 1.0-6 |
| F1E1E | FC1E1 | NR | NR | 0.6-14 | 1.0-6 |
| F1A2E | FC1A2 | NR | NR | 0.6-14 | 1.0-6 |
| F1B2E | FC1B2 | NR | NR | 0.6-14 | 1.0-6 |
| F1C2E | FC1C2 | NR | NR | 0.6-14 | 1.0-6 |
| F1D2E | FC1D2 | NR | NR | 0.6-14 | 1.0-6 |
| F1E2E | FC1E2 | NR | NR | 0.6-14 | 1.0-6 |
| F1A3E | FC1A3 | NR | NR | 0.6-14 | 1.0-6 |
| F1B3E | FC1B3 | NR | NR | 0.6-14 | 1.0-6 |
| F1C3E | FC1C3 | NR | NR | 0.6-14 | 1.0-6 |
| F1D3E | FC1D3 | NR | NR | 0.6-14 | 1.0-6 |
| F1E3E | FC1E3 | NR | NR | 0.6-14 | 1.0-6 |
| F1A4E | FC1A4 | NR | NR | 0.6-14 | 1.0-6 |
| F1B4E | FC1B4 | NR | NR | 0.6-14 | 1.0-6 |
| F1C4E | FC1C4 | NR | NR | 0.6-14 | 1.0-6 |
| F1D4E | FC1D4 | NR | NR | 0.6-14 | 1.0-6 |
| F1E4E | FC1E4 | NR | NR | 0.6-14 | 1.0-6 |
| F1A5E | FC1A5 | NR | NR | 0.6-14 | 1.0-6 |
| F1B5E | FC1B5 | NR | NR | 0.6-14 | 1.0-6 |
| F1C5E | FC1C5 | NR | NR | 0.6-14 | 1.0-6 |
| F1D5E | FC1D5 | NR | NR | 0.6-14 | 1.0-6 |
| F1E5E | FC1E5 | NR | NR | 0.6-14 | 1.0-6 |
| F1A6E | FC1A6 | NR | NR | 0.6-14 | 1.0-6 |
| F1B6E | FC1B6 | NR | NR | 0.6-14 | 1.0-6 |
| F1C6E | FC1C6 | NR | NR | 0.6-14 | 1.0-6 |
| F1D6E | FC1D6 | NR | NR | 0.6-14 | 1.0-6 |
| F1E6E | FC1E6 | NR | NR | 0.6-14 | 1.0-6 |
| F2A1E | FC2A1 | NR | NR | 0.6-14 | 1.0-6 |
| F2B1E | FC2B1 | NR | NR | 0.6-14 | 1.0-6 |
| F2C1E | FC2C1 | NR | NR | 0.6-14 | 1.0-6 |
| F2D1E | FC2D1 | NR | NR | 0.6-14 | 1.0-6 |
| F2E1E | FC2E1 | NR | NR | 0.6-14 | 1.0-6 |
| F2A2E | FC2A2 | NR | NR | 0.6-14 | 1.0-6 |
| F2B2E | FC2B2 | NR | NR | 0.6-14 | 1.0-6 |
| F2C2E | FC2C2 | NR | NR | 0.6-14 | 1.0-6 |
| F2D2E | FC2D2 | NR | NR | 0.6-14 | 1.0-6 |
| F2E2E | FC2E2 | NR | NR | 0.6-14 | 1.0-6 |
| F2A3E | FC2A3 | NR | NR | 0.6-14 | 1.0-6 |
| F2B3E | FC2B3 | NR | NR | 0.6-14 | 1.0-6 |
| F2C3E | FC2C3 | NR | NR | 0.6-14 | 1.0-6 |
| F2D3E | FC2D3 | NR | NR | 0.6-14 | 1.0-6 |
| F2E3E | FC2E3 | NR | NR | 0.6-14 | 1.0-6 |
| F2A4E | FC2A4 | NR | NR | 0.6-14 | 1.0-6 |
| F2B4E | FC2B4 | NR | NR | 0.6-14 | 1.0-6 |
| F2C4E | FC2C4 | NR | NR | 0.6-14 | 1.0-6 |
| F2D4E | FC2D4 | NR | NR | 0.6-14 | 1.0-6 |
| F2E4E | FC2E4 | NR | NR | 0.6-14 | 1.0-6 |
| F2A5E | FC2A5 | NR | NR | 0.6-14 | 1.0-6 |
| F2B5E | FC2B5 | NR | NR | 0.6-14 | 1.0-6 |
| F2C5E | FC2C5 | NR | NR | 0.6-14 | 1.0-6 |
| F2D5E | FC2D5 | NR | NR | 0.6-14 | 1.0-6 |
| F2E5E | FC2E5 | NR | NR | 0.6-14 | 1.0-6 |
| F2A6E | FC2A6 | NR | NR | 0.6-14 | 1.0-6 |
| F2B6E | FC2B6 | NR | NR | 0.6-14 | 1.0-6 |
| F2C6E | FC2C6 | NR | NR | 0.6-14 | 1.0-6 |
| F2D6E | FC2D6 | NR | NR | 0.6-14 | 1.0-6 |
| F2E6E | FC2E6 | NR | NR | 0.6-14 | 1.0-6 |
| F3A1E | FC3A1 | NR | NR | 0.6-14 | 1.0-6 |
| F3B1E | FC3B1 | NR | NR | 0.6-14 | 1.0-6 |
| F3C1E | FC3C1 | NR | NR | 0.6-14 | 1.0-6 |
| F3D1E | FC3D1 | NR | NR | 0.6-14 | 1.0-6 |
| F3E1E | FC3E1 | NR | NR | 0.6-14 | 1.0-6 |
| F3A2E | FC3A2 | NR | NR | 0.6-14 | 1.0-6 |
| F3B2E | FC3B2 | NR | NR | 0.6-14 | 1.0-6 |
| F3C2E | FC3C2 | NR | NR | 0.6-14 | 1.0-6 |
| F3D2E | FC3D2 | NR | NR | 0.6-14 | 1.0-6 |
| F3E2E | FC3E2 | NR | NR | 0.6-14 | 1.0-6 |
| F3A3E | FC3A3 | NR | NR | 0.6-14 | 1.0-6 |
| F3B3E | FC3B3 | NR | NR | 0.6-14 | 1.0-6 |
| F3C3E | FC3C3 | NR | NR | 0.6-14 | 1.0-6 |
| F3D3E | FC3D3 | NR | NR | 0.6-14 | 1.0-6 |
| F3E3E | FC3E3 | NR | NR | 0.6-14 | 1.0-6 |
| F3A4E | FC3A4 | NR | NR | 0.6-14 | 1.0-6 |
| F3B4E | FC3B4 | NR | NR | 0.6-14 | 1.0-6 |
| F3C4E | FC3C4 | NR | NR | 0.6-14 | 1.0-6 |
| F3D4E | FC3D4 | NR | NR | 0.6-14 | 1.0-6 |
| F3E4E | FC3E4 | NR | NR | 0.6-14 | 1.0-6 |
| F3A5E | FC3A5 | NR | NR | 0.6-14 | 1.0-6 |
| F3B5E | FC3B5 | NR | NR | 0.6-14 | 1.0-6 |
| F3C5E | FC3C5 | NR | NR | 0.6-14 | 1.0-6 |
| F3D5E | FC3D5 | NR | NR | 0.6-14 | 1.0-6 |
| F3E5E | FC3E5 | NR | NR | 0.6-14 | 1.0-6 |
| F3A6E | FC3A6 | NR | NR | 0.6-14 | 1.0-6 |
| F3B6E | FC3B6 | NR | NR | 0.6-14 | 1.0-6 |
| F3C6E | FC3C6 | NR | NR | 0.6-14 | 1.0-6 |
| F3D6E | FC3D6 | NR | NR | 0.6-14 | 1.0-6 |
| F3E6E | FC3E6 | NR | NR | 0.6-14 | 1.0-6 |
| F4A1E | FC4A1 | NR | NR | 0.6-14 | 1.0-6 |
| F4B1E | FC4B1 | NR | NR | 0.6-14 | 1.0-6 |
| F4C1E | FC4C1 | NR | NR | 0.6-14 | 1.0-6 |
| F4D1E | FC4D1 | NR | NR | 0.6-14 | 1.0-6 |
| F4E1E | FC4E1 | NR | NR | 0.6-14 | 1.0-6 |
| F4A2E | FC4A2 | NR | NR | 0.6-14 | 1.0-6 |
| F4B2E | FC4B2 | NR | NR | 0.6-14 | 1.0-6 |
| F4C2E | FC4C2 | NR | NR | 0.6-14 | 1.0-6 |
| F4D2E | FC4D2 | NR | NR | 0.6-14 | 1.0-6 |
| F4E2E | FC4E2 | NR | NR | 0.6-14 | 1.0-6 |
| F4A3E | FC4A3 | NR | NR | 0.6-14 | 1.0-6 |
| F4B3E | FC4B3 | NR | NR | 0.6-14 | 1.0-6 |
| F4C3E | FC4C3 | NR | NR | 0.6-14 | 1.0-6 |
| F4D3E | FC4D3 | NR | NR | 0.6-14 | 1.0-6 |
| F4E3E | FC4E3 | NR | NR | 0.6-14 | 1.0-6 |
| F4A4E | FC4A4 | NR | NR | 0.6-14 | 1.0-6 |
| F4B4E | FC4B4 | NR | NR | 0.6-14 | 1.0-6 |
| F4C4E | FC4C4 | NR | NR | 0.6-14 | 1.0-6 |
| F4D4E | FC4D4 | NR | NR | 0.6-14 | 1.0-6 |
| F4E4E | FC4E4 | NR | NR | 0.6-14 | 1.0-6 |
| F4A5E | FC4A5 | NR | NR | 0.6-14 | 1.0-6 |
| F4B5E | FC4B5 | NR | NR | 0.6-14 | 1.0-6 |
| F4C5E | FC4C5 | NR | NR | 0.6-14 | 1.0-6 |
| F4D5E | FC4D5 | NR | NR | 0.6-14 | 1.0-6 |
| F4E5E | FC4E5 | NR | NR | 0.6-14 | 1.0-6 |
| F4A6E | FC4A6 | NR | NR | 0.6-14 | 1.0-6 |
| F4B6E | FC4B6 | NR | NR | 0.6-14 | 1.0-6 |
| F4C6E | FC4C6 | NR | NR | 0.6-14 | 1.0-6 |
| F4D6E | FC4D6 | NR | NR | 0.6-14 | 1.0-6 |
| F4E6E | FC4E6 | NR | NR | 0.6-14 | 1.0-6 |
| F5A1E | FC5A1 | NR | NR | 0.6-14 | 1.0-6 |
| F5B1E | FC5B1 | NR | NR | 0.6-14 | 1.0-6 |
| F5C1E | FC5C1 | NR | NR | 0.6-14 | 1.0-6 |
| F5D1E | FC5D1 | NR | NR | 0.6-14 | 1.0-6 |
| F5E1E | FC5E1 | NR | NR | 0.6-14 | 1.0-6 |
| F5A2E | FC5A2 | NR | NR | 0.6-14 | 1.0-6 |
| F5B2E | FC5B2 | NR | NR | 0.6-14 | 1.0-6 |
| F5C2E | FC5C2 | NR | NR | 0.6-14 | 1.0-6 |
| F5D2E | FC5D2 | NR | NR | 0.6-14 | 1.0-6 |
| F5E2E | FC5E2 | NR | NR | 0.6-14 | 1.0-6 |
| F5A3E | FC5A3 | NR | NR | 0.6-14 | 1.0-6 |
| F5B3E | FC5B3 | NR | NR | 0.6-14 | 1.0-6 |
| F5C3E | FC5C3 | NR | NR | 0.6-14 | 1.0-6 |
| F5D3E | FC5D3 | NR | NR | 0.6-14 | 1.0-6 |
| F5E3E | FC5E3 | NR | NR | 0.6-14 | 1.0-6 |
| F5A4E | FC5A4 | NR | NR | 0.6-14 | 1.0-6 |
| F5B4E | FC5B4 | NR | NR | 0.6-14 | 1.0-6 |
| F5C4E | FC5C4 | NR | NR | 0.6-14 | 1.0-6 |
| F5D4E | FC5D4 | NR | NR | 0.6-14 | 1.0-6 |
| F5E4E | FC5E4 | NR | NR | 0.6-14 | 1.0-6 |
| F5A5E | FC5A5 | NR | NR | 0.6-14 | 1.0-6 |
| F5B5B | FC5E5 | NR | NR | 0.6-14 | 1.0-6 |
| F5C5E | FC5C5 | NR | NR | 0.6-14 | 1.0-6 |
| F5D5E | FC5D5 | NR | NR | 0.6-14 | 1.0-6 |
| F5E5E | FC5E5 | NR | NR | 0.6-14 | 1.0-6 |
| F5A6E | FC5A6 | NR | NR | 0.6-14 | 1.0-6 |
| F5B6E | FC5B6 | NR | NR | 0.6-14 | 1.0-6 |
| F5C6E | FC5C6 | NR | NR | 0.6-14 | 1.0-6 |
| F5D6E | FC5D6 | NR | NR | 0.6-14 | 1.0-6 |
| F5E6E | FC5E6 | NR | NR | 0.6-14 | 1.0-6 |
| F6A1E | FC6A1 | NR | NR | 0.6-14 | 1.0-6 |
| F6B1E | FC6B1 | NR | NR | 0.6-14 | 1.0-6 |
| F6C1E | FC6C1 | NR | NR | 0.6-14 | 1.0-6 |
| F6D1E | FC6D1 | NR | NR | 0.6-14 | 1.0-6 |
| F6E1E | FC6E1 | NR | NR | 0.6-14 | 1.0-6 |
| F6A2E | FC6A2 | NR | NR | 0.6-14 | 1.0-6 |
| F6B2E | FC6E2 | NR | NR | 0.6-14 | 1.0-6 |
| F6C2E | FC6C2 | NR | NR | 0.6-14 | 1.0-6 |
| F6D2E | FC6D2 | NR | NR | 0.6-14 | 1.0-6 |
| F6E2E | FC6E2 | NR | NR | 0.6-14 | 1.0-6 |
| F6A3E | FC6A3 | NR | NR | 0.6-14 | 1.0-6 |
| F6B3E | FC6B3 | NR | NR | 0.6-14 | 1.0-6 |
| F6C3E | FC6C3 | NR | NR | 0.6-14 | 1.0-6 |
| F6D3E | FC6D3 | NR | NR | 0.6-14 | 1.0-6 |
| F6E3E | FC6E3 | NR | NR | 0.6-14 | 1.0-6 |
| F6A4E | FC6A4 | NR | NR | 0.6-14 | 1.0-6 |
| F6B4E | FC6B4 | NR | NR | 0.6-14 | 1.0-6 |
| F6C4E | FC6C4 | NR | NR | 0.6-14 | 1.0-6 |
| F6D4E | FC6D4 | NR | NR | 0.6-14 | 1.0-6 |
| F6E4E | FC6E4 | NR | NR | 0.6-14 | 1.0-6 |
| F6A5E | FC6A5 | NR | NR | 0.6-14 | 1.0-6 |
| F6B5E | FC6B5 | NR | NR | 0.6-14 | 1.0-6 |
| F6C5E | FC6C5 | NR | NR | 0.6-14 | 1.0-6 |
| F6D5E | FC6D5 | NR | NR | 0.6-14 | 1.0-6 |
| F6E5E | FC6E5 | NR | NR | 0.6-14 | 1.0-6 |
| F6A6E | FC6A6 | NR | NR | 0.6-14 | 1.0-6 |
| F6B6E | FC6B6 | NR | NR | 0.6-14 | 1.0-6 |
| F6C6E | FC6C6 | NR | NR | 0.6-14 | 1.0-6 |
| F6D6E | FC6D6 | NR | NR | 0.6-14 | 1.0-6 |
| F6E6E | FC6E6 | NR | NR | 0.6-14 | 1.0-6 |
| F7A1E | FC7A1 | NR | NR | 0.6-14 | 1.0-6 |
| F7B1E | FC7B1 | NR | NR | 0.6-14 | 1.0-6 |
| F7C1E | FC7C1 | NR | NR | 0.6-14 | 1.0-6 |
| F7D1E | FC7D1 | NR | NR | 0.6-14 | 1.0-6 |
| F7E1E | FC7E1 | NR | NR | 0.6-14 | 1.0-6 |
| F7A2E | FC7A2 | NR | NR | 0.6-14 | 1.0-6 |
| F7B2E | FC7B2 | NR | NR | 0.6-14 | 1.0-6 |
| F7C2E | FC7C2 | NR | NR | 0.6-14 | 1.0-6 |
| F7D2E | FC7D2 | NR | NR | 0.6-14 | 1.0-6 |
| F7E2E | FC7E2 | NR | NR | 0.6-14 | 1.0-6 |
| F7A3E | FC7A3 | NR | NR | 0.6-14 | 1.0-6 |
| F7B3E | FC7B3 | NR | NR | 0.6-14 | 1.0-6 |
| F7C3E | FC7C3 | NR | NR | 0.6-14 | 1.0-6 |
| F7D3E | FC7D3 | NR | NR | 0.6-14 | 1.0-6 |
| F7E3E | FC7E3 | NR | NR | 0.6-14 | 1.0-6 |
| F7A4E | FC7A4 | NR | NR | 0.6-14 | 1.0-6 |
| F7B4E | FC7B4 | NR | NR | 0.6-14 | 1.0-6 |
| F7C4E | FC7C4 | NR | NR | 0.6-14 | 1.0-6 |
| F7D4E | FC7D4 | NR | NR | 0.6-14 | 1.0-6 |
| F7E4E | FC7E4 | NR | NR | 0.6-14 | 1.0-6 |
| F7A5E | FC7A5 | NR | NR | 0.6-14 | 1.0-6 |
| F7B5E | FC7B5 | NR | NR | 0.6-14 | 1.0-6 |
| F7C5E | FC7C5 | NR | NR | 0.6-14 | 1.0-6 |
| F7D5E | FC7D5 | NR | NR | 0.6-14 | 1.0-6 |
| F7E5E | FC7E5 | NR | NR | 0.6-14 | 1.0-6 |
| F7A6E | FC7A6 | NR | NR | 0.6-14 | 1.0-6 |
| F7B6E | FC7B6 | NR | NR | 0.6-14 | 1.0-6 |
| F7C6E | FC7C6 | NR | NR | 0.6-14 | 1.0-6 |
| F7D6E | FC7D6 | NR | NR | 0.6-14 | 1.0-6 |
| F7E6E | FC7E6 | NR | NR | 0.6-14 | 1.0-6 |
| F8A1E | FC8A1 | NR | NR | 0.6-14 | 1.0-6 |
| F8B1E | FC8B1 | NR | NR | 0.6-14 | 1.0-6 |
| F8C1E | FC8C1 | NR | NR | 0.6-14 | 1.0-6 |
| F8D1E | FC8D1 | NR | NR | 0.6-14 | 1.0-6 |
| F8E1E | FC8E1 | NR | NR | 0.6-14 | 1.0-6 |
| F8A2E | FC8A2 | NR | NR | 0.6-14 | 1.0-6 |
| F8B2E | FC8B2 | NR | NR | 0.6-14 | 1.0-6 |
| F8C2E | FC8C2 | NR | NR | 0.6-14 | 1.0-6 |
| F8D2E | FC8D2 | NR | NR | 0.6-14 | 1.0-6 |
| F8E2E | FC8E2 | NR | NR | 0.6-14 | 1.0-6 |
| F8A3E | FC8A3 | NR | NR | 0.6-14 | 1.0-6 |
| F8B3E | FC8B3 | NR | NR | 0.6-14 | 1.0-6 |
| F8C3E | FC8C3 | NR | NR | 0.6-14 | 1.0-6 |
| F8D3E | FC8D3 | NR | NR | 0.6-14 | 1.0-6 |
| F8E3E | FC8E3 | NR | NR | 0.6-14 | 1.0-6 |
| F8A4E | FC8A4 | NR | NR | 0.6-14 | 1.0-6 |
| F8B4E | FC8B4 | NR | NR | 0.6-14 | 1.0-6 |
| F8C4E | FC8C4 | NR | NR | 0.6-14 | 1.0-6 |
| F8D4E | FC8D4 | NR | NR | 0.6-14 | 1.0-6 |
| F8E4E | FC8E4 | NR | NR | 0.6-14 | 1.0-6 |
| F8A5E | FC8A5 | NR | NR | 0.6-14 | 1.0-6 |
| F8B5E | FC8B5 | NR | NR | 0.6-14 | 1.0-6 |
| F8C5E | FC8C5 | NR | NR | 0.6-14 | 1.0-6 |
| F8D5E | FC8D5 | NR | NR | 0.6-14 | 1.0-6 |
| F8E5E | FC8E5 | NR | NR | 0.6-14 | 1.0-6 |
| F8A6E | FC8A6 | NR | NR | 0.6-14 | 1.0-6 |
| F8B6E | FC8B6 | NR | NR | 0.6-14 | 1.0-6 |
| F8C6E | FC8C6 | NR | NR | 0.6-14 | 1.0-6 |
| F8D6E | FC8D6 | NR | NR | 0.6-14 | 1.0-6 |
| F8E6E | FC8E6 | NR | NR | 0.6-14 | 1.0-6 |
| F1B2D | FC1B2 | >25% | 0.04-0.25 | 0.6-14 | 1.0-6 |
| F1C2D | FC1C2 | >25% | 0.04-0.25 | 0.6-14 | 1.0-6 |
| F1D2D | FC1D2 | >25% | 0.04-0.25 | 0.6-14 | 1.0-6 |
| F1E2D | FC1E2 | >25% | 0.04-0.25 | 0.6-14 | 1.0-6 |
| F1A3D | FC1A3 | >25% | 0.04-0.25 | 0.6-14 | 1.0-6 |
| F1B3D | FC1B3 | >25% | 0.04-0.25 | 0.6-14 | 1.0-6 |
| F1C3D | FC1C3 | >25% | 0.04-0.25 | 0.6-14 | 1.0-6 |
| F1D3D | FC1D3 | >25% | 0.04-0.25 | 0.6-14 | 1.0-6 |
| F1E3D | FC1E3 | >25% | 0.04-0.25 | 0.6-14 | 1.0-6 |
| F1A4D | FC1A4 | >25% | 0.04-0.25 | 0.6-14 | 1.0-6 |
| F1B4D | FC1B4 | >25% | 0.04-0.25 | 0.6-14 | 1.0-6 |
| F1C4D | FC1C4 | >25% | 0.04-0.25 | 0.6-14 | 1.0-6 |
| F1D4D | FC1D4 | >25% | 0.04-0.25 | 0.6-14 | 1.0-6 |
| F1E4D | FC1E4 | >25% | 0.04-0.25 | 0.6-14 | 1.0-6 |
| F1A5D | FC1A5 | >25% | 0.04-0.25 | 0.6-14 | 1.0-6 |
| F1B5D | FC1B5 | >25% | 0.04-0.25 | 0.6-14 | 1.0-6 |
| F1C5D | FC1C5 | >25% | 0.04-0.25 | 0.6-14 | 1.0-6 |
| F1D5D | FC1D5 | >25% | 0.04-0.25 | 0.6-14 | 1.0-6 |
| F1E5D | FC1E5 | >25% | 0.04-0.25 | 0.6-14 | 1.0-6 |
| F1A6D | FC1A6 | >25% | 0.04-0.25 | 0.6-14 | 1.0-6 |
| F1B6D | FC1B6 | >25% | 0.04-0.25 | 0.6-14 | 1.0-6 |
| F1C6D | FC1C6 | >25% | 0.04-0.25 | 0.6-14 | 1.0-6 |
| F1D6D | FC1D6 | >25% | 0.04-0.25 | 0.6-14 | 1.0-6 |
| F1E6D | FC1E6 | >25% | 0.04-0.25 | 0.6-14 | 1.0-6 |
| F2A1D | FC2A1 | >25% | 0.04-0.25 | 0.6-14 | 1.0-6 |
| F2B1D | FC2B1 | >25% | 0.04-0.25 | 0.6-14 | 1.0-6 |
| F2C1D | FC2C1 | >25% | 0.04-0.25 | 0.6-14 | 1.0-6 |
| F2D1D | FC2D1 | >25% | 0.04-0.25 | 0.6-14 | 1.0-6 |
| F2E1D | FC2E1 | >25% | 0.04-0.25 | 0.6-14 | 1.0-6 |
| F2A2D | FC2A2 | >25% | 0.04-0.25 | 0.6-14 | 1.0-6 |
| F2B2D | FC2B2 | >25% | 0.04-0.25 | 0.6-14 | 1.0-6 |
| F2C2D | FC2C2 | >25% | 0.04-0.25 | 0.6-14 | 1.0-6 |
| F2D2D | FC2D2 | >25% | 0.04-0.25 | 0.6-14 | 1.0-6 |
| F2E2D | FC2E2 | >25% | 0.04-0.25 | 0.6-14 | 1.0-6 |
| F2A3D | FC2A3 | >25% | 0.04-0.25 | 0.6-14 | 1.0-6 |
| F2B3D | FC2B3 | >25% | 0.04-0.25 | 0.6-14 | 1.0-6 |
| F2C3D | FC2C3 | >25% | 0.04-0.25 | 0.6-14 | 1.0-6 |
| F2D3D | FC2D3 | >25% | 0.04-0.25 | 0.6-14 | 1.0-6 |
| F2E3D | FC2E3 | >25% | 0.04-0.25 | 0.6-14 | 1.0-6 |
| F2A4D | FC2A4 | >25% | 0.04-0.25 | 0.6-14 | 1.0-6 |
| F2B4D | FC2B4 | >25% | 0.04-0.25 | 0.6-14 | 1.0-6 |
| F2C4D | FC2C4 | >25% | 0.04-0.25 | 0.6-14 | 1.0-6 |
| F2D4D | FC2D4 | >25% | 0.04-0.25 | 0.6-14 | 1.0-6 |
| F2E4D | FC2E4 | >25% | 0.04-0.25 | 0.6-14 | 1.0-6 |
| F2A5D | FC2A5 | >25% | 0.04-0.25 | 0.6-14 | 1.0-6 |
| F2B5D | FC2B5 | >25% | 0.04-0.25 | 0.6-14 | 1.0-6 |
| F2C5D | FC2C5 | >25% | 0.04-0.25 | 0.6-14 | 1.0-6 |
| F2D5D | FC2D5 | >25% | 0.04-0.25 | 0.6-14 | 1.0-6 |
| F2E5D | FC2E5 | >25% | 0.04-0.25 | 0.6-14 | 1.0-6 |
| F2A6D | FC2A6 | >25% | 0.04-0.25 | 0.6-14 | 1.0-6 |
| F2B6D | FC2B6 | >25% | 0.04-0.25 | 0.6-14 | 1.0-6 |
| F2C6D | FC2C6 | >25% | 0.04-0.25 | 0.6-14 | 1.0-6 |
| F2D6D | FC2D6 | >25% | 0.04-0.25 | 0.6-14 | 1.0-6 |
| F2E6D | FC2E6 | >25% | 0.04-0.25 | 0.6-14 | 1.0-6 |
| F3A1D | FC3A1 | >25% | 0.04-0.25 | 0.6-14 | 1.0-6 |
| F3B1D | FC3B1 | >25% | 0.04-0.25 | 0.6-14 | 1.0-6 |
| F3C1D | FC3C1 | >25% | 0.04-0.25 | 0.6-14 | 1.0-6 |
| F3D1D | FC3D1 | >25% | 0.04-0.25 | 0.6-14 | 1.0-6 |
| F3E1D | FC3E1 | >25% | 0.04-0.25 | 0.6-14 | 1.0-6 |
| F3A2D | FC3A2 | >25% | 0.04-0.25 | 0.6-14 | 1.0-6 |
| F3B2D | FC3B2 | >25% | 0.04-0.25 | 0.6-14 | 1.0-6 |
| F3C2D | FC3C2 | >25% | 0.04-0.25 | 0.6-14 | 1.0-6 |
| F3D2D | FC3D2 | >25% | 0.04-0.25 | 0.6-14 | 1.0-6 |
| F3E2D | FC3E2 | >25% | 0.04-0.25 | 0.6-14 | 1.0-6 |
| F3A3D | FC3A3 | >25% | 0.04-0.25 | 0.6-14 | 1.0-6 |
| F3B3D | FC3B3 | >25% | 0.04-0.25 | 0.6-14 | 1.0-6 |
| F3C3D | FC3C3 | >25% | 0.04-0.25 | 0.6-14 | 1.0-6 |
| F3D3D | FC3D3 | >25% | 0.04-0.25 | 0.6-14 | 1.0-6 |
| F3E3D | FC3E3 | >25% | 0.04-0.25 | 0.6-14 | 1.0-6 |
| F3A4D | FC3A4 | >25% | 0.04-0.25 | 0.6-14 | 1.0-6 |
| F3B4D | FC3B4 | >25% | 0.04-0.25 | 0.6-14 | 1.0-6 |
| F3C4D | FC3C4 | >25% | 0.04-0.25 | 0.6-14 | 1.0-6 |
| F3D4D | FC3D4 | >25% | 0.04-0.25 | 0.6-14 | 1.0-6 |
| F3E4D | FC3E4 | >25% | 0.04-0.25 | 0.6-14 | 1.0-6 |
| F3A5D | FC3A5 | >25% | 0.04-0.25 | 0.6-14 | 1.0-6 |
| F3B5D | FC3B5 | >25% | 0.04-0.25 | 0.6-14 | 1.0-6 |
| F3C5D | FC3C5 | >25% | 0.04-0.25 | 0.6-14 | 1.0-6 |
| F3D5D | FC3D5 | >25% | 0.04-0.25 | 0.6-14 | 1.0-6 |
| F3E5D | FC3E5 | >25% | 0.04-0.25 | 0.6-14 | 1.0-6 |
| F3A6D | FC3A6 | >25% | 0.04-0.25 | 0.6-14 | 1.0-6 |
| F3B6D | FC3B6 | >25% | 0.04-0.25 | 0.6-14 | 1.0-6 |
| F3C6D | FC3C6 | >25% | 0.04-0.25 | 0.6-14 | 1.0-6 |
| F3D6D | FC3D6 | >25% | 0.04-0.25 | 0.6-14 | 1.0-6 |
| F3E6D | FC3E6 | >25% | 0.04-0.25 | 0.6-14 | 1.0-6 |
| F4A1D | FC4A1 | >25% | 0.04-0.25 | 0.6-14 | 1.0-6 |
| F4B1D | FC4B1 | >25% | 0.04-0.25 | 0.6-14 | 1.0-6 |
| F4C1D | FC4C1 | >25% | 0.04-0.25 | 0.6-14 | 1.0-6 |
| F4D1D | FC4D1 | >25% | 0.04-0.25 | 0.6-14 | 1.0-6 |
| F4E1D | FC4E1 | >25% | 0.04-0.25 | 0.6-14 | 1.0-6 |
| F4A2D | FC4A2 | >25% | 0.04-0.25 | 0.6-14 | 1.0-6 |
| F4B2D | FC4B2 | >25% | 0.04-0.25 | 0.6-14 | 1.0-6 |
| F4C2D | FC4C2 | >25% | 0.04-0.25 | 0.6-14 | 1.0-6 |
| F4D2D | FC4D2 | >25% | 0.04-0.25 | 0.6-14 | 1.0-6 |
| F4E2D | FC4E2 | >25% | 0.04-0.25 | 0.6-14 | 1.0-6 |
| F4A3D | FC4A3 | >25% | 0.04-0.25 | 0.6-14 | 1.0-6 |
| F4B3D | FC4B3 | >25% | 0.04-0.25 | 0.6-14 | 1.0-6 |
| FC4C3D | FC4C3 | >25% | 0.04-0.25 | 0.6-14 | 1.0-6 |
| F4D3D | FC4D3 | >25% | 0.04-0.25 | 0.6-14 | 1.0-6 |
| F4E3D | FC4E3 | >25% | 0.04-0.25 | 0.6-14 | 1.0-6 |
| F4A4D | FC4A4 | >25% | 0.04-0.25 | 0.6-14 | 1.0-6 |
| F4B4D | FC4B4 | >25% | 0.04-0.25 | 0.6-14 | 1.0-6 |
| F4C4D | FC4C4 | >25% | 0.04-0.25 | 0.6-14 | 1.0-6 |
| F4D4D | FC4D4 | >25% | 0.04-0.25 | 0.6-14 | 1.0-6 |
| F4E4D | FC4E4 | >25% | 0.04-0.25 | 0.6-14 | 1.0-6 |
| F4A5D | FC4A5 | >25% | 0.04-0.25 | 0.6-14 | 1.0-6 |
| F4B5D | FC4B5 | >25% | 0.04-0.25 | 0.6-14 | 1.0-6 |
| F4C5D | FC4C5 | >25% | 0.04-0.25 | 0.6-14 | 1.0-6 |
| F4D5D | FC4D5 | >25% | 0.04-0.25 | 0.6-14 | 1.0-6 |
| F4E5D | FC4E5 | >25% | 0.04-0.25 | 0.6-14 | 1.0-6 |
| F4A6D | FC4A6 | >25% | 0.04-0.25 | 0.6-14 | 1.0-6 |
| F4B6D | FC4B6 | >25% | 0.04-0.25 | 0.6-14 | 1.0-6 |
| F4C6D | FC4C6 | >25% | 0.04-0.25 | 0.6-14 | 1.0-6 |
| F4D6D | FC4D6 | >25% | 0.04-0.25 | 0.6-14 | 1.0-6 |
| F4E6D | FC4E6 | >25% | 0.04-0.25 | 0.6-14 | 1.0-6 |
| F5A1D | FC5A1 | >25% | 0.04-0.25 | 0.6-14 | 1.0-6 |
| F5B1D | FC5B1 | >25% | 0.04-0.25 | 0.6-14 | 1.0-6 |
| F5C1D | FC5C1 | >25% | 0.04-0.25 | 0.6-14 | 1.0-6 |
| F5D1D | FC5D1 | >25% | 0.04-0.25 | 0.6-14 | 1.0-6 |
| F5E1D | FC5E1 | >25% | 0.04-0.25 | 0.6-14 | 1.0-6 |
| F5A2D | FC5A2 | >25% | 0.04-0.25 | 0.6-14 | 1.0-6 |
| F5B2D | FC5B2 | >25% | 0.04-0.25 | 0.6-14 | 1.0-6 |
| F5C2D | FC5C2 | >25% | 0.04-0.25 | 0.6-14 | 1.0-6 |
| F5D2D | FC5D2 | >25% | 0.04-0.25 | 0.6-14 | 1.0-6 |
| F5E2D | FC5E2 | >25% | 0.04-0.25 | 0.6-14 | 1.0-6 |
| F5A3D | FC5A3 | >25% | 0.04-0.25 | 0.6-14 | 1.0-6 |
| F5B3D | FC5B3 | >25% | 0.04-0.25 | 0.6-14 | 1.0-6 |
| F5C3D | FC5C3 | >25% | 0.04-0.25 | 0.6-14 | 1.0-6 |
| F5D3D | FC5D3 | >25% | 0.04-0.25 | 0.6-14 | 1.0-6 |
| F5E3D | FC5E3 | >25% | 0.04-0.25 | 0.6-14 | 1.0-6 |
| F5A4D | FC5A4 | >25% | 0.04-0.25 | 0.6-14 | 1.0-6 |
| F5B4D | FC5B4 | >25% | 0.04-0.25 | 0.6-14 | 1.0-6 |
| F5C4D | FC5C4 | >25% | 0.04-0.25 | 0.6-14 | 1.0-6 |
| F5D4D | FC5D4 | >25% | 0.04-0.25 | 0.6-14 | 1.0-6 |
| F5E4D | FC5E4 | >25% | 0.04-0.25 | 0.6-14 | 1.0-6 |
| F5A5D | FC5A5 | >25% | 0.04-0.25 | 0.6-14 | 1.0-6 |
| F5B5D | FC5B5 | >25% | 0.04-0.25 | 0.6-14 | 1.0-6 |
| F5C5D | FC5C5 | >25% | 0.04-0.25 | 0.6-14 | 1.0-6 |
| F5D5D | FC5D5 | >25% | 0.04-0.25 | 0.6-14 | 1.0-6 |
| F5E5D | FC5E5 | >25% | 0.04-0.25 | 0.6-14 | 1.0-6 |
| F5A6D | FC5A6 | >25% | 0.04-0.25 | 0.6-14 | 1.0-6 |
| F5B6D | FC5B6 | >25% | 0.04-0.25 | 0.6-14 | 1.0-6 |
| F5C6D | FC5C6 | >25% | 0.04-0.25 | 0.6-14 | 1.0-6 |
| F5D6D | FC5D6 | >25% | 0.04-0.25 | 0.6-14 | 1.0-6 |
| F5E6D | FC5E6 | >25% | 0.04-0.25 | 0.6-14 | 1.0-6 |
| F6A1D | FC6A1 | >25% | 0.04-0.25 | 0.6-14 | 1.0-6 |
| F6B1D | FC6B1 | >25% | 0.04-0.25 | 0.6-14 | 1.0-6 |
| F6C1D | FC6C1 | >25% | 0.04-0.25 | 0.6-14 | 1.0-6 |
| F6D1D | FC6D1 | >25% | 0.04-0.25 | 0.6-14 | 1.0-6 |
| F6E1D | FC6E1 | >25% | 0.04-0.25 | 0.6-14 | 1.0-6 |
| F6A2D | FC6A2 | >25% | 0.04-0.25 | 0.6-14 | 1.0-6 |
| F6B2D | FC6B2 | >25% | 0.04-0.25 | 0.6-14 | 1.0-6 |
| F6C2D | FC6C2 | >25% | 0.04-0.25 | 0.6-14 | 1.0-6 |
| F6D2D | FC6D2 | >25% | 0.04-0.25 | 0.6-14 | 1.0-6 |
| F6E2D | FC6E2 | >25% | 0.04-0.25 | 0.6-14 | 1.0-6 |
| F6A3D | FC6A3 | >25% | 0.04-0.25 | 0.6-14 | 1.0-6 |
| F6B3D | FC6B3 | >25% | 0.04-0.25 | 0.6-14 | 1.0-6 |
| F6C3D | FC6C3 | >25% | 0.04-0.25 | 0.6-14 | 1.0-6 |
| F6D3D | FC6D3 | >25% | 0.04-0.25 | 0.6-14 | 1.0-6 |
| F6E3D | FC6E3 | >25% | 0.04-0.25 | 0.6-14 | 1.0-6 |
| F6B4D | FC6B4 | >25% | 0.04-0.25 | 0.6-14 | 1.0-6 |
| F6C4D | FC6C4 | >25% | 0.04-0.25 | 0.6-14 | 1.0-6 |
| F6D4D | FC6D4 | >25% | 0.04-0.25 | 0.6-14 | 1.0-6 |
| F6E4D | FC6E4 | >25% | 0.04-0.25 | 0.6-14 | 1.0-6 |
| F6A5D | FC6A5 | >25% | 0.04-0.25 | 0.6-14 | 1.0-6 |
| F6B5D | FC6B5 | >25% | 0.04-0.25 | 0.6-14 | 1.0-6 |
| F6C5D | FC6C5 | >25% | 0.04-0.25 | 0.6-14 | 1.0-6 |
| F6D5D | FC6D5 | >25% | 0.04-0.25 | 0.6-14 | 1.0-6 |
| F6E5D | FC6E5 | >25% | 0.04-0.25 | 0.6-14 | 1.0-6 |
| F6A6D | FC6A6 | >25% | 0.04-0.25 | 0.6-14 | 1.0-6 |
| F6B6D | FC6B6 | >25% | 0.04-0.25 | 0.6-14 | 1.0-6 |
| F6C6D | FC6C6 | >25% | 0.04-0.25 | 0.6-14 | 1.0-6 |
| F6D6D | FC6D6 | >25% | 0.04-0.25 | 0.6-14 | 1.0-6 |
| F6E6D | FC6E6 | >25% | 0.04-0.25 | 0.6-14 | 1.0-6 |
| F7A1D | FC7A1 | >25% | 0.04-0.25 | 0.6-14 | 1.0-6 |
| F7B1D | FC7B1 | >25% | 0.04-0.25 | 0.6-14 | 1.0-6 |
| F7C1D | FC7C1 | >25% | 0.04-0.25 | 0.6-14 | 1.0-6 |
| F7D1D | FC7D1 | >25% | 0.04-0.25 | 0.6-14 | 1.0-6 |
| F7E1D | FC7E1 | >25% | 0.04-0.25 | 0.6-14 | 1.0-6 |
| F7A2D | FC7A2 | >25% | 0.04-0.25 | 0.6-14 | 1.0-6 |
| F7B2D | FC7B2 | >25% | 0.04-0.25 | 0.6-14 | 1.0-6 |
| F7C2D | FC7C2 | >25% | 0.04-0.25 | 0.6-14 | 1.0-6 |
| F7D2D | FC7D2 | >25% | 0.04-0.25 | 0.6-14 | 1.0-6 |
| F7E2D | FC7E2 | >25% | 0.04-0.25 | 0.6-14 | 1.0-6 |
| F7A3D | FC7A3 | >25% | 0.04-0.25 | 0.6-14 | 1.0-6 |
| F7B3D | FC7B3 | >25% | 0.04-0.25 | 0.6-14 | 1.0-6 |
| F7C3D | FC7C3 | >25% | 0.04-0.25 | 0.6-14 | 1.0-6 |
| F7D3D | FC7D3 | >25% | 0.04-0.25 | 0.6-14 | 1.0-6 |
| F7E3D | FC7E3 | >25% | 0.04-0.25 | 0.6-14 | 1.0-6 |
| F7A4D | FC7A4 | >25% | 0.04-0.25 | 0.6-14 | 1.0-6 |
| F7B4D | FC7B4 | >25% | 0.04-0.25 | 0.6-14 | 1.0-6 |
| F7C4D | FC7C4 | >25% | 0.04-0.25 | 0.6-14 | 1.0-6 |
| F7D4D | FC7D4 | >25% | 0.04-0.25 | 0.6-14 | 1.0-6 |
| F7E4D | FC7E4 | >25% | 0.04-0.25 | 0.6-14 | 1.0-6 |
| F7A5D | FC7A5 | >25% | 0.04-0.25 | 0.6-14 | 1.0-6 |
| F7B5D | FC7B5 | >25% | 0.04-0.25 | 0.6-14 | 1.0-6 |
| F7C5D | FC7C5 | >25% | 0.04-0.25 | 0.6-14 | 1.0-6 |
| F7D5D | FC7D5 | >25% | 0.04-0.25 | 0.6-14 | 1.0-6 |
| F7E5D | FC7E5 | >25% | 0.04-0.25 | 0.6-14 | 1.0-6 |
| F7A6D | FC7A6 | >25% | 0.04-0.25 | 0.6-14 | 1.0-6 |
| F7B6D | FC7B6 | >25% | 0.04-0.25 | 0.6-14 | 1.0-6 |
| F7C6D | FC7C6 | >25% | 0.04-0.25 | 0.6-14 | 1.0-6 |
| F7D6D | FC7D6 | >25% | 0.04-0.25 | 0.6-14 | 1.0-6 |
| F7E6D | FC7E6 | >25% | 0.04-0.25 | 0.6-14 | 1.0-6 |
| F8A1D | FC8A1 | >25% | 0.04-0.25 | 0.6-14 | 1.0-6 |
| F8B1D | FC8B1 | >25% | 0.04-0.25 | 0.6-14 | 1.0-6 |
| F8C1D | FC8C1 | >25% | 0.04-0.25 | 0.6-14 | 1.0-6 |
| F8D1B | FC8D1 | >25% | 0.04-0.25 | 0.6-14 | 1.0-6 |
| F8E1D | FC8E1 | >25% | 0.04-0.25 | 0.6-14 | 1.0-6 |
| F8A2B | FC8A2 | >25% | 0.04-0.25 | 0.6-14 | 1.0-6 |
| F8B2D | FC8B2 | >25% | 0.04-0.25 | 0.6-14 | 1.0-6 |
| F8C2D | FC8C2 | >25% | 0.04-0.25 | 0.6-14 | 1.0-6 |
| F8D2D | FC8D2 | >25% | 0.04-0.25 | 0.6-14 | 1.0-6 |
| F8E2D | FC8E2 | >25% | 0.04-0.25 | 0.6-14 | 1.0-6 |
| F8A3D | FC8A3 | >25% | 0.04-0.25 | 0.6-14 | 1.0-6 |
| F8B3D | FC8B3 | >25% | 0.04-0.25 | 0.6-14 | 1.0-6 |
| F8C3D | FC8C3 | >25% | 0.04-0.25 | 0.6-14 | 1.0-6 |
| F8D3D | FC8D3 | >25% | 0.04-0.25 | 0.6-14 | 1.0-6 |
| F8E3D | FC8E3 | >25% | 0.04-0.25 | 0.6-14 | 1.0-6 |
| F8A4D | FC8A4 | >25% | 0.04-0.25 | 0.6-14 | 1.0-6 |
| F8B4D | FC8B4 | >25% | 0.04-0.25 | 0.6-14 | 1.0-6 |
| F8C4D | FC8C4 | >25% | 0.04-0.25 | 0.6-14 | 1.0-6 |
| F8D4D | FC8D4 | >25% | 0.04-0.25 | 0.6-14 | 1.0-6 |
| F8E4D | FC8E4 | >25% | 0.04-0.25 | 0.6-14 | 1.0-6 |
| F8A5D | FC8A5 | >25% | 0.04-0.25 | 0.6-14 | 1.0-6 |
| F8B5D | FC8B5 | >25% | 0.04-0.25 | 0.6-14 | 1.0-6 |
| F8C5D | FC8C5 | >25% | 0.04-0.25 | 0.6-14 | 1.0-6 |
| F8D5D | FC8D5 | >25% | 0.04-0.25 | 0.6-14 | 1.0-6 |
| F8E5D | FC8E5 | >25% | 0.04-0.25 | 0.6-14 | 1.0-6 |
| F8A6D | FC8A6 | >25% | 0.04-0.25 | 0.6-14 | 1.0-6 |
| F8B6D | FC8B6 | >25% | 0.04-0.25 | 0.6-14 | 1.0-6 |
| F8C6D | FC8C6 | >25% | 0.04-0.25 | 0.6-14 | 1.0-6 |
| F8D6D | FC8D6 | >25% | 0.04-0.25 | 0.6-14 | 1.0-6 |
| F8E6D | FC8E6 | >25% | 0.04-0.25 | 0.6-14 | 1.0-6 |
| F1A1E | FC1A1 | >25% | 0.04-0.25 | 0.6-14 | 1.0-6 |
| F1B1E | FC1B1 | >25% | 0.04-0.25 | 0.6-14 | 1.0-6 |
| F1C1E | FC1C1 | >25% | 0.04-0.25 | 0.6-14 | 1.0-6 |
| F1D1E | FC1D1 | >25% | 0.04-0.25 | 0.6-14 | 1.0-6 |
| F1E1E | FC1E1 | >25% | 0.04-0.25 | 0.6-14 | 1.0-6 |
| F1A2E | FC1A2 | >25% | 0.04-0.25 | 0.6-14 | 1.0-6 |
| F1B2E | FC1B2 | >25% | 0.04-0.25 | 0.6-14 | 1.0-6 |
| F1C2E | FC1C2 | >25% | 0.04-0.25 | 0.6-14 | 1.0-6 |
| F1D2E | FC1D2 | >25% | 0.04-0.25 | 0.6-14 | 1.0-6 |
| F1E2E | FC1E2 | >25% | 0.04-0.25 | 0.6-14 | 1.0-6 |
| F1A3E | FC1A3 | >25% | 0.04-0.25 | 0.6-14 | 1.0-6 |
| F1B3E | FC1B3 | >25% | 0.04-0.25 | 0.6-14 | 1.0-6 |
| F1C3E | FC1C3 | >25% | 0.04-0.25 | 0.6-14 | 1.0-6 |
| F1D3E | FC1D3 | >25% | 0.04-0.25 | 0.6-14 | 1.0-6 |
| F1E3E | FC1E3 | >25% | 0.04-0.25 | 0.6-14 | 1.0-6 |
| F1A4E | FC1A4 | >25% | 0.04-0.25 | 0.6-14 | 1.0-6 |
| F1B4E | FC1B4 | >25% | 0.04-0.25 | 0.6-14 | 1.0-6 |
| F1C4E | FC1C4 | >25% | 0.04-0.25 | 0.6-14 | 1.0-6 |
| F1D4E | FC1D4 | >25% | 0.04-0.25 | 0.6-14 | 1.0-6 |
| F1E4E | FC1E4 | >25% | 0.04-0.25 | 0.6-14 | 1.0-6 |
| F1A5E | FC1A5 | >25% | 0.04-0.25 | 0.6-14 | 1.0-6 |
| F1B5E | FC1B5 | >25% | 0.04-0.25 | 0.6-14 | 1.0-6 |
| F1C5E | FC1C5 | >25% | 0.04-0.25 | 0.6-14 | 1.0-6 |
| F1D5E | FC1D5 | >25% | 0.04-0.25 | 0.6-14 | 1.0-6 |
| F1E5E | FC1E5 | >25% | 0.04-0.25 | 0.6-14 | 1.0-6 |
| F1A6E | FC1A6 | >25% | 0.04-0.25 | 0.6-14 | 1.0-6 |
| F1B6E | FC1B6 | >25% | 0.04-0.25 | 0.6-14 | 1.0-6 |
| F1C6E | FC1C6 | >25% | 0.04-0.25 | 0.6-14 | 1.0-6 |
| F1D6E | FC1D6 | >25% | 0.04-0.25 | 0.6-14 | 1.0-6 |
| F1E6E | FC1E6 | >25% | 0.04-0.25 | 0.6-14 | 1.0-6 |
| F2A1E | FC2A1 | >25% | 0.04-0.25 | 0.6-14 | 1.0-6 |
| F2B1E | FC2B1 | >25% | 0.04-0.25 | 0.6-14 | 1.0-6 |
| F2C1E | FC2C1 | >25% | 0.04-0.25 | 0.6-14 | 1.0-6 |
| F2D1E | FC2D1 | >25% | 0.04-0.25 | 0.6-14 | 1.0-6 |
| F2E1E | FC2E1 | >25% | 0.04-0.25 | 0.6-14 | 1.0-6 |
| F2A2E | FC2A2 | >25% | 0.04-0.25 | 0.6-14 | 1.0-6 |
| F2B2E | FC2B2 | >25% | 0.04-0.25 | 0.6-14 | 1.0-6 |
| F2C2E | FC2C2 | >25% | 0.04-0.25 | 0.6-14 | 1.0-6 |
| F2D2E | FC2D2 | >25% | 0.04-0.25 | 0.6-14 | 1.0-6 |
| F2E2E | FC2E2 | >25% | 0.04-0.25 | 0.6-14 | 1.0-6 |
| F2A3E | FC2A3 | >25% | 0.04-0.25 | 0.6-14 | 1.0-6 |
| F2B3E | FC2B3 | >25% | 0.04-0.25 | 0.6-14 | 1.0-6 |
| F2C3E | FC2C3 | >25% | 0.04-0.25 | 0.6-14 | 1.0-6 |
| F2D3E | FC2D3 | >25% | 0.04-0.25 | 0.6-14 | 1.0-6 |
| F2E3E | FC2E3 | >25% | 0.04-0.25 | 0.6-14 | 1.0-6 |
| F2A4E | FC2A4 | >25% | 0.04-0.25 | 0.6-14 | 1.0-6 |
| F2B4E | FC2B4 | >25% | 0.04-0.25 | 0.6-14 | 1.0-6 |
| F2C4E | FC2C4 | >25% | 0.04-0.25 | 0.6-14 | 1.0-6 |
| F2D4E | FC2D4 | >25% | 0.04-0.25 | 0.6-14 | 1.0-6 |
| F2E4E | FC2E4 | >25% | 0.04-0.25 | 0.6-14 | 1.0-6 |
| F2A5E | FC2A5 | >25% | 0.04-0.25 | 0.6-14 | 1.0-6 |
| F2B5E | FC2B5 | >25% | 0.04-0.25 | 0.6-14 | 1.0-6 |
| F2C5E | FC2C5 | >25% | 0.04-0.25 | 0.6-14 | 1.0-6 |
| F2D5E | FC2D5 | >25% | 0.04-0.25 | 0.6-14 | 1.0-6 |
| F2E5E | FC2E5 | >25% | 0.04-0.25 | 0.6-14 | 1.0-6 |
| F2A6E | FC2A6 | >25% | 0.04-0.25 | 0.6-14 | 1.0-6 |
| F2B6E | FC2B6 | >25% | 0.04-0.25 | 0.6-14 | 1.0-6 |
| F2C6E | FC2C6 | >25% | 0.04-0.25 | 0.6-14 | 1.0-6 |
| F2D6E | FC2D6 | >25% | 0.04-0.25 | 0.6-14 | 1.0-6 |
| F2E6E | FC2E6 | >25% | 0.04-0.25 | 0.6-14 | 1.0-6 |
| F3A1E | FC3A1 | >25% | 0.04-0.25 | 0.6-14 | 1.0-6 |
| F3B1E | FC3B1 | >25% | 0.04-0.25 | 0.6-14 | 1.0-6 |
| F3C1E | FC3C1 | >25% | 0.04-0.25 | 0.6-14 | 1.0-6 |
| F3D1E | FC3D1 | >25% | 0.04-0.25 | 0.6-14 | 1.0-6 |
| F3E1E | FC3E1 | >25% | 0.04-0.25 | 0.6-14 | 1.0-6 |
| F3A2E | FC3A2 | >25% | 0.04-0.25 | 0.6-14 | 1.0-6 |
| F3B2E | FC3B2 | >25% | 0.04-0.25 | 0.6-14 | 1.0-6 |
| F3C2E | FC3C2 | >25% | 0.04-0.25 | 0.6-14 | 1.0-6 |
| F3D2E | FC3D2 | >25% | 0.04-0.25 | 0.6-14 | 1.0-6 |
| F3E2E | FC3E2 | >25% | 0.04-0.25 | 0.6-14 | 1.0-6 |
| F3A3E | FC3A3 | >25% | 0.04-0.25 | 0.6-14 | 1.0-6 |
| F3B3E | FC3B3 | >25% | 0.04-0.25 | 0.6-14 | 1.0-6 |
| F3C3E | FC3C3 | >25% | 0.04-0.25 | 0.6-14 | 1.0-6 |
| F3D3E | FC3D3 | >25% | 0.04-0.25 | 0.6-14 | 1.0-6 |
| F3E3E | FC3E3 | >25% | 0.04-0.25 | 0.6-14 | 1.0-6 |
| F3A4E | FC3A4 | >25% | 0.04-0.25 | 0.6-14 | 1.0-6 |
| F3B4E | FC3B4 | >25% | 0.04-0.25 | 0.6-14 | 1.0-6 |
| F3C4E | FC3C4 | >25% | 0.04-0.25 | 0.6-14 | 1.0-6 |
| F3D4E | FC3D4 | >25% | 0.04-0.25 | 0.6-14 | 1.0-6 |
| F3E4E | FC3E4 | >25% | 0.04-0.25 | 0.6-14 | 1.0-6 |
| F3A5E | FC3A5 | >25% | 0.04-0.25 | 0.6-14 | 1.0-6 |
| F3B5E | FC3B5 | >25% | 0.04-0.25 | 0.6-14 | 1.0-6 |
| F3C5E | FC3C5 | >25% | 0.04-0.25 | 0.6-14 | 1.0-6 |
| F3D5E | FC3D5 | >25% | 0.04-0.25 | 0.6-14 | 1.0-6 |
| F3E5E | FC3E5 | >25% | 0.04-0.25 | 0.6-14 | 1.0-6 |
| F3A6E | FC3A6 | >25% | 0.04-0.25 | 0.6-14 | 1.0-6 |
| F3B6E | FC3B6 | >25% | 0.04-0.25 | 0.6-14 | 1.0-6 |
| F3C6E | FC3C6 | >25% | 0.04-0.25 | 0.6-14 | 1.0-6 |
| F3D6E | FC3D6 | >25% | 0.04-0.25 | 0.6-14 | 1.0-6 |
| F3E6E | FC3E6 | >25% | 0.04-0.25 | 0.6-14 | 1.0-6 |
| F4A1E | FC4A1 | >25% | 0.04-0.25 | 0.6-14 | 1.0-6 |
| F4B1E | FC4B1 | >25% | 0.04-0.25 | 0.6-14 | 1.0-6 |
| F4C1E | FC4C1 | >25% | 0.04-0.25 | 0.6-14 | 1.0-6 |
| F4D1E | FC4D1 | >25% | 0.04-0.25 | 0.6-14 | 1.0-6 |
| F4E1E | FC4E1 | >25% | 0.04-0.25 | 0.6-14 | 1.0-6 |
| F4A2E | FC4A2 | >25% | 0.04-0.25 | 0.6-14 | 1.0-6 |
| F4B2E | FC4B2 | >25% | 0.04-0.25 | 0.6-14 | 1.0-6 |
| F4C2E | FC4C2 | >25% | 0.04-0.25 | 0.6-14 | 1.0-6 |
| F4D2E | FC4D2 | >25% | 0.04-0.25 | 0.6-14 | 1.0-6 |
| F4E2E | FC4E2 | >25% | 0.04-0.25 | 0.6-14 | 1.0-6 |
| F4A3E | FC4A3 | >25% | 0.04-0.25 | 0.6-14 | 1.0-6 |
| F4B3E | FC4B3 | >25% | 0.04-0.25 | 0.6-14 | 1.0-6 |
| F4C3E | FC4C3 | >25% | 0.04-0.25 | 0.6-14 | 1.0-6 |
| F4D3E | FC4D3 | >25% | 0.04-0.25 | 0.6-14 | 1.0-6 |
| F4E3E | FC4E3 | >25% | 0.04-0.25 | 0.6-14 | 1.0-6 |
| F4A4E | FC4A4 | >25% | 0.04-0.25 | 0.6-14 | 1.0-6 |
| F4B4E | FC4B4 | >25% | 0.04-0.25 | 0.6-14 | 1.0-6 |
| F4C4E | FC4C4 | >25% | 0.04-0.25 | 0.6-14 | 1.0-6 |
| F4D4E | FC4D4 | >25% | 0.04-0.25 | 0.6-14 | 1.0-6 |
| F4E4E | FC4E4 | >25% | 0.04-0.25 | 0.6-14 | 1.0-6 |
| F4A5E | FC4A5 | >25% | 0.04-0.25 | 0.6-14 | 1.0-6 |
| F4B5E | FC4B5 | >25% | 0.04-0.25 | 0.6-14 | 1.0-6 |
| F4C5E | FC4C5 | >25% | 0.04-0.25 | 0.6-14 | 1.0-6 |
| F4D5E | FC4D5 | >25% | 0.04-0.25 | 0.6-14 | 1.0-6 |
| F4E5E | FC4E5 | >25% | 0.04-0.25 | 0.6-14 | 1.0-6 |
| F4A6E | FC4A6 | >25% | 0.04-0.25 | 0.6-14 | 1.0-6 |
| F4B6E | FC4B6 | >25% | 0.04-0.25 | 0.6-14 | 1.0-6 |
| F4C6E | FC4C6 | >25% | 0.04-0.25 | 0.6-14 | 1.0-6 |
| F4D6E | FC4D6 | >25% | 0.04-0.25 | 0.6-14 | 1.0-6 |
| F4E6E | FC4E6 | >25% | 0.04-0.25 | 0.6-14 | 1.0-6 |
| F5A1E | FC5A1 | >25% | 0.04-0.25 | 0.6-14 | 1.0-6 |
| F5B1E | FC5B1 | >25% | 0.04-0.25 | 0.6-14 | 1.0-6 |
| F5C1E | FC5C1 | >25% | 0.04-0.25 | 0.6-14 | 1.0-6 |
| F5D1E | FC5D1 | >25% | 0.04-0.25 | 0.6-14 | 1.0-6 |
| F5E1E | FC5E1 | >25% | 0.04-0.25 | 0.6-14 | 1.0-6 |
| F5A2E | FC5A2 | >25% | 0.04-0.25 | 0.6-14 | 1.0-6 |
| F5B2E | FC5B2 | >25% | 0.04-0.25 | 0.6-14 | 1.0-6 |
| F5C2E | FC5C2 | >25% | 0.04-0.25 | 0.6-14 | 1.0-6 |
| F5D2E | FC5D2 | >25% | 0.04-0.25 | 0.6-14 | 1.0-6 |
| F5E2E | FC5E2 | >25% | 0.04-0.25 | 0.6-14 | 1.0-6 |
| F5A3E | FC5A3 | >25% | 0.04-0.25 | 0.6-14 | 1.0-6 |
| F5B3E | FC5B3 | >25% | 0.04-0.25 | 0.6-14 | 1.0-6 |
| F5C3E | FC5C3 | >25% | 0.04-0.25 | 0.6-14 | 1.0-6 |
| F5D3E | FC5D3 | >25% | 0.04-0.25 | 0.6-14 | 1.0-6 |
| F5E3E | FC5E3 | >25% | 0.04-0.25 | 0.6-14 | 1.0-6 |
| F5A4E | FC5A4 | >25% | 0.04-0.25 | 0.6-14 | 1.0-6 |
| F5B4E | FC5B4 | >25% | 0.04-0.25 | 0.6-14 | 1.0-6 |
| F5C4E | FC5C4 | >25% | 0.04-0.25 | 0.6-14 | 1.0-6 |
| F5D4E | FC5D4 | >25% | 0.04-0.25 | 0.6-14 | 1.0-6 |
| F5E4E | FC5E4 | >25% | 0.04-0.25 | 0.6-14 | 1.0-6 |
| F5A5E | FC5A5 | >25% | 0.04-0.25 | 0.6-14 | 1.0-6 |
| F5B5B | FC5E5 | >25% | 0.04-0.25 | 0.6-14 | 1.0-6 |
| F5C5E | FC5C5 | >25% | 0.04-0.25 | 0.6-14 | 1.0-6 |
| F5D5E | FC5D5 | >25% | 0.04-0.25 | 0.6-14 | 1.0-6 |
| F5E5E | FC5E5 | >25% | 0.04-0.25 | 0.6-14 | 1.0-6 |
| F5A6E | FC5A6 | >25% | 0.04-0.25 | 0.6-14 | 1.0-6 |
| F5B6E | FC5B6 | >25% | 0.04-0.25 | 0.6-14 | 1.0-6 |
| F5C6E | FC5C6 | >25% | 0.04-0.25 | 0.6-14 | 1.0-6 |
| F5D6E | FC5D6 | >25% | 0.04-0.25 | 0.6-14 | 1.0-6 |
| F5E6E | FC5E6 | >25% | 0.04-0.25 | 0.6-14 | 1.0-6 |
| F6A1E | FC6A1 | >25% | 0.04-0.25 | 0.6-14 | 1.0-6 |
| F6B1E | FC6B1 | >25% | 0.04-0.25 | 0.6-14 | 1.0-6 |
| F6C1E | FC6C1 | >25% | 0.04-0.25 | 0.6-14 | 1.0-6 |
| F6D1E | FC6D1 | >25% | 0.04-0.25 | 0.6-14 | 1.0-6 |
| F6E1E | FC6E1 | >25% | 0.04-0.25 | 0.6-14 | 1.0-6 |
| F6A2E | FC6A2 | >25% | 0.04-0.25 | 0.6-14 | 1.0-6 |
| F6B2E | FC6E2 | >25% | 0.04-0.25 | 0.6-14 | 1.0-6 |
| F6C2E | FC6C2 | >25% | 0.04-0.25 | 0.6-14 | 1.0-6 |
| F6D2E | FC6D2 | >25% | 0.04-0.25 | 0.6-14 | 1.0-6 |
| F6E2E | FC6E2 | >25% | 0.04-0.25 | 0.6-14 | 1.0-6 |
| F6A3E | FC6A3 | >25% | 0.04-0.25 | 0.6-14 | 1.0-6 |
| F6B3E | FC6B3 | >25% | 0.04-0.25 | 0.6-14 | 1.0-6 |
| F6C3E | FC6C3 | >25% | 0.04-0.25 | 0.6-14 | 1.0-6 |
| F6D3E | FC6D3 | >25% | 0.04-0.25 | 0.6-14 | 1.0-6 |
| F6E3E | FC6E3 | >25% | 0.04-0.25 | 0.6-14 | 1.0-6 |
| F6A4E | FC6A4 | >25% | 0.04-0.25 | 0.6-14 | 1.0-6 |
| F6B4E | FC6B4 | >25% | 0.04-0.25 | 0.6-14 | 1.0-6 |
| F6C4E | FC6C4 | >25% | 0.04-0.25 | 0.6-14 | 1.0-6 |
| F6D4E | FC6D4 | >25% | 0.04-0.25 | 0.6-14 | 1.0-6 |
| F6E4E | FC6E4 | >25% | 0.04-0.25 | 0.6-14 | 1.0-6 |
| F6A5E | FC6A5 | >25% | 0.04-0.25 | 0.6-14 | 1.0-6 |
| F6B5E | FC6B5 | >25% | 0.04-0.25 | 0.6-14 | 1.0-6 |
| F6C5E | FC6C5 | >25% | 0.04-0.25 | 0.6-14 | 1.0-6 |
| F6D5E | FC6D5 | >25% | 0.04-0.25 | 0.6-14 | 1.0-6 |
| F6E5E | FC6E5 | >25% | 0.04-0.25 | 0.6-14 | 1.0-6 |
| F6A6E | FC6A6 | >25% | 0.04-0.25 | 0.6-14 | 1.0-6 |
| F6B6E | FC6B6 | >25% | 0.04-0.25 | 0.6-14 | 1.0-6 |
| F6C6E | FC6C6 | >25% | 0.04-0.25 | 0.6-14 | 1.0-6 |
| F6D6E | FC6D6 | >25% | 0.04-0.25 | 0.6-14 | 1.0-6 |
| F6E6E | FC6E6 | >25% | 0.04-0.25 | 0.6-14 | 1.0-6 |
| F7A1E | FC7A1 | >25% | 0.04-0.25 | 0.6-14 | 1.0-6 |
| F7B1E | FC7B1 | >25% | 0.04-0.25 | 0.6-14 | 1.0-6 |
| F7C1E | FC7C1 | >25% | 0.04-0.25 | 0.6-14 | 1.0-6 |
| F7D1E | FC7D1 | >25% | 0.04-0.25 | 0.6-14 | 1.0-6 |
| F7E1E | FC7E1 | >25% | 0.04-0.25 | 0.6-14 | 1.0-6 |
| F7A2E | FC7A2 | >25% | 0.04-0.25 | 0.6-14 | 1.0-6 |
| F7B2E | FC7B2 | >25% | 0.04-0.25 | 0.6-14 | 1.0-6 |
| F7C2E | FC7C2 | >25% | 0.04-0.25 | 0.6-14 | 1.0-6 |
| F7D2E | FC7D2 | >25% | 0.04-0.25 | 0.6-14 | 1.0-6 |
| F7E2E | FC7E2 | >25% | 0.04-0.25 | 0.6-14 | 1.0-6 |
| F7A3E | FC7A3 | >25% | 0.04-0.25 | 0.6-14 | 1.0-6 |
| F7B3E | FC7B3 | >25% | 0.04-0.25 | 0.6-14 | 1.0-6 |
| F7C3E | FC7C3 | >25% | 0.04-0.25 | 0.6-14 | 1.0-6 |
| F7D3E | FC7D3 | >25% | 0.04-0.25 | 0.6-14 | 1.0-6 |
| F7E3E | FC7E3 | >25% | 0.04-0.25 | 0.6-14 | 1.0-6 |
| F7A4E | FC7A4 | >25% | 0.04-0.25 | 0.6-14 | 1.0-6 |
| F7B4E | FC7B4 | >25% | 0.04-0.25 | 0.6-14 | 1.0-6 |
| F7C4E | FC7C4 | >25% | 0.04-0.25 | 0.6-14 | 1.0-6 |
| F7D4E | FC7D4 | >25% | 0.04-0.25 | 0.6-14 | 1.0-6 |
| F7E4E | FC7E4 | >25% | 0.04-0.25 | 0.6-14 | 1.0-6 |
| F7A5E | FC7A5 | >25% | 0.04-0.25 | 0.6-14 | 1.0-6 |
| F7B5E | FC7B5 | >25% | 0.04-0.25 | 0.6-14 | 1.0-6 |
| F7C5E | FC7C5 | >25% | 0.04-0.25 | 0.6-14 | 1.0-6 |
| F7D5E | FC7D5 | >25% | 0.04-0.25 | 0.6-14 | 1.0-6 |
| F7E5E | FC7E5 | >25% | 0.04-0.25 | 0.6-14 | 1.0-6 |
| F7A6E | FC7A6 | >25% | 0.04-0.25 | 0.6-14 | 1.0-6 |
| F7B6E | FC7B6 | >25% | 0.04-0.25 | 0.6-14 | 1.0-6 |
| F7C6E | FC7C6 | >25% | 0.04-0.25 | 0.6-14 | 1.0-6 |
| F7D6E | FC7D6 | >25% | 0.04-0.25 | 0.6-14 | 1.0-6 |
| F7E6E | FC7E6 | >25% | 0.04-0.25 | 0.6-14 | 1.0-6 |
| F8A1E | FC8A1 | >25% | 0.04-0.25 | 0.6-14 | 1.0-6 |
| F8B1E | FC8B1 | >25% | 0.04-0.25 | 0.6-14 | 1.0-6 |
| F8C1E | FC8C1 | >25% | 0.04-0.25 | 0.6-14 | 1.0-6 |
| F8D1E | FC8D1 | >25% | 0.04-0.25 | 0.6-14 | 1.0-6 |
| F8E1E | FC8E1 | >25% | 0.04-0.25 | 0.6-14 | 1.0-6 |
| F8A2E | FC8A2 | >25% | 0.04-0.25 | 0.6-14 | 1.0-6 |
| F8B2E | FC8B2 | >25% | 0.04-0.25 | 0.6-14 | 1.0-6 |
| F8C2E | FC8C2 | >25% | 0.04-0.25 | 0.6-14 | 1.0-6 |
| F8D2E | FC8D2 | >25% | 0.04-0.25 | 0.6-14 | 1.0-6 |
| F8E2E | FC8E2 | >25% | 0.04-0.25 | 0.6-14 | 1.0-6 |
| F8A3E | FC8A3 | >25% | 0.04-0.25 | 0.6-14 | 1.0-6 |
| F8B3E | FC8B3 | >25% | 0.04-0.25 | 0.6-14 | 1.0-6 |
| F8C3E | FC8C3 | >25% | 0.04-0.25 | 0.6-14 | 1.0-6 |
| F8D3E | FC8D3 | >25% | 0.04-0.25 | 0.6-14 | 1.0-6 |
| F8E3E | FC8E3 | >25% | 0.04-0.25 | 0.6-14 | 1.0-6 |
| F8A4E | FC8A4 | >25% | 0.04-0.25 | 0.6-14 | 1.0-6 |
| F8B4E | FC8B4 | >25% | 0.04-0.25 | 0.6-14 | 1.0-6 |
| F8C4E | FC8C4 | >25% | 0.04-0.25 | 0.6-14 | 1.0-6 |
| F8D4E | FC8D4 | >25% | 0.04-0.25 | 0.6-14 | 1.0-6 |
| F8E4E | FC8E4 | >25% | 0.04-0.25 | 0.6-14 | 1.0-6 |
| F8A5E | FC8A5 | >25% | 0.04-0.25 | 0.6-14 | 1.0-6 |
| F8B5E | FC8B5 | >25% | 0.04-0.25 | 0.6-14 | 1.0-6 |
| F8C5E | FC8C5 | >25% | 0.04-0.25 | 0.6-14 | 1.0-6 |
| F8D5E | FC8D5 | >25% | 0.04-0.25 | 0.6-14 | 1.0-6 |
| F8E5E | FC8E5 | >25% | 0.04-0.25 | 0.6-14 | 1.0-6 |
| F8A6E | FC8A6 | >25% | 0.04-0.25 | 0.6-14 | 1.0-6 |
| F8B6E | FC8B6 | >25% | 0.04-0.25 | 0.6-14 | 1.0-6 |
| F8C6E | FC8C6 | >25% | 0.04-0.25 | 0.6-14 | 1.0-6 |
| F8D6E | FC8D6 | >25% | 0.04-0.25 | 0.6-14 | 1.0-6 |
| F8E6E | FC8E6 | >25% | 0.04-0.25 | 0.6-14 | 1.0-6 |

The foams of the present invention have wide utility. The present foams, including each of Foams 1-4 and foams F1-F8, have unexpected advantage in applications requiring low density and/or good compression and/or tensile and/or shear properties, and/or long-term stability, and/or sustainable sourcing, and/or being made from recycled material and being recyclable. In particular, the present foams, including each of Foams 1-6 and each of foams F1-F8, have unexpected advantage in: wind energy applications (wind turbine blades (shear webs, shells, cores, and root); marine applications (hulls, decks, superstructures, bulkheads, stringers, and interiors); industrial low weight applications; automotive and transport applications (interior and exterior of cars, trucks, trains, aircraft, and spacecraft).

PEF: PET copolymers can be formed by any means to those known to those skilled in the art, including but not limited to those procedures described in the Examples hereof.

The foams of the present invention, including each of Foam 1-4, are formed from either PEF homopolymers, PEF copolymers, PEF: PET copolymers or a combination/mixture of these.

The foams, including each of Foam 1-4, may be formed in preferred embodiments from PEF homopolymer in which the polymer has at least 99.5% by weight, or at least 99.9% of by weight, of ethylene furanoate moieties.

It is contemplated that the foams of the present invention, including each of Foam 1-3, may be formed in preferred embodiments from PEF copolymer in which the polymer, including PEF copolymer that has from about 0.5% to about 99% by weight of ethylene furanoate moieties. The invention includes foams, including each of Foam 1-3, wherein the thermoplastic polymer consists essentially of the components as described in the following table:

| | RELATIVE MOLE % | | |
|---|---|---|---|
| | Ethylene | Ethylene | MOLECULAR |
| Thermoplastic | furanoate | terephthalate | WEIGHT, |
| Polymer (TMP) | moieties | moieties | g/mol |
| TMP1A | 100 | 0 | 25,000-140,000 |
| TMP1B | 100 | 0 | 50,000-130,000 |
| TMP1C | 100 | 0 | 60,000-130,000 |
| TMP1D | 100 | 0 | 70,000-130,000 |
| TMP1E | 100 | 0 | 80,000-130,000 |
| TMP1F | 100 | 0 | 85,000-110,000 |
| TMP2A | 90 | 10 | 25,000-140,000 |
| TMP2B | 90 | 10 | 50,000-130,000 |
| TMP2C | 90 | 10 | 60,000-130,000 |
| TMP2D | 90 | 10 | 70,000-130,000 |
| TMP2E | 80 | 20 | 80,000-130,000 |
| TMP2F | 90 | 20 | 85,000-110,000 |
| TMP3A | 80 | 20 | 25,000-140,000 |
| TMP3B | 80 | 20 | 50,000-130,000 |
| TMP3C | 80 | 20 | 60,000-130,000 |
| TMP3D | 80 | 20 | 70,000-130,000 |
| TMP3E | 80 | 20 | 80,000-130,000 |
| TMP3F | 80 | 20 | 85,000-110,000 |
| TMP4A | 70 | 30 | 25,000-140,000 |
| TMP4B | 70 | 30 | 50,000-130,000 |
| TMP4C | 70 | 30 | 60,000-130,000 |
| TMP4D | 70 | 30 | 70,000-130,000 |
| TMP4E | 70 | 30 | 80,000-130,000 |
| TMP4F | 70 | 30 | 85,000-110,000 |
| TMP5A | 60 | 40 | 25,000-140,000 |
| TMP5B | 60 | 40 | 50,000-130,000 |
| TMP5C | 60 | 40 | 60,000-130,000 |
| TMP5D | 60 | 40 | 70,000-130,000 |
| TMP5E | 60 | 40 | 80,000-130,000 |
| TMP5F | 60 | 40 | 85,000-110,000 |
| TMP6A | 50 | 50 | 25,000-140,000 |
| TMP6B | 50 | 50 | 50,000-130,000 |
| TMP6C | 50 | 50 | 60,000-130,000 |
| TMP6D | 50 | 50 | 70,000-130,000 |
| TMP6E | 50 | 50 | 80,000-130,000 |
| TMP6F | 50 | 50 | 85,000-110,000 |
| TMP7A | 40 | 60 | 25,000-140,000 |
| TMP7B | 40 | 60 | 50,000-130,000 |
| TMP7C | 40 | 60 | 60,000-130,000 |
| TMP7D | 40 | 60 | 70,000-130,000 |
| TMP7E | 40 | 60 | 80,000-130,000 |
| TMP7F | 40 | 60 | 85,000-110,000 |
| TMP8A | 30 | 70 | 25,000-140,000 |
| TMP8B | 30 | 70 | 50,000-130,000 |
| TMP8C | 30 | 70 | 60,000-130,000 |
| TMP8D | 30 | 70 | 70,000-130,000 |
| TMP8E | 30 | 70 | 80,000-130,000 |
| TMP8F | 30 | 70 | 85,000-110,000 |
| TMP9A | 20 | 80 | 25,000-140,000 |
| TMP9B | 20 | 80 | 50,000-130,000 |
| TMP9C | 20 | 80 | 60,000-130,000 |
| TMP9D | 20 | 80 | 70,000-130,000 |
| TMP9E | 20 | 80 | 80,000-130,000 |
| TMP9F | 20 | 80 | 85,000-110,000 |
| TMP10A | 10 | 90 | 25,000-140,000 |
| TMP10B | 10 | 90 | 50,000-130,000 |
| TMP10C | 10 | 90 | 60,000-130,000 |
| TMP10D | 10 | 90 | 70,000-130,000 |
| TMP10E | 10 | 90 | 80,000-130,000 |
| TMP10F | 10 | 90 | 85,000-110,000 |
| TMP11A | 5 | 95 | 25,000-140,000 |
| TMP11B | 5 | 95 | 50,000-130,000 |
| TMP11C | 5 | 95 | 60,000-130,000 |
| TMP11D | 5 | 95 | 70,000-130,000 |
| TMP11E | 5 | 95 | 80,000-130,000 |
| TMP11F | 5 | 95 | 85,000-110,000 |
| TMP12A | 2.5 | 97.5 | 25,000-140,000 |
| TMP12B | 2.5 | 97.5 | 50,000-130,000 |
| TMP12C | 2.5 | 97.5 | 60,000-130,000 |
| TMP12D | 2.5 | 97.5 | 70,000-130,000 |
| TMP12E | 2.5 | 97.5 | 80,000-130,000 |
| TMP12F | 2.5 | 97.5 | 85,000-110,000 |
| TMP13A | 1 | 99 | 25,000-140,000 |
| TMP13B | 1 | 99 | 50,000-130,000 |
| TMP13C | 1 | 99 | 60,000-130,000 |
| TMP13D | 1 | 99 | 70,000-130,000 |
| TMP13E | 1 | 99 | 80,000-130,000 |
| TMP13F | 1 | 99 | 85,000-110,000 |
| TMP14A | 0.5 | 99.5 | 25,000-140,000 |
| TMP14B | 0.5 | 99.5 | 50,000-130,000 |
| TMP14C | 0.5 | 99.5 | 60,000-130,000 |
| TMP14D | 0.5 | 99.5 | 70,000-130,000 |
| TMP14E | 0.5 | 99.5 | 80,000-130,000 |
| TMP14F | 0.5 | 99.5 | 85,000-110,000 |

The foams of the present invention, including each of Foams 1-3, can comprise closed cell walls comprising each of the thermoplastic polymers of the present invention, including each of TMP1-TMP12 described in the table above.

For those embodiments of the present invention involving PEF copolymers, it is contemplated that those skilled in the art will be able, in view of the teachings contained herein, to select the type in an amount of co-polymeric materials to be used within each of the ranges described herein to achieve the desired enhancement/modification of the polymer without undue experimentation.

It is contemplated that the TMPs of the present invention may be formed with a variety of physical properties, including the following ranges of polymer characteristics, which are measured as described in the Examples hereof:

| Polymer | Broad | Intermediate | Narrow |
|---|---|---|---|
| property | Range | Range | Range |
| Glass Transition | 80-100 | 85-95 | 90-95 |
| Temperature, | | | |
| T_{g}, ° C. | | | |
| Melting | 190-250 | 200-240 | 210-230 |
| Temperature, | | | |
| Tₘ, ° C. | | | |
| Decomposition | 300-420 | 320-400 | 330-370 |
| Temperature, | | | |
| T_{d}, ° C. | | | |
| Crystallinity, % | 25-75 | 30-60 | 40-50 |

In general, it is contemplated that those skilled in the art will be able to formulate PEF polymers within the range of properties described above without undue experimentation in view of the teachings contained herein. In preferred embodiments, however, PEF polymer according to the present invention (including PEF: PET copolymers of the present invention), having these properties is achieved using one or more of the synthesis methods described above, in combination with a variety of known supplemental processing techniques, including by treatment with chain extenders, such as PMDA, and/or SSP processing.

An example of the process for chain extension treatment of polyesters is provided in the article “Recycled poly (ethylene terephthalate) chain extension by a reactive extrusion process,” Firas Awaja, Fugen Daver, Edward Kosior, 16 Aug. 2004, available at https://doi.org/10.1002/pen.20155, which is incorporated herein by reference. As explained in US 1009/0264545, which is incorporated herein by reference, chain extenders generally are typically compounds that are at least di-functional with respect to reactive groups which can react with end groups or functional groups in the polyester to extend the length of the polymer chains. In certain cases, as disclosed herein, such a treatment can advantageously increase the average molecular weight of the polyester to improve its melt strength and/or other important properties. The degree of chain extension achieved is related, at least in part, to the structure and functionalities of the compounds used. Various compounds are useful as chain extenders. Non-limiting examples of chain extenders include trimellitic anhydride, pyromellitic dianhydride (PMDA), trimellitic acid, haloformyl derivatives thereof, or compounds containing multi-functional epoxy (e.g., glycidyl), or oxazoline functional groups. Nanocomposite material such as finely dispersed nanoclay may optionally be used for controlling viscosity. Commercial chain extenders include CESA-Extend from Clariant, Joncryl from BASF, or Lotader from Arkema. The amount of chain extender can vary depending on the type and molecular weight of the polyester components. The amount of chain extender used to treat the polymer can vary widely, and in preferred embodiments ranges from about 0.1 to about 5 wt. %, or preferably from about 0.1 to about 1.5 wt. %. Examples of chain extenders are also described in U.S. Pat. No. 4,219,527, which is incorporated herein by reference.

An example of the process for SSP processing of poly (ethylene furanoate) is provided in the article “Solid-State Polymerization of Poly (ethylene furanoate) Biobased Polyester, I: Effect of Catalyst Type on Molecular Weight Increase,”

Nejib Kasmi, Mustapha Majdoub, George Z. Papageorgiou, Dimitris S. Achilias, and Dimitrios N. Bikiaris, which is incorporated herein by reference.

The foams of the present invention have wide utility. The present foams, including each of Foams 1-10, have unexpected advantage in applications requiring low density and/or good compression and/or tensile and/or shear properties, and/or long-term stability, and/or sustainable sourcing, and/or being made from recycled material and being recyclable. In particular, the present foams, including each of Foams 1-10, have unexpected advantage in: wind energy applications (wind turbine blades (shear webs, shells, cores, and nacelles); marine applications (hulls, decks, superstructures, bulkheads, stringers, and interiors); industrial low weight applications; automotive and transport applications (interior and exterior of cars, trucks, trains, aircraft, and spacecraft); stationary building structure; and sporting equipment.

The size and shape of the foam used in the present foam articles can vary widely within the scope of the present invention depending on the use that will be made of the article, and all such sizes and shapes are within the scope of the present invention. In many applications, the foam will be in the form of a three dimensional form in which the length and/or width are much larger in dimension than the thickness. In other applications, the form of the article can be characterized as a block, slab, panel or the like, or as a particular shape such as I-beam, U-shaped or other specific shape.

### Foam Articles

The foams of the present invention may also be formed into foamed articles comprising a foam of the present invention with at least a portion of a surface thereof being faced. For convenience of illustration but not by way of limitation, FIG. 2 illustrates a form in which the foam article is in the general shape of a sheet or panel that has a facing on each side of the sheet or panel. In the illustrated embodiment, a foam article according to the present invention comprises a core 1 of PEF foam of the present invention, including each of Foams 1-4 as defined above, and at least one reinforcing facing 2 and at least one connecting and/or integrating layer 3. It will be understood by those skilled in the art in view of the teachings contained herein that the connecting/integrating layer may comprise a layer of adhesive, for example, or may be formed by integrating the core material and the facing material without the use of a separate adhesive, such as would occur, for example, by melting the surfaces of the two materials together to form a connecting/integrating region. The facing can be any material appropriate to the intended use, as mentioned above, but in many applications the facing 2 is a sheet or film of fibrous material as described above. The fibers of a preferred facing 2 may be, for example, in the form of a woven or nonwoven mat (or a mat comprising a combination of woven and non-woven fibers), including crimped mats that can be either woven or non-woven, and the fibers can be oriented or non-oriented (i.e., random). In embodiments in which the fibers of the facing are oriented, the orientation can include unidirectional, bi-directional, bi-axial, tri-axial, quad-axial and combinations of any of these.

The connecting/integrating film, layer or region 3 can be any material and in any thickness needed to attach or integrate the facing 3 to the core 1. Furthermore, while the film or layer 3 is shown as generally as being between the facing 2 and the core 1, it will be understood and appreciated by those skilled in the art that the connecting layer or film generally extends into each of the foam core I and the facing 2. In certain preferred embodiments, the film or layer 3 can comprise adhesive material, such as an epoxy adhesive, which bonds the core I and the facing sheet 2 together. Other adhesive resins which may be used to bond the facing to the foam include polyurethane, vinyl ester, polyester, cyanate esters, urethane-acrylates, bismaleimides, polyimides, silicones, phenolics, polypropenes, caprolactams and combinations of any two or more of these. In general, the processing of forming the foam articles of the present invention involves steps which provide a strong chemical and/or physical bond between facing 2 and the foam 1, and all such steps are within the scope of the present invention.

In preferred embodiments, the facing 2 comprises a plurality of inter-bonded sheets or mats which can be the same or different and are bound to one another by appropriate means, including inter-bonding layers of adhesive or resin or inter-bonding regions formed by material integration (e.g., melting together to form an integrated region). In such embodiments, it is contemplated that the number of inter-bonded sheets that make-up the facing 2 can vary widely, and in preferred embodiments the facing comprises from 2 to 10 inter-bonded sheets, and even more preferably from about 3 to about 5 inter-bonded sheets.

While it is understood that the dimensions of the present foam articles can vary widely, in preferred embodiments involving the use in connections with wind turbine applications, the face sheet can vary from about 0.1 mm to about 3 mm, or from about 0.4 mm to about 1.5 mm. Furthermore, it is generally understood that the relative thickness of the foam compared to the face sheet can vary over a wide range depending on the particular application, and that those skilled in the art will be able to make appropriate selections in view of the teachings contained herein, and that in general the face sheet thickness will be less than the thickness of the foam.

Preferred materials which are used to form the foam articles of the present invention are described in additional detail below.

### Facings

The foam articles of the present invention include a facing that can have a wide variety of dimensions, and the dimensions used will depending upon the particular needs of the application in which the foam article will be used, and articles having all such dimensions are within the scope of the present invention.

The materials which form the facing material may also vary widely depending on the particular use intended for the foam article, and again all such materials are within the scope of present invention. For example, the facing used in the present foam articles, comprises one or more fibrous sheets or mats wherein the fibrous portion can be formed from a wide variety of materials, including for example, glass fibers (preferably impregnated with resin and/or polymers), other natural fibers (such as cellulose and other plant derived materials), mineral fibers (such as quartz), metal fibers or films, carbon fibers (preferably impregnated with or reinforced with one or more polymers, including thermoplastic polymer and/or thermoset polymers), synthetic fibers, such as polyesters (including fibers comprising furan-based polyesters, as disclosed for example in US 2015/0111450, which is incorporated herein by reference), polyethylenes, aramids, Kevlars, and any and all combinations of these.

### Particular Uses

The foam articles of the present invention have wide utility. The present foam articles have unexpected advantage in applications requiring low density and/or good compression and/or tensile and/or shear properties, and/or long-term stability, and/or sustainable sourcing, and/or being made from recycled material and being recyclable. In particular, the present foam articles have unexpected advantage in: fluid energy transfer components, such as for example in wind and water energy transfer applications (e.g., wind turbine blades (shear webs, shells, cores, and nacelles) for transferring wind energy from fixed or mobile devices located in air, and vortex, tidal, oceans current oscillating hydrofoils and kites which recover water kinetic energy from fixed or mobile devices located in water); marine applications (hulls, decks, superstructures, bulkheads, stringers, and interiors); industrial low weight applications; automotive and transport applications (interior and exterior of cars, trucks, trains, aircraft, and spacecraft); and packaging applications.

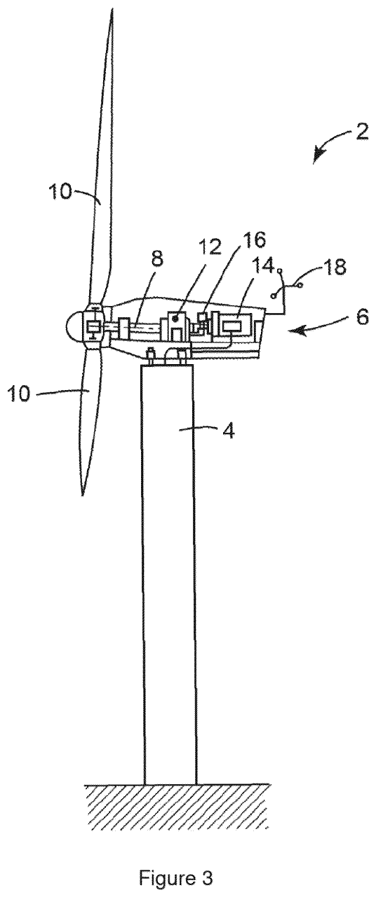

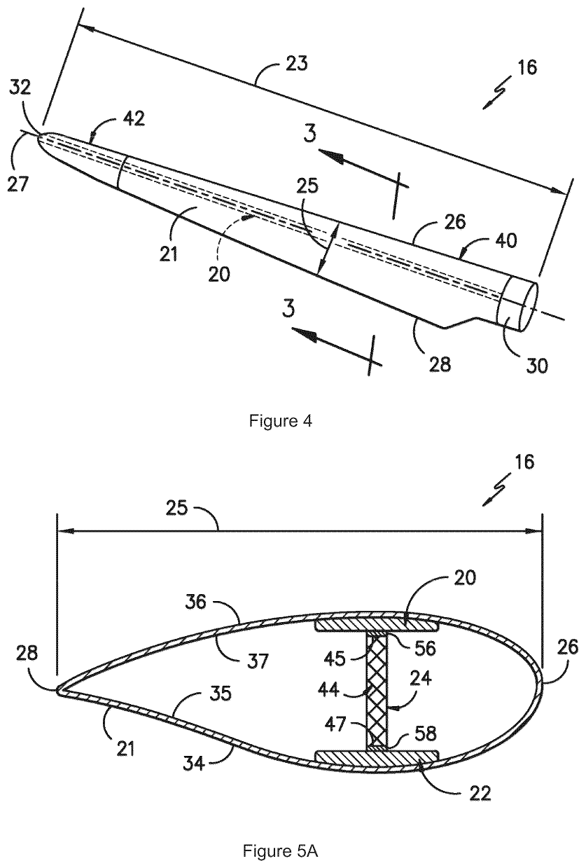

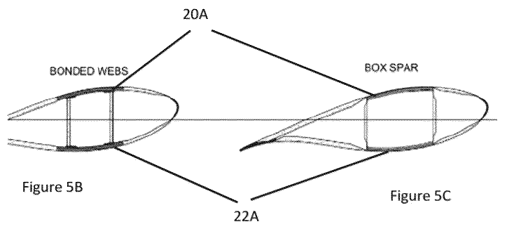

With particular reference to FIGS. 3 and 4A, 4B and 4C, the foam articles of the present invention may be used in a rotor blade 10 at any and all locations along the length of the blade from the blade root 30 to the blade tip 32 disposed opposite the blade root 30, and at any location along the body shell, including on the pressure side 34, on the suction side 36 and at all locations extending between leading edge 26 to the trailing edge 28 of the rotor blade 10. Further, the foam articles of the present invention may be used for all or part of a longitudinally extending structural components configured to provide increased stiffness, buckling resistance and/or strength to the rotor blade 10, such as, longitudinally extending spar caps 20, 22 configured to be engaged against the opposing inner surfaces 35, 37 of the pressure and suction sides 34, 36 of the rotor blade 10, as well as for one or more shear webs 24 disposed between the spar caps 20, 22 so as to form a beam-like configuration. The spar caps 20, 22 may generally be designed to resist the bending stresses and minimize blade tip deflection and/or other loads acting on the rotor blade 10 in a generally span-wise direction (a direction parallel to the span 23 of the rotor blade 16) during operation of a wind turbine 10; it is understood, however, that in other applications the spar cap may also be oriented at any angle transverse to the span-wise axis, including at an angle of about 90 degrees to the span-wise axis. Similarly, the spar caps 20, 22 may also be designed to resist the span-wise compression or tension occurring during operation of the wind turbine 6. Because of the unexpected combination of light weight and high strength of the present foams and the present foam articles the root portions of the blade, as well as the spars and caps used in rotor blades, may utilize to advantage such foams and foam articles.

The following Foam Use Table includes an identification of some of the preferred uses for some of the preferred foam articles of the present invention comprising a foam and a facing for the foam, wherein the column heading “Foam Article Number” refers to a foam article comprising the indicated Particular Foam as identified above.

| Foam Article | Particular | |
|---|---|---|
| Number | Foam | Use |
| 1A | 1A-1N | Energy Transfer Device |
| 1B | 1A-1N | Wind Turbine Blade |
| 1C | 1A-1N | Transportation Device |
| 1D | 1A-1N | Automobile |
| 1E | 1A-1N | Truck |
| 1F | 1A-1N | Rail car |
| 1G | 1A-1N | Aircraft |
| 1H | 1A-1N | Building Structure |
| 1I | 1A-1N | Floor Component |
| 1J | 1A-1N | Wall Component |
| 1K | 1A-1N | Roof Component |
| 1L | 1A-1N | Packaging |
| 1M | 1A-1N | Sporting Good |
| 2A | 2A-2M | Energy Transfer Device |
| 2B | 2A-2M | Wind Turbine Blade |
| 2C | 2A-2M | Transportation Device |
| 2D | 2A-2M | Automobile |
| 2E | 2A-2M | Truck |
| 2F | 2A-2M | Rail car |
| 2G | 2A-2M | Aircraft |
| 2H | 2A-2M | Building Structure |
| 2I | 2A-2M | Floor Component |
| 2J | 2A-2M | Wall Component |
| 2K | 2A-2M | Roof Component |
| 2L | 2A-2M | Packaging |
| 2M | 2A-2M | Sporting Good |
| 3A | 3A-3L | Energy Transfer Device |
| 3B | 3A-3L | Wind Turbine Blade |
| 3C | 3A-3L | Transportation Device |
| 3D | 3A-3L | Automobile |
| 3E | 3A-3L | Truck |
| 3F | 3A-3L | Rail car |
| 3G | 3A-3L | Aircraft |
| 3H | 3A-3L | Building Structure |
| 3I | 3A-3L | Floor Component |
| 3J | 3A-3L | Wall Component |
| 3K | 3A-3L | Roof Component |
| 3L | 3A-3L | Packaging |
| 4A | 4A-4F | Wind Turbine Blade |
| 4B | 4A-4F | Transportation Device |
| 4C | 4A-4F | Automobile |
| 4D | 4A-4F | Truck |
| 4E | 4A-4F | Rail car |
| 4F | 4A-4F | Aircraft |
| 4G | 4A-4F | Building Structure |
| 4H | 4A-4F | Floor Component |
| 4I | 4A-4F | Wall Component |
| 4J | 4A-4F | Roof Component |
| 4K | 4A-4F | Packaging |
| 4L | 4A-4F | Sporting Good |

### EXAMPLES

Without limiting the full scope of the present invention, Applicants have conducted a series of experiments for the purposes of demonstrating the utility of the PEF homopolymers and the PEF-based copolymers of the present invention and to compare the performance of the inventive foams made in accordance with the present invention to foams made with blowing agents other than HFC-152a, and to PET foams made with HFC-152a. These tests involved the synthesis of a series of PET polymers covering a range of physical properties, including molecular weights, crystallinities and melting points. Applicants also prepared a series of PEF polymers (including homopolymers and copolymers) over a similar range of physical properties. A series of foams were prepared using the HFC-152a of the present invention as the blowing agent. Foams prepared using other materials as blowing agents were also prepared and tested. A consistent set of processing conditions for a given range of comparable polymer properties were utilized.

The foaming conditions were selected to ensure suitable expansion.

The foams thus produced throughout the Examples in this application, were tested to determine the density of foam using a method which corresponds generally to ASTM D71, except that hexane is used for displacement instead of water. In order to facilitate comparison of the densities of the foam produced in these examples, applicants have reported foam density as Relative Foam Density (RFD), which is the density of the foam measured as described above divided by the density of the starting polymer. In this document all foam densities, whether they originate from PEF or PET homopolymers or from PEF-PET copolymers, have been normalized by the density of PEF polymer, 1.43 g/cc, which is about 7% less dense than PET. This way, when strengths of various polymeric foams are compared at the same RFD, they are also compared at the same overall density.

In addition, each of the foams produced in these examples was tested to determine tensile strength and compressive strength. The tensile strength and compressive strength measurements were based on the guidelines provided in ASTM C297 and ISO 844, respectively, with the measurement in each case in the direction of depressurizing.

The details of each of these sets of experimental results are explained in detail in the examples which follow.

### Example 1A-PEF Preparation at Mw 114,000 with PMDA Chain Extender and SSP

A bio-based polyethylene furanoate homopolymer was prepared by esterification and polycondensation of 2,5-furandicarboxylic acid with mono ethylene glycol using the additives and polymer formation procedures generally as described in Synthesis Example 1A below.

The homopolymer thus produced, which is designated PEFEx1 was tested and found to have the characteristics as reported in Table Ex1A below1:

TABLE Ex1A

| | Example 1 |
|---|---|
| Designation | PEFEx1 |
| PEF Homopolymer | 114,000 |
| Molecular Weight | |
| Glass Transition | 86 |
| Temperature, ° C. | |
| Melting Point, ° C. | 214 |
| Decomposition | 347 |
| Temperature, ° C. | |
| Crystallinity, % | 46 |

The PEF polymer so produced is referred to in these Examples as PEFEx1.

### Comparative Examples C1A, C1B and C1C-PEF Foam Preparation Using Pefex1 and Isopentane, Cyclopentane and CO2 as Blowing Agent

For each of these comparative examples, 1 gram of PEFEx1 in a glass container was loaded into an autoclave and then dried under vacuum for six (6) hours at 130° C. The dried polymer was then cooled to room temperature and placed in a glass container inside an autoclave. The indicated amount of the blowing agent in the table below was then pumped into the autoclave containing the dried polymer, and then the autoclave was heated to bring the polymer to a melt state at a temperature of about 240° C. and a pressure above about 610 1 Throughout these examples, molecular weight as determined and referenced herein refers to molecular weight determination by diffusion ordered nuclear magnetic resonance spectroscopy (DOSY NMR) as per the description contained in “Application of 1H DOSY NMR in Measurement of Polystyrene Molecular Weights,” VNU Journal of Science: Natural Sciences and Technology, Vol. 36, No. 2 (2020) 16-21 Jun. 2020, Nam et a, except for differences in the solvents used. The reference above used 3 mg of polystyrene and 0.5 ml of deuterated chloroform. For these examples, NMR measurements were made with the dissolved portion of 2-3 mg of polymer in a 0.6 ml mixture of 50 vol % deuterated chloroform+50 vol % trifluoroacetic acid. psig. The polymer/blowing agent was maintained in the melt state at the melt state pressure and temperature for about a period (designated below as the “Melt Time”, MTime) as indicated in the table (either 60 minutes or 15 minutes). The temperature (MTemp) and pressure (MP) of the melt/blowing agent were then reduced over a period of about 5-15 minutes to pre-foaming temperature (PFT) for about 5-15 minutes, and then maintained at about this temperature and pressure for a period of about 30 minutes to allow the amount of blowing agent incorporated into the melt under such conditions to reach equilibrium. The temperature and pressure in the autoclave were then reduced rapidly (over a period of about 10 seconds for the pressure reduction and about 1-10 minutes for the temperature reduction using chilled water)) to ambient conditions (approximately 22° C. and 1 atmosphere) and foaming occurred. The foam thus produced was tested to determine the following properties:
compressive strength (“CS”) (measured perpendicular to the plane in accordance with ISO 844)
tensile strength (“TM”) (measured perpendicular to the plane in accordance with ASTM C297)
relative foam density (“RFD”).

As used herein, RFD is the density of the foam produced divided by the density of the starting polymer. Density is measured in these Examples using a method which corresponds generally to ASTM D71, except that hexane is used for displacement instead of water.

The foam produced in this Comparative Examples CIA, C1B and CIC was tested and found to have the properties as reported in Table C1 below:

TABLE C1

| | Example | | |
|---|---|---|---|
| | C1A | C1B | C1C |
| MATERIAL | | | |
| Polymer | PEFEx1 | PEFEx1 | PEFEx1 |
| (MW) | (114K) | (114K) | (114K) |
| Blowing Agent* | Isopentane | Cyclopentane | CO2 |
| Blowing Agent, (grams) | 27.8 | 32.9 | 11 |
| CONDITION | | | |
| Melt Temp, ° C. | 240 | 240 | 240 |
| Melt Press., psig | 443 | 320 | 668 |
| Melt Time, min. | 60 | 60 | 60 |
| Pre-foaming Temp., ° C. | 190 | 190 | 180 |
| FOAM PROPERTY | | | |
| RFD | 0.125 | .204 | 0.29 |
| TS, Mp | 0.95 | 0.55 | 0.32 |
| CS, Mp | 0.69 | 0.71 | 0.27 |
| TS + CS | 1.64 | 1.26 | 0.57 |

### Example 2-PEF Preparation at MW 49,000 with PMDA Chain Extender and SSP

A bio-based polyethylene furanoate homopolymer was prepared by esterification and polycondensation of 2,5-furandicarboxylic acid with mono ethylene glycol using the additives and polymer formation procedures as described in Synthesis Example 2 below.

The homopolymer thus produced, which is designated PEFEx2 was tested and found to have the characteristics as reported in Table Ex2 below:

TABLE Ex2

| | Example 2 |
|---|---|
| Designation | PEFEx2 |
| PEF Homopolymer | 49,000 |
| Molecular Weight | |
| Glass Transition | 92.1 |
| Temperature, ° C. | |
| Melting Point, ° C. | 219.1 |
| Decomposition | 343.7 |
| Temperature, ° C. | |
| Crystallinity, % | 41.9 |

The PEF polymer so produced is referred to in these Examples as PEFEx2.

### Example 2A-PEF Foam Preparation Using PEX2 and HFC-152a as Blowing Agent

The procedure for making foam as described in Comparative Example 1 was repeated, except that blowing agent was HFC-152a and process conditions were as indicated in Table E2A below. The foams thus produced were observed to be good, high quality foam, and were then tested and found to have the properties reported in Table E2B below, together with the results from Comparative Examples 1A, 1B and 1C for ease of comparison:

TABLE E2B

| | Example | | | |
|---|---|---|---|---|
| | 2A | C1A | C1B | C1C |
| MATERIAL | | | | |
| Polymer | PEFEx2 | PEFEx1 | PEFEx1 | PEFEx1 |
| (MW) | (49K) | (114K) | (114K) | (114K) |
| Blowing Agent* | HFC-152a | Isopentane | Cyclo- | CO2 |
| | | | pentane | |
| Blowing Agent, (grams) | 25 | 27.8 | 32.9 | 11 |
| CONDITION | | | | |
| Melt Temp, ° C. | 220 | 240 | 240 | 240 |
| Melt Press., psig | 1006 | 443 | 320 | 668 |
| Melt Time, min. | 15 | 60 | 60 | 60 |
| Pre-foaming Temp., ° C. | 200 | 190 | 190 | 180 |
| FOAM PROPERTY | | | | |
| RFD | 0.110 | 0.125 | .204 | 0.29 |
| TS, Mp | 1.45 | 0.95 | 0.55 | 0.32 |
| CS, Mp | 1.72 | 0.69 | 0.71 | 0.27 |
| TS + CS | 3.17 | 1.64 | 1.26 | 0.57 |

The PEF polymer used to form the foam of Example 2 had a molecular weight that was less than half the molecular weight of the polymer used to make the comparative foams. In general, the use of a lower molecular material to make a foam will result in a tendency to produce foams having a strength disadvantage compared to foams made from the same thermoplastic but with a higher molecular weight. Also, generally speaking, strength properties of foams tend to decrease as density decreases. Despite these general tendencies, the foam made in accordance with the present invention surprisingly has dramatically superior properties to the comparative foams, and this result is even more surprising in view of the fact that: (1) the molecular weight of the polymeric material used to make the foam of this example was less than half of the molecular weight of the polymeric material used to form the comparative examples; and (2) the inventive foam of this example had the lowest density of all the foams in Table E2A. By way of example, the CS+TS value of the foam of this example was 3.17, which is almost 2 times higher than the foam blown with isopentane, even though the isopentane foam had a higher density and was made from the polymer having a molecular weight of 114,000.

### Comparative Example 2A-PET Homopolymer Preparation with Molecular Weight of about 81 Kg/Mol and Crystallinty of 43 with PMDA and SSP2

A PET homopolymer was prepared by polycondensation yielding a polymer product having a molecular weight of about 81 kg/mol using the procedure described in Synthesis Example C1 to achieve the polymer with a molecular weight of 80,871 identified as PETC1A below, as described in detail in Synthesis Example C1 below.

The PET polymer is designated herein as PETC1A was tested and found to have the characteristics as reported in Table CIA below:

TABLE C1

| | Example C1A |
|---|---|
| Designation | PETC1A |
| PET Homopolymer Molecular Weight | 80,871 |
| Glass Transition Temperature, ° C. | 74.9 |
| Melting Point, ° C. | 230 |
| Decomposition Temperature, ° C. | 378 |
| Crystallinity, % | 42.9 |

As noted from the table above, the PET homopolymer was produced utilizing the preferred high crystallinity aspects of the present invention and therefore includes an unexpectedly high strength for PET foams made using the present blowing agents compared to PET foams that are made from PET polymers that do not use this aspect of the present invention.

### Comparative Example C1B1-C1B4: Pet Foam Preparation Using Petcia with HFC-152A Blowing Agent and 60 Minute Melt Times

In a series of runs, 1 gram of the polymer PETCIA in a glass container was loaded into a 60 cc volume autoclave and then dried under vacuum for six (6) hours at 130° C. The dried polymer was then cooled to room temperature. For each case, the blowing agent (as indicated in Table C1B below) was then pumped into the autoclave containing the dried polymer, and then the autoclave was heated to bring the polymer to a melt state, for which the temperatures, pressures and times are listed in Table CIB below. After the indicated melt time, the temperature and pressure of the melt/blowing agent were then reduced over a period of about 5-15 minutes to pre-foaming temperature and pre-foaming pressure, as indicated in Table C1B. The autoclave was then maintained at about this temperature and pressure for a period of about 30 minutes to ensure that the amount of blowing agent incorporated into the melt under such conditions reached equilibrium. The conditions used, including the amount of the blowing agent and the melt temperature and pressure, were determined after several tests, based on the ability to form acceptable foams with RFD values in the range of about 0.05 to about 0.2. The temperature and pressure in the autoclave were then reduced rapidly (over a period of about 10 seconds for the pressure reduction and about 1-10 minutes for the temperature reduction using chilled water) to ambient conditions (approximately 22° C. and 1 atmosphere) and foaming occurred.

The PET foams thus produced in this Example CIB were tested and found to have the properties as reported in Table C1B below, which includes for comparison purposes the foam of the present invention according to Example 2A above.

TABLE C1B

| | Example | | | |
|---|---|---|---|---|
| | 2A | C1A | C1B | C1C |
| MATERIAL | | | | |
| Polymer | PEFEx2 | PET1A | PET1A | PET1A |
| (MW) | (49K) | (80.87K) | (80.87K) | (80.87K) |
| Blowing Agent* | HFC-152a | HFC-152a | HFC-152a | HFC-152a |
| Blowing Agent, (grams) | 25 | 27.8 | 32.9 | 11 |
| CONDITION | | | | |
| Melt Temp, ° C. | 220 | 245 | 255 | 255 |
| Melt Press., psig | 1006 | | 2010 | 2174 |
| Melt Time, min. | 15 | 60 | 60 | 60 |
| Pre-foaming Temp., ° C. | 200 | 225 | 215 | 225 |
| FOAM PROPERTY | | | | |
| RFD | 0.110 | 0.068 | .144 | 0.159 |
| TS, Mp | 1.45 | 0.66 | 0.76 | 0.96 |
| CS, Mp | 1.72 | 0.38 | 0.19 | 0.34 |
| TS + CS | 3.17 | 1.04 | 0.95 | 1.30 |

As illustrated by Table C1B above, the foam of the present invention made with HFC-152a blowing agent and the preferred PEF homopolymer of the present invention exhibits dramatically superior results compared to foams made from PET homopolymer when using HFC-152a as the blowing agent. For example, the CS+TS value of the foam of this Example 2A according to the present inventio was 3.17, which is almost 3 times higher than the foam blown with HFC-152a but made from PET having a molecular weight that is about double the molecular weight of the PEF foam. This is a surprising and highly advantageous result.

### Examples 4-6-PEF Foam Preparation Using PEF with MW of 25,000-150,000

Example 1 is repeated, except that the conditions and materials are altered as indicted below in Table E4 through Table E10, with all values understood to be “about” the indicated value, and wherein the wt % of HFC-152a refers to the wt % based on the total weight of blowing agent used to make the foam.

TABLE E4

| | | | | | Foam Properties** | | | |
|---|---|---|---|---|---|---|---|---|
| | Thermoplastic Properties* | | | | | | | Vol % |
| | WT % | | | HFC-152a, | | | | Closed |
| Example | PEF | MW | % Cr* | wt % | RFD | Strength | Modulus | Cells |
| 4A | >50 | >25,000- | >25% | >50% | <0.2 | A | A | >50 |
| | | 50,000 | | | | | | |
| 4B | >60 | >25,000- | >25% | >50% | <0.2 | A | A | >50 |
| | | 50,000 | | | | | | |
| 4C | >70 | >25,000- | >25% | >50% | <0.2 | A | A | >50 |
| | | 50,000 | | | | | | |
| 4D | >80 | >25,000- | >25% | >50% | <0.2 | A | A | >50 |
| | | 50,000 | | | | | | |
| 4E | >90 | >25,000- | >25% | >50% | <0.2 | A | A | >50 |
| | | 50,000 | | | | | | |
| 4G | 100 | >25,000- | >25% | >50% | <0.2 | A | A | >50 |
| | | 50,000 | | | | | | |
| 4H | >50 | >25,000- | >25% | >75% | <0.2 | A | A | >50 |
| | | 50,000 | | | | | | |
| 4I | >60 | >25,000- | >25% | >75% | <0.2 | A | A | >50 |
| | | 50,000 | | | | | | |
| 4J | >70 | >25,000- | >25% | >75% | <0.2 | A | A | >50 |
| | | 50,000 | | | | | | |
| 4K | >80 | >25,000- | >25% | >75% | <0.2 | A | A | >50 |
| | | 50,000 | | | | | | |
| 4L | >90 | >25,000- | >25% | >75% | <0.2 | A | A | >50 |
| | | 50,000 | | | | | | |
| 4M | 100 | >25,000- | >25% | >75% | <0.2 | A | A | >50 |
| | | 50,000 | | | | | | |
| 4N | >50 | >25,000- | >25% | >90% | <0.2 | A | A | >50 |
| | | 50,000 | | | | | | |
| 4O | >60 | >25,000- | >25% | >90% | <0.2 | A | A | >50 |
| | | 50,000 | | | | | | |
| 4P | >70 | >25,000- | >25% | >90% | <0.2 | A | A | >50 |
| | | 50,000 | | | | | | |
| 4Q | >80 | >25,000- | >25% | >90% | <0.2 | A | A | >50 |
| | | 50,000 | | | | | | |
| 4R | >90 | >25,000- | >25% | >90% | <0.2 | A | A | >50 |
| | | 50,000 | | | | | | |
| 4S | 100 | >25,000- | >25% | >90% | <0.2 | A | A | >50 |
| | | 50,000 | | | | | | |

*WT % PEF moieties in the polymer and Cr % refers to % crystallinity in the polymer
**A—acceptable

TABLE E5

| | | | | | Foam Properties** | | | |
|---|---|---|---|---|---|---|---|---|
| | Thermoplastic Properties* | | | | | | | Vol % |
| | WT % | | | HFC-152a, | | | | Closed |
| Example | PEF | MW | % Cr* | wt % | RFD | Strength | Modulus | Cells |
| 5A | >50 | 50,000- | >25% | >50% | <0.2 | A | A | >50 |
| | | 100000 | | | | | | |
| 5B | >60 | 50,000- | >25% | >50% | <0.2 | A | A | >50 |
| | | 100000 | | | | | | |
| 5C | >70 | 50,000- | >25% | >50% | <0.2 | A | A | >50 |
| | | 100000 | | | | | | |
| 5D | >80 | 50,000- | >25% | >50% | <0.2 | A | A | >50 |
| | | 100000 | | | | | | |
| 5E | >90 | 50,000- | >25% | >50% | <0.2 | A | A | >50 |
| | | 100000 | | | | | | |
| 5G | 100 | 50,000- | >25% | >50% | <0.2 | A | A | >50 |
| | | 100000 | | | | | | |
| 5H | >50 | 50,000- | >25% | >75% | <0.2 | A | A | >50 |
| | | 100000 | | | | | | |
| 5I | >60 | 50,000- | >25% | >75% | <0.2 | A | A | >50 |
| | | 100000 | | | | | | |
| 5J | >70 | 50,000- | >25% | >75% | <0.2 | A | A | >50 |
| | | 100000 | | | | | | |
| 5K | >80 | 50,000- | >25% | >75% | <0.2 | A | A | >50 |
| | | 100000 | | | | | | |
| 5L | >90 | 50,000- | >25% | >75% | <0.2 | A | A | >50 |
| | | 100000 | | | | | | |
| 5M | 100 | 50,000- | >25% | >75% | <0.2 | A | A | >50 |
| | | 100000 | | | | | | |
| 5N | >50 | 50,000- | >25% | >90% | <0.2 | A | A | >50 |
| | | 100000 | | | | | | |
| 5O | >60 | 50,000- | >25% | >90% | <0.2 | A | A | >50 |
| | | 100000 | | | | | | |
| 5P | >70 | 50,000- | >25% | >90% | <0.2 | A | A | >50 |
| | | 100000 | | | | | | |
| 5Q | >80 | 50,000- | >25% | >90% | <0.2 | A | A | >50 |
| | | 100000 | | | | | | |
| 5R | >90 | 50,000- | >25% | >90% | <0.2 | A | A | >50 |
| | | 100000 | | | | | | |
| 5S | 100 | 50,000- | >25% | >90% | <0.2 | A | A | >50 |
| | | 100000 | | | | | | |

*WT % PEF moieties in the polymer and Cr % refers to % crystallinity in the polymer
**A—acceptable

TABLE E6

| | | | | | Foam Properties** | | | |
|---|---|---|---|---|---|---|---|---|
| | Thermoplastic Properties* | | | | | | | Vol % |
| | WT % | | | HFC-152a, | | | | Closed |
| Example | PEF | MW | % Cr* | wt % | RFD | Strength | Modulus | Cells |
| 6A | >50 | 100,000- | >25% | >50% | <0.2 | A | A | >50 |
| | | 150000 | | | | | | |
| 6B | >60 | 100,000- | >25% | >50% | <0.2 | A | A | >50 |
| | | 150000 | | | | | | |
| 6C | >70 | 100,000- | >25% | >50% | <0.2 | A | A | >50 |
| | | 150000 | | | | | | |
| 6D | >80 | 100,000- | >25% | >50% | <0.2 | A | A | >50 |
| | | 150000 | | | | | | |
| 6E | >90 | 100,000- | >25% | >50% | <0.2 | A | A | >50 |
| | | 150000 | | | | | | |
| 6G | 100 | 100,000- | >25% | >50% | <0.2 | A | A | >50 |
| | | 150000 | | | | | | |
| 6H | >50 | 100,000- | >25% | >75% | <0.2 | A | A | >50 |
| | | 150000 | | | | | | |
| 6I | >60 | 100,000- | >25% | >75% | <0.2 | A | A | >50 |
| | | 150000 | | | | | | |
| 6J | >70 | 100,000- | >25% | >75% | <0.2 | A | A | >50 |
| | | 150000 | | | | | | |
| 6K | >80 | 100,000- | >25% | >75% | <0.2 | A | A | >50 |
| | | 150000 | | | | | | |
| 6L | >90 | 100,000- | >25% | >75% | <0.2 | A | A | >50 |
| | | 150000 | | | | | | |
| 6M | 100 | 100,000- | >25% | >75% | <0.2 | A | A | >50 |
| | | 150000 | | | | | | |
| 6N | >50 | 100,000- | >25% | >90% | <0.2 | A | A | >50 |
| | | 150000 | | | | | | |
| 6O | >60 | 100,000- | >25% | >90% | <0.2 | A | A | >50 |
| | | 150000 | | | | | | |
| 6P | >70 | 100,000- | >25% | >90% | <0.2 | A | A | >50 |
| | | 150000 | | | | | | |
| 6Q | >80 | 100,000- | >25% | >90% | <0.2 | A | A | >50 |
| | | 150000 | | | | | | |
| 6R | >90 | 100,000- | >25% | >90% | <0.2 | A | A | >50 |
| | | 150000 | | | | | | |
| 6S | 100 | 100,000- | >25% | >90% | <0.2 | A | A | >50 |
| | | 150000 | | | | | | |

*WT % PEF moieties in the polymer and Cr % refers to % crystallinity in the polymer
**A—acceptable

In each case in Tables E5-E6 above, the thermoplastic polymer used to make the foam had characteristics (measured in accordance with same procedures as identified above in Comparative Example 1) within the ranges indicated below:
Glass Transition Temperature-85-95° C.
Melt Temperature-200-240° C.
Decomposition Temperature-320-400° C.
Crystallinity-30-60%

All foams thus produced according to these examples are observed to be foams of acceptable quality.

### Synthesis Example 1-PEF Homopolymer Preparation with Mw about 90 Kg/Mol or Higher with PMDA and SSP

To obtain a 96,078 g/mol MW PEF homopolymer, 75 grams of 2,5-furandicarboxylic acid (FDCA) with 55 grams of mono-ethylene glycol (EG). The reactants were added to a 500-mL cylindrical steel reactor equipped with an overhead stirrer and a distillation/condensation apparatus. After pulling vacuum and back filling with nitrogen, 0.228 gram of titanium (IV) isopropoxide catalyst was added to the flask. The flask was then lowered into a 180° C. salt bath and overhead mixing was started at 200 rpm under a nitrogen atmosphere. After 2.5 hours, the bath temperature was increased to 220° C. After 30 minutes at this temperature under nitrogen, vacuum was started. After 40 minutes under vacuum, the temperature was increased to 250° C. and was continued for 1 hour. Under a stream of nitrogen, PMDA (0.5732 g) was slowly added over the span of about 5 minutes. An additional 30 minutes of mixing at temperature were allowed before stopping the reaction. To perform SSP, an aliquot of the product was ground and heated at 180° C. under vacuum for 3 days on a rotary evaporator to produce the PEF homopolymer as reported below. The product was removed from the vessel. Gamma-valerolactone was added to dissolve the polymer that was remaining in the reactor and on the impeller. The mixture was stirred for several hours at 190° C. The gamma-valerolactone was distilled from the polymer under vacuum resulting in a solid. To perform SSP, an aliquot of the product was ground and heated at 180° C. under vacuum for 3 days on a rotary evaporator to produce the PEF homopolymer with a molecular weight of 96,078.

### Synthesis Example 2-PEF Homopolymer Preparation with MW of about 49 Kg/Mol with PMDA and SSP

A homopolymer of PEF was made using the same additives and basic polymer formation procedures as were used to form the PEF homopolymer of Synthesis Example 1 to achieve polymer molecular weight of about 49,000 g/mol. In particular, the 49 kg/mol MW PEF homopolymer was formed by esterification and polycondensation of 75 grams of 2,5-furandicarboxylic acid (FDCA) with 59.8 grams of mono ethylene glycol (EG). The reactants were added to a 500 mL cylindrical steel reactor equipped with an overhead stirrer and a distillation/condensation apparatus. After pulling vacuum and back filling with nitrogen, 0.067 gram of titanium (IV) isopropoxide catalyst was added to the flask. The flask was then lowered into a 180° C. salt bath and overhead mixing was started at 200 rpm under a nitrogen atmosphere. After 2.5 hours, the bath temperature was increased to 220° C. After 30 minutes at this temperature under nitrogen, vacuum was started. After 40 minutes under vacuum, the temperature was increased to 230° C. and was continued for 1 hour. Under a stream of nitrogen, 0.58 gram (0.7% by weight) of PMDA wase slowly added over a time of about 5 minutes. To perform SSP, an aliquot (30 g) of the product was ground and heated at 180° C. under vacuum for 3 days on a rotary evaporator to produce the PEF homopolymer as reported in Table SEx2 below:

TABLE SEx2

| | |
|---|---|
| Molecular Weight, g/mol | 49,000 |
| Glass Transition Temperature, ° C. | 92 |
| Melt Temperature, ° C. | 220 |
| Decomposition Temperature, ° C. | 340 |
| Crystallinity, % | 43 |

### Synthesis Example C1-Pet Homopolymer Preparation at Molecular Weight of 80.9 Kg/Mol with PMDA and SSP

PET homopolymer was prepared by polycondensation yielding products with a molecular size of 61.1 kg/mol. About 93 grams (0.366 mol) of bis (2-hydroxyethyl) terephthalate (BHET) was added to a 500 mL round bottom flask. After pulling vacuum and back filling with N2, the flask was lowered into a 180° C. salt bath and overhead mixing was started at 100 rpm under N₂ flow. After three hours of heating under N2, 0.123 grams (0.0004 mol) of titanium isopropoxide catalyst were charged into the flask. After 50 minutes, the bath temperature was increased to 285° C. After 1.5 hours at this temperature under N₂, vacuum was started and continued for two hours. Under a stream of N2, pyromellitic dianhydride PMDA (0.49 g; 0.0022 mol) was slowly added over the span of about 10 minutes. An additional 30 minutes of mixing at temperature were allowed before stopping the reaction. Solid state polymerization was conducted by grinding an aliquot (30g) of the above product and then heating at 180° C. under vacuum for 3 days on a rotary evaporator yielding a polymer with a molecular weight of 81 kg/mol.

What is claimed is:

1. A low-density, thermoplastic foam comprising:
(a) thermoplastic polymer cells comprising cell walls comprising polyethylene furanoate, wherein at least about 50% by volume of the cells are closed cells and wherein ethylene furanoate moieties are at least 1% by mole of the thermoplastic polymer; and
(b) HFC-152a contained in the closed cells.

2. The foam of claim 1 wherein said cell walls consisting essentially of polyethylene furanoate that has been treated with a chain extender and having a molecular weight of at least about 25,000.

3. The foam of claim 2 wherein at least about 75% of the cells are closed cells.

4. The foam of claim 3 wherein ethylene furanoate moieties are at least 10% by weight of the thermoplastic polymer.

5. The foam of claim 2 wherein said foam has a foam density of less than 0.2 g/cc.

6. The foam of claim 2 wherein said cell walls consist essentially of polyethylene furanoate having a molecular weight of at least about 90,000.

7. The foam of claim 1 wherein said one or more blowing agents contained in said closed cells further comprise at least 1234ze (E).

8. A wind energy turbine blade and/or nacelle comprising a foam according to claim 1.

9. A wind energy turbine blade and/or nacelle comprising a foam according to claim 2.

10. A wind energy turbine blade and/or nacelle comprising a foam according to claim 5.
